(19) United States
(12) Patent Application Publication
(10) Pub. No.: US 2015/0106627 A1
(43) Pub. Date: Apr. 16, 2015

(54) DEVICES, METHODS, AND SYSTEMS FOR ANALYZING CAPTURED IMAGE DATA AND PRIVACY DATA

(71) Applicant: ELWHA LLC, Bellevue, WA (US)

(72) Inventors: Pablos Holman, Seattle, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US)

(21) Appl. No.: 14/084,254

(22) Filed: Nov. 19, 2013

Related U.S. Application Data
(63) Continuation-in-part of application No. 14/051,213, filed on Oct. 10, 2013.
Application No. 14/051,213 is a continuation-in-part of application No. 14/055,471, filed on Oct. 16, 2013.
Application No. 14/055,471 is a continuation-in-part of application No. 14/055,543, filed on Oct. 16, 2013.

(51) Int. Cl. G06F 21/60

(52) U.S. Cl. CPC G06F 21/602
USPC 713/189

(57) ABSTRACT

Computationally implemented methods and systems include acquiring a block of encrypted data that corresponds to an image that has been encrypted through use of a unique device code associated with an image capture device configured to capture the image that includes a representation of a feature of an entity, obtaining a privacy metadata that corresponds to a detection of a privacy beacon in the image, said at least one image captured by the image capture device, said privacy beacon associated with the entity, and determining, at least partly based on the obtained privacy metadata, and partly based on a calculation related to the block of encrypted data that corresponds to the whether to allow one or more processes related to the encrypted data block. In addition to the foregoing, other aspects are described in the claims, drawings, and text.

### CROSS-REFERENCE TO RELATED APPLICATIONS

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a continuation-in-part of U.S. patent application Ser. No. 14/051,213, entitled METHODS, SYSTEMS, AND DEVICES FOR FACILITATING VIABLE DISTRIBUTION OF DATA COLLECTED BY WEARABLE COMPUTATION, naming Pablos Holman, Roderick A. Hyde, Royce A. Levien, Richard T. Lord, Robert W. Lord, and Mark A. Malamud as inventors, filed 10 Oct. 2013 with attorney docket no. 0213-003-060-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 14/055,471, entitled METHODS, SYSTEMS, AND DEVICES FOR HANDLING IMAGE DATA FROM CAPTURED IMAGES, naming Pablos Holman, Roderick A. Hyde, Royce A. Levien, Richard T. Lord, Robert W. Lord, and Mark A. Malamud as inventors, filed 16 Oct. 2013 with attorney docket no. 0213-003-061-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 14/055,543, entitled METHODS, SYSTEMS, AND DEVICES FOR HANDLING IMAGE DATA FROM CAPTURED IMAGES, naming Pablos Holman, Roderick A. Hyde, Royce A. Levien, Richard T. Lord, Robert W. Lord, and Mark A. Malamud as inventors, filed 16 Oct. 2013 with attorney docket no. 0213-003-072-000000, which is currently co-pending or is an application of which a currently co-pending application is entitled to the benefit of the filing date.

### RELATED APPLICATIONS

United States patent application No. To Be Assigned, entitled METHODS, SYSTEMS, AND DEVICES FOR HANDLING IMAGE DATA FROM CAPTURED IMAGES, naming Pablos Holman, Roderick A. Hyde, Royce A. Levien, Richard T. Lord, Robert W. Lord, and Mark A. Malamud as inventors, filed 19 Nov. 2013 with attorney docket no. 0213-003-063-000000, is related to the present application.

United States patent application No. To Be Assigned, entitled METHODS, SYSTEMS, AND DEVICES FOR HANDLING IMAGE DATA FROM CAPTURED IMAGES, naming Pablos Holman, Roderick A. Hyde, Royce A. Levien, Richard T. Lord, Robert W. Lord, and Mark A. Malamud as inventors, filed 19 Nov. 2013 with attorney docket no. 0213-003-074-000000, is related to the present application.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BACKGROUND

This application is related to the handling of the capture of images that may include personality rights.

### SUMMARY

Recently, there has been an increased popularity in wearable computers, e.g., computers that are placed in articles of clothing or clothing accessories, e.g., watches, eyeglasses, shoes, jewelry, accessories, shirts, pants, headbands, and the like. As technology allows electronic devices to become smaller and smaller, more and more items may be “smart” items, e.g., may contain a computer.

In addition, image capturing technology has also improved, allowing for high quality digital cameras that can capture pictures, audio, video, or a combination thereof. These digital cameras may be small enough to fit onto wearable computers, e.g., inside of eyeglasses. In some instances, the digital camera may blend into the eyeglasses mold, and may not be immediately recognizable as a camera. Such eyeglasses may be indistinguishable or somewhat distinguishable from standard eyeglasses that do not contain a camera and/or a computer.

Further, the cost of data storage has decreased dramatically, and it is not uncommon for an average person in a developed nation to have access to enough digital storage to store months' and/or years' worth of video and pictures. As the cost of data storage has decreased dramatically, so too has the cost of processors to process that data, meaning that automation may be able to take an entire day's worth of surreptitious recording, and isolate those portions of the recording that captured persons, either specific persons or persons in general.

Accordingly, with technology, it is possible for a person to “wear” a computer, in the form of eyeglasses, watches, shirts, hats, or through a pocket-sized device carried by a person, e.g., a cellular telephone device. This wearable computer may be used to record people, e.g., to capture pictures, audio, video, or a combination thereof a person, without their knowledge. Thus, conversations that a person may assume to be private, may be recorded and widely distributed. Moreover, a person may be surreptitiously recorded while they are in a locker room, in a bathroom, or in a telephone booth. It may be difficult or impossible to tell when a person is being recorded. Further, once proliferation of these wearable computers with digital cameras becomes widespread, people must assume that they are under surveillance 100% of the time that they are not in their house.

Therefore, a need has arisen to provide systems that attempt to limit the capture and distribution of a person's personality rights. The present invention is directed to devices, methods, and systems that attempt to limit the capture and distribution of captured images of persons. Specifically, the present invention is directed to devices, methods, and systems that attempt to limit the capture and distribution of captured images of persons, implemented at a device that carries out the capturing of the image. In some embodiments, this device may be a wearable computer, but in other embodiments, any image capturing device or any device that has an image capturing device incorporated into its functionality may implement the devices, methods, and systems described herein.

In various embodiments, devices, methods, and systems may have a capability to capture images, and in which the capture of those images may include capturing images of a person, persons, or portion(s) of a person for which a privacy beacon may be associated. The privacy beacon may be optical, digital, or other form (e.g., radio, electromagnetic, biomechanic, quantum-state, and the like), and may be detected through digital or optical operations, as discussed herein.

The instant application is directed at least in part to, but not limited by, devices, methods, and systems that acquire a captured encrypted image, and that acquire beacon data, and that make a determination at least partly based on data that is acquired and that is related to one or more of the captured image and the privacy beacon, whether directly or indirectly, e.g., inferentially or tangentially.

In one or more various aspects, a method includes but is not limited to acquiring a block of encrypted data that corresponds to at least one image that has been encrypted through use of a unique device code associated with an image capture device configured to capture the at least one image, wherein the at least one image includes at least one representation of a feature of at least one entity, obtaining a privacy metadata that corresponds to a detection of a privacy beacon in the at least one image, said at least one image captured by the image capture device, said privacy beacon associated with the at least one entity, and determining, at least partly based on the obtained privacy metadata, and at least partly based on a calculation related to the block of encrypted data that corresponds to the at least one image, whether to allow one or more processes related to the encrypted data block. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for affecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for acquiring a block of encrypted data that corresponds to at least one image that has been encrypted through use of a unique device code associated with an image capture device configured to capture the at least one image, wherein the at least one image includes at least one representation of a feature of at least one entity, means for obtaining a privacy metadata that corresponds to a detection of a privacy beacon in the at least one image, said at least one image captured by the image capture device, said privacy beacon associated with the at least one entity, and means for determining, at least partly based on the obtained privacy metadata, and at least partly based on a calculation related to the block of encrypted data that corresponds to the at least one image, whether to allow one or more processes related to the encrypted data block. In addition to the foregoing, other system aspects are described in the claims, drawings, and text forming a part of the disclosure set forth herein.

In one or more various aspects, a system includes, but is not limited to, circuitry for acquiring a block of encrypted data that corresponds to at least one image that has been encrypted through use of a unique device code associated with an image capture device configured to capture the at least one image, wherein the at least one image includes at least one representation of a feature of at least one entity, circuitry for obtaining a privacy metadata that corresponds to a detection of a privacy beacon in the at least one image, said at least one image captured by the image capture device, said privacy beacon associated with the at least one entity, and circuitry for determining, at least partly based on the obtained privacy metadata, and at least partly based on a calculation related to the block of encrypted data that corresponds to the at least one image, whether to allow one or more processes related to the encrypted data block. In addition to the foregoing, other system aspects are described in the claims, drawings, and text forming a part of the disclosure set forth herein.

In one or more various aspects, a computer program product, comprising a signal bearing medium, bearing one or more instructions including, but not limited to, one or more instructions for acquiring a block of encrypted data that corresponds to at least one image that has been encrypted through use of a unique device code associated with an image capture device configured to capture the at least one image, wherein the at least one image includes at least one representation of a feature of at least one entity, one or more instructions for obtaining a privacy metadata that corresponds to a detection of a privacy beacon in the at least one image, said at least one image captured by the image capture device, said privacy beacon associated with the at least one entity, and one or more instructions for determining, at least partly based on the obtained privacy metadata, and at least partly based on a calculation related to the block of encrypted data that corresponds to the at least one image, whether to allow one or more processes related to the encrypted data block. In addition to the foregoing, other computer program product aspects are described in the claims, drawings, and text forming a part of the disclosure set forth herein.

In one or more various aspects, a device is defined by a computational language, such that the device comprises one or more interchained physical machines ordered for acquiring a block of encrypted data that corresponds to at least one image that has been encrypted through use of a unique device code associated with an image capture device configured to capture the at least one image, wherein the at least one image includes at least one representation of a feature of at least one entity, one or more interchained physical machines ordered for obtaining a privacy metadata that corresponds to a detection of a privacy beacon in the at least one image, said at least one image captured by the image capture device, said privacy beacon associated with the at least one entity, and one or more interchained physical machines ordered for determining, at least partly based on the obtained privacy metadata, and at least partly based on a calculation related to the block of encrypted data that corresponds to the at least one image, whether to allow one or more processes related to the encrypted data block.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1, including FIGS. 1-A through 1-T, shows a high-level system diagram of one or more exemplary environments in which transactions and potential transactions may be carried out, according to one or more embodiments. FIG. 1 forms a partially schematic diagram of an environment(s) and/or an implementation(s) of technologies described herein when FIGS. 1-A through 1-T are stitched together in the manner shown in FIG. 1-P, which is reproduced below in table format.

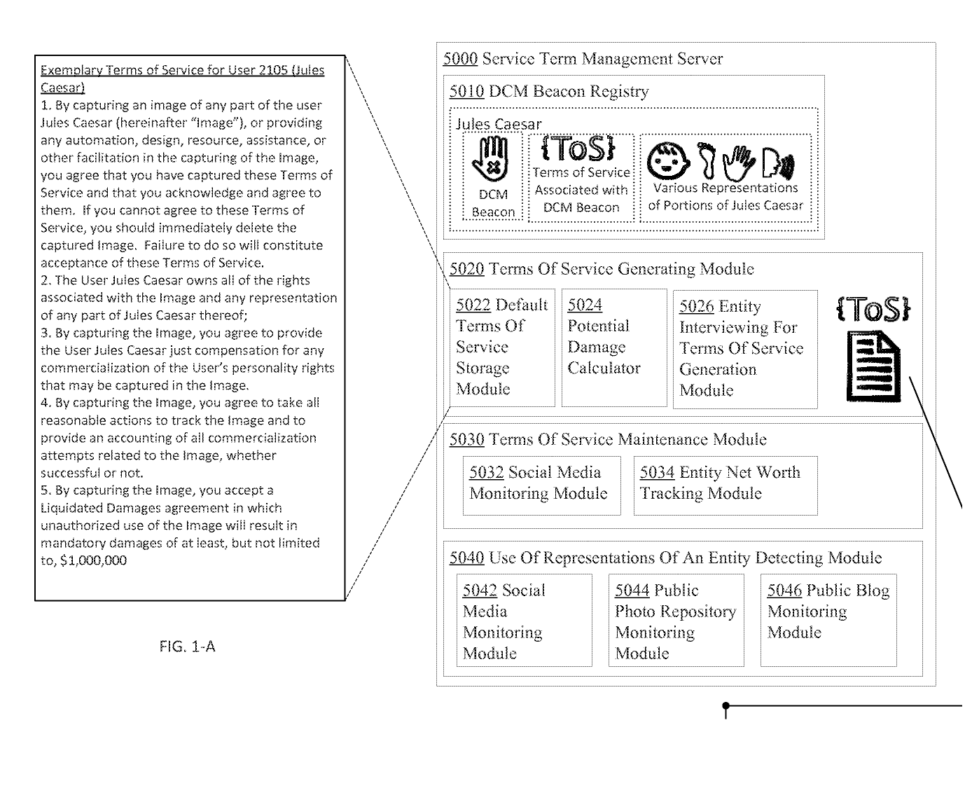

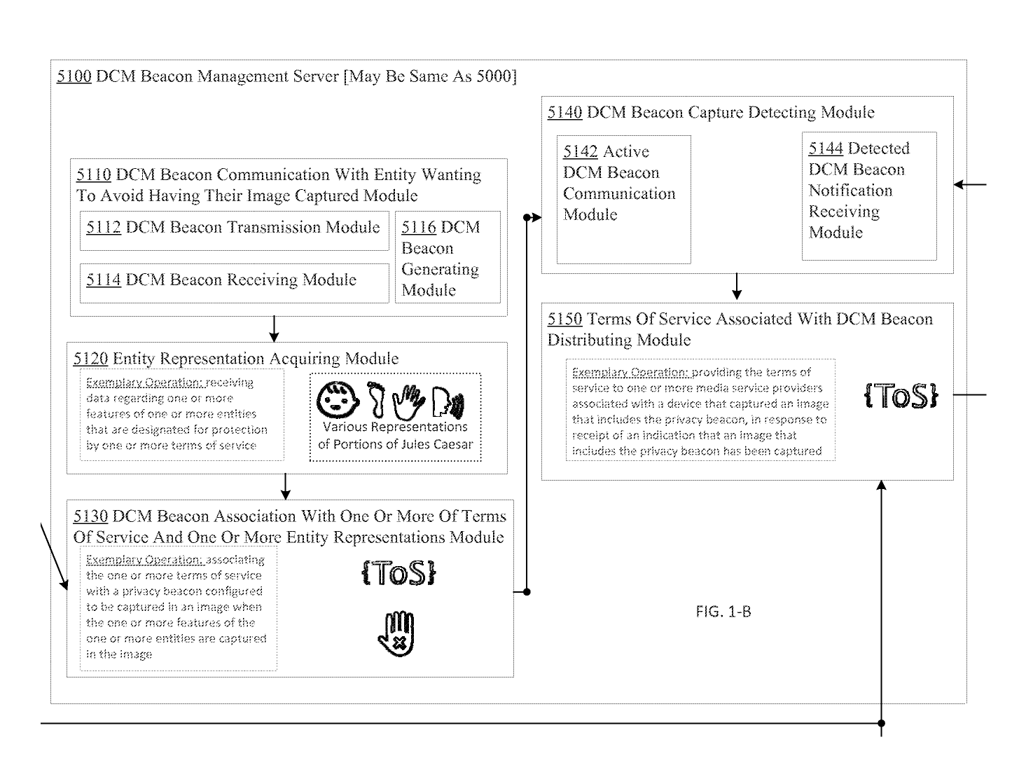

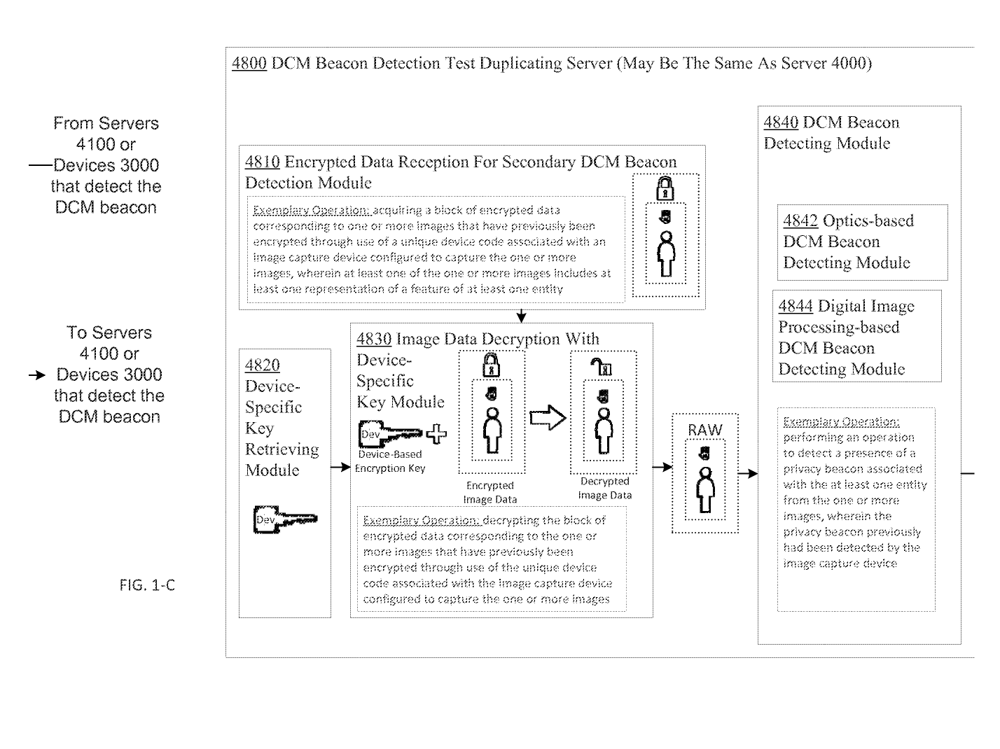

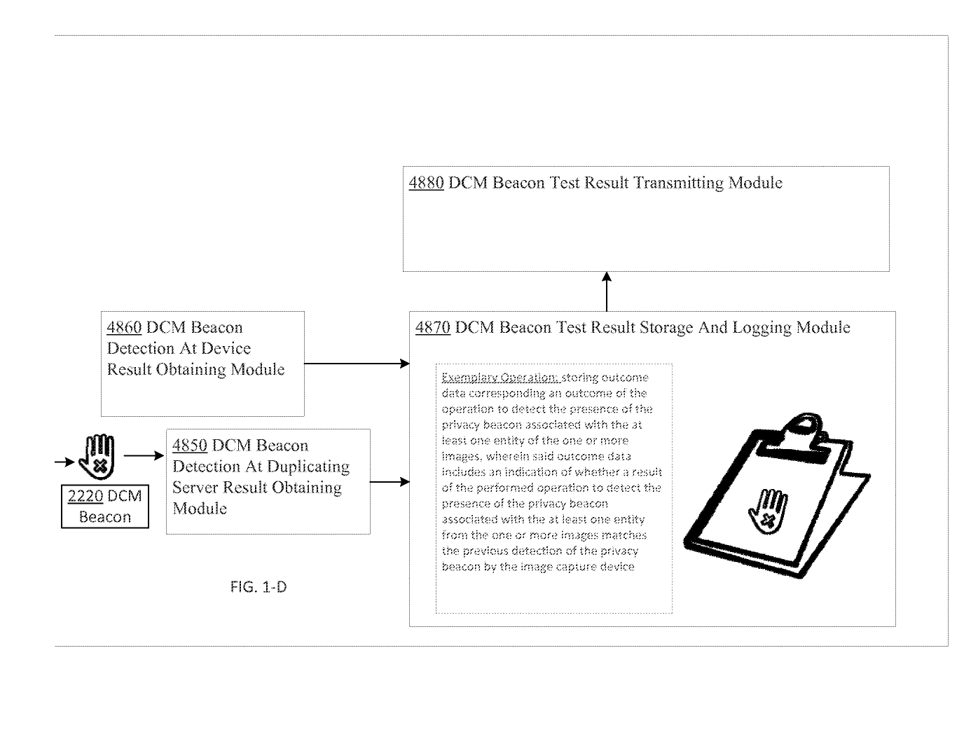

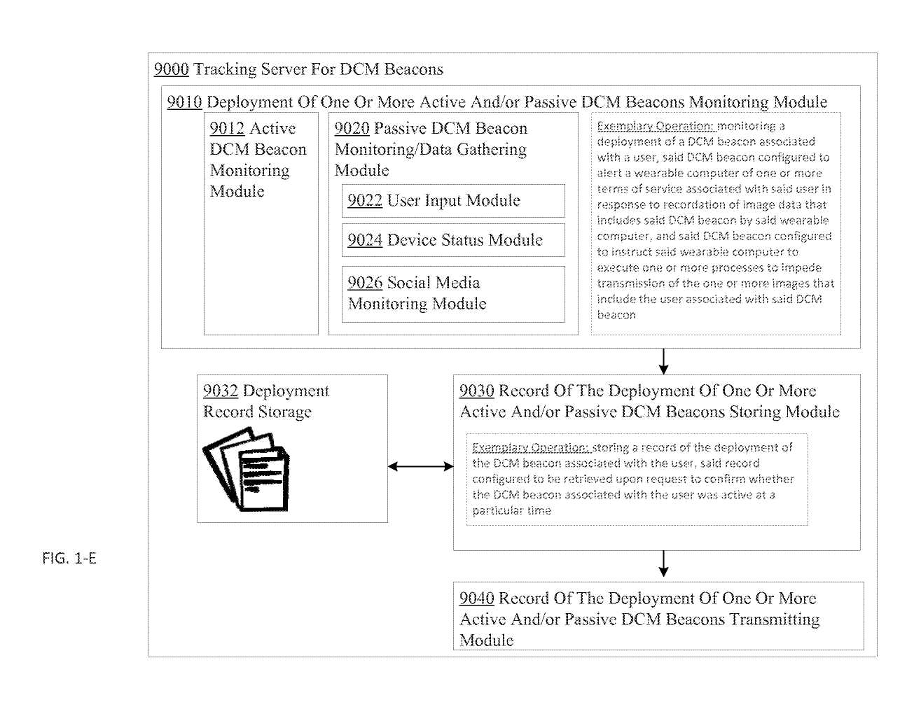

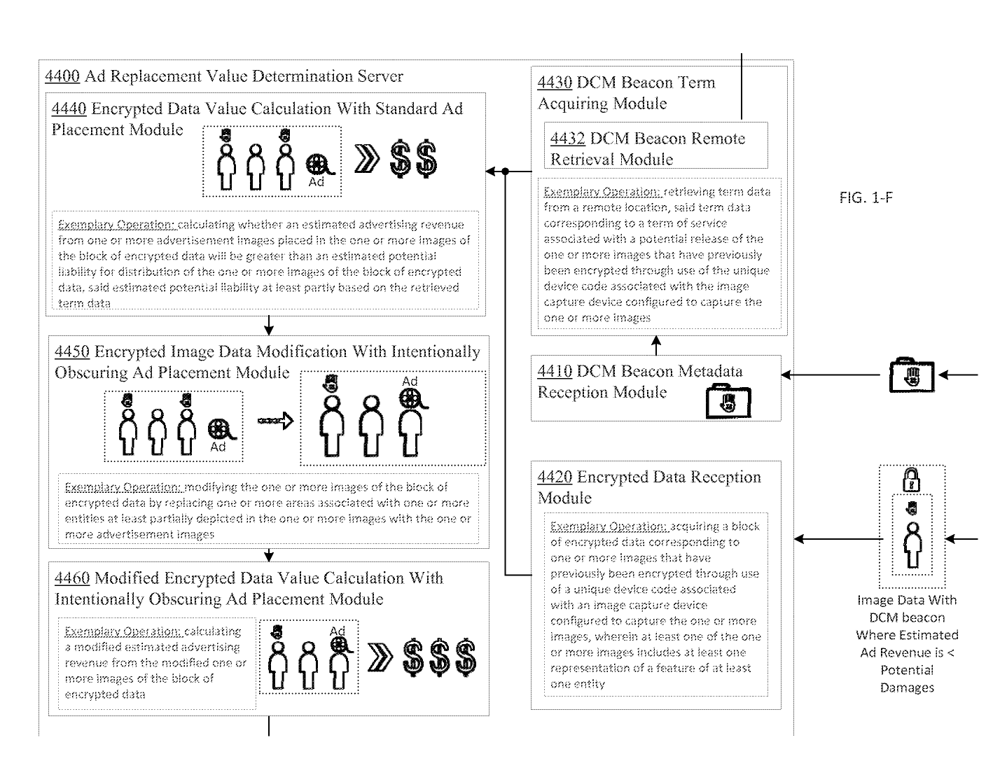

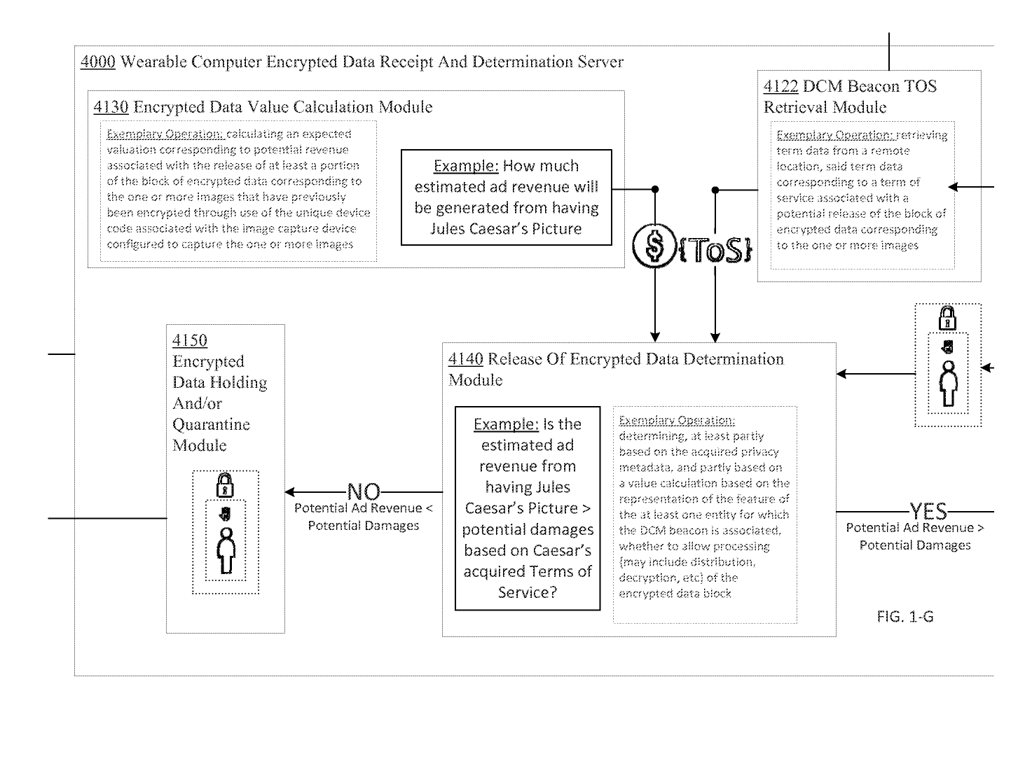

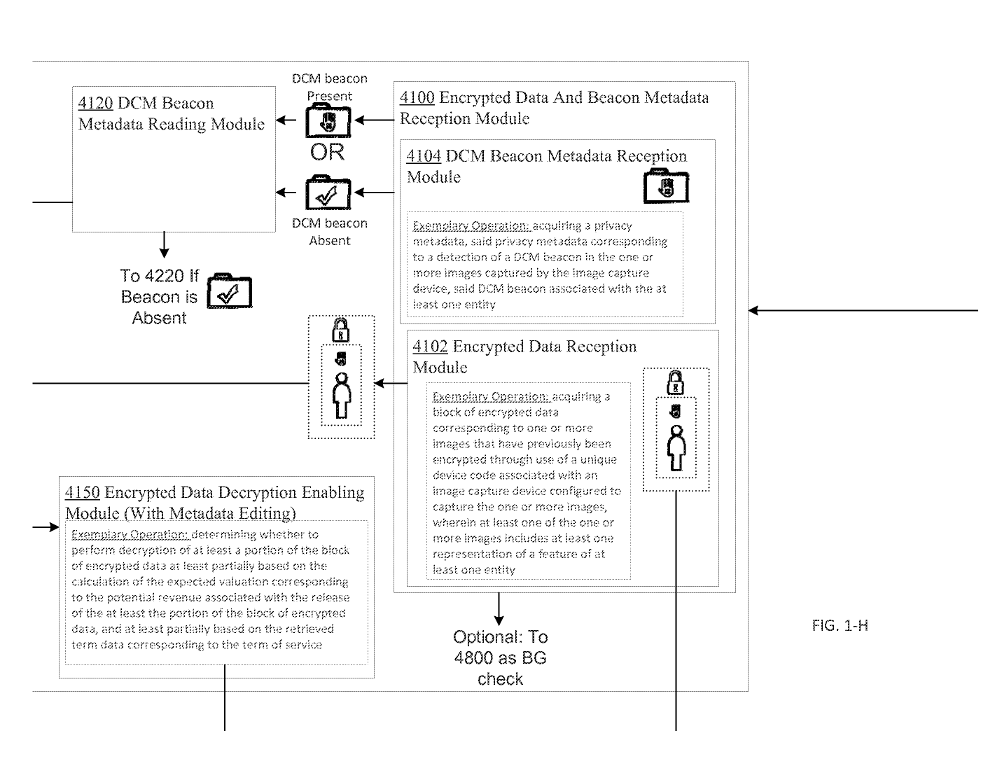

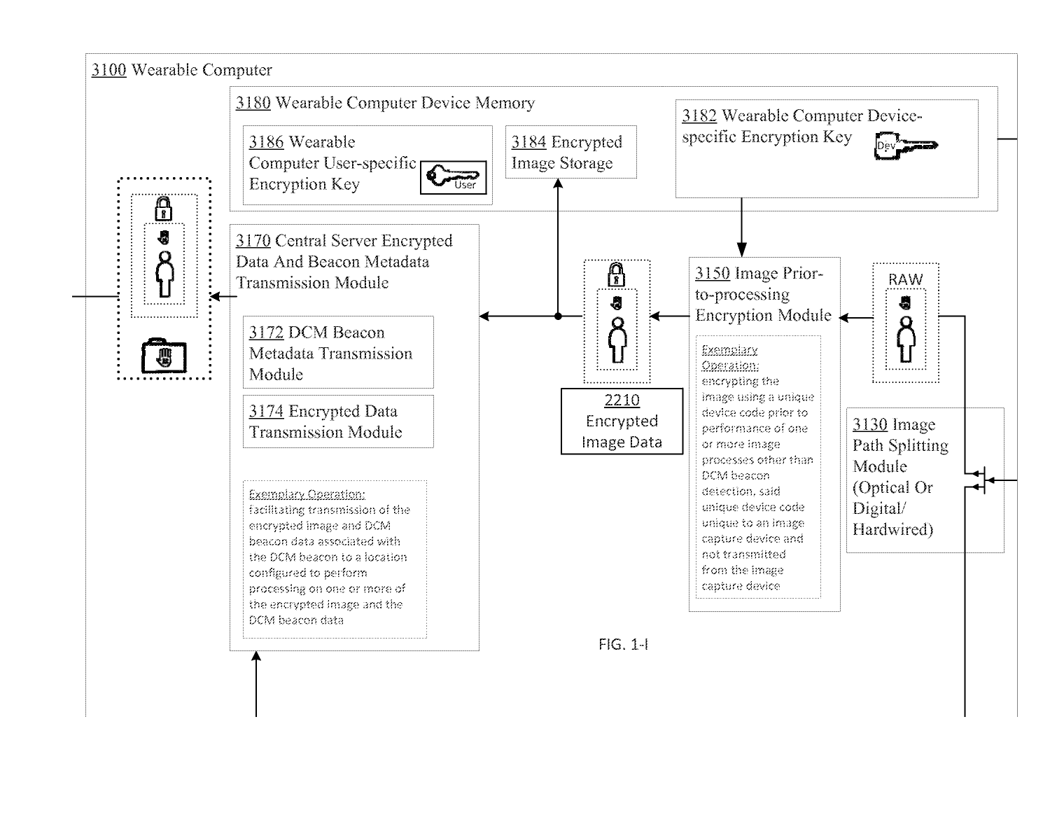

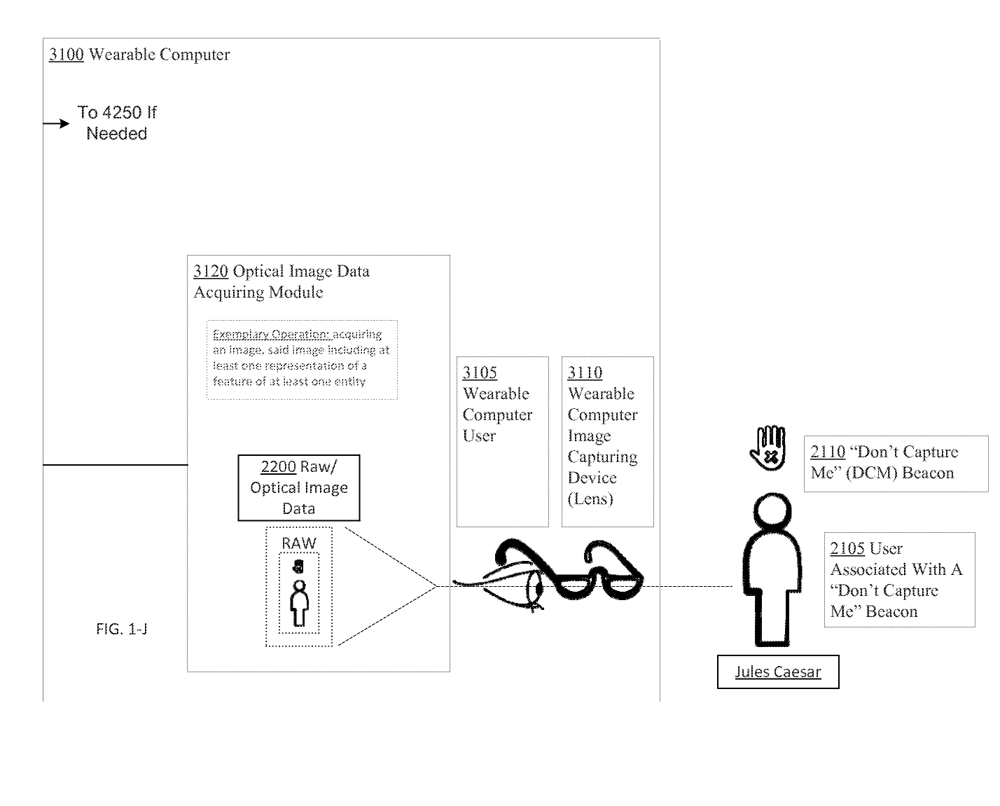

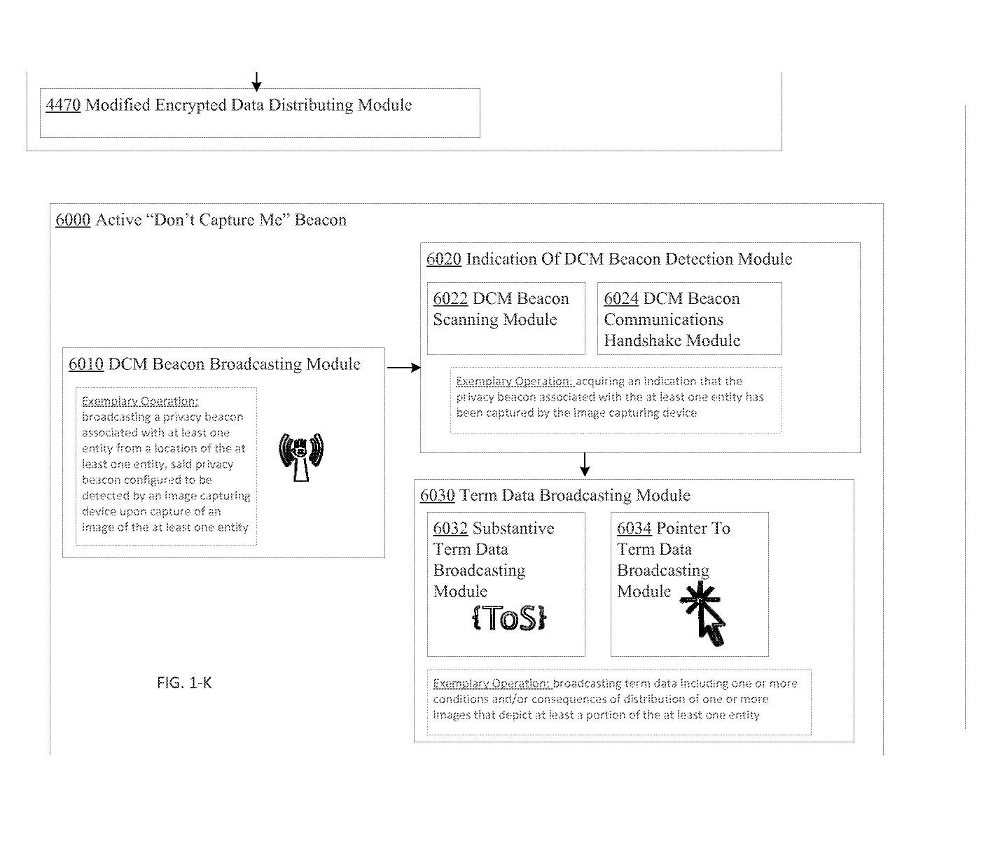

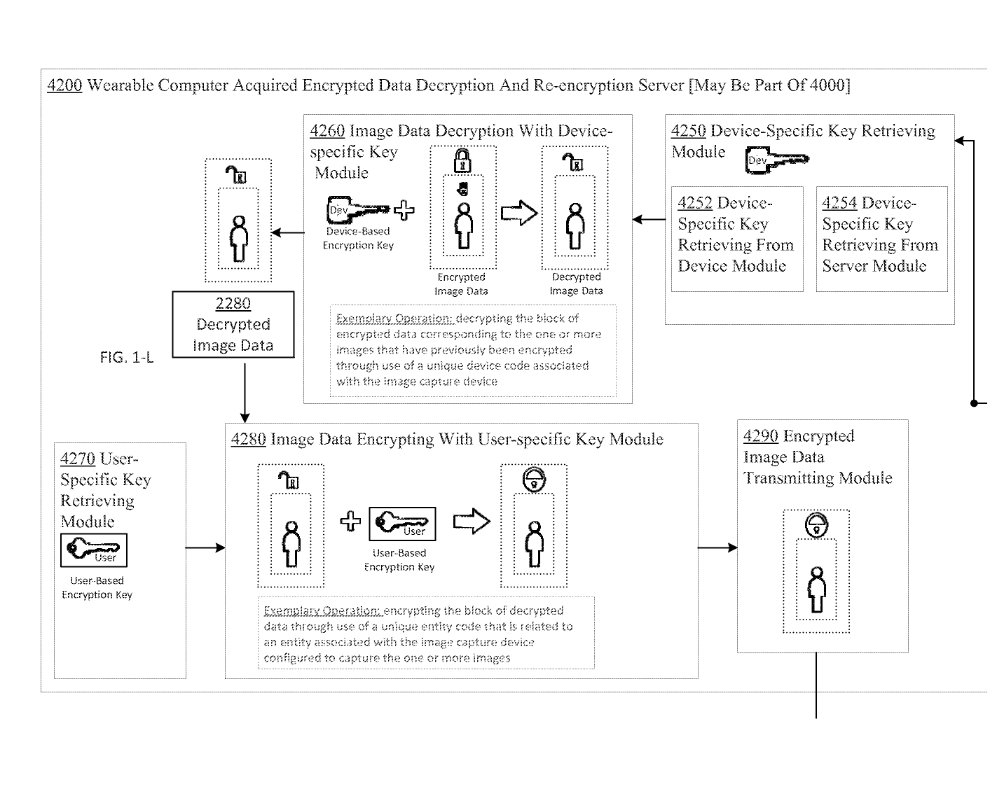

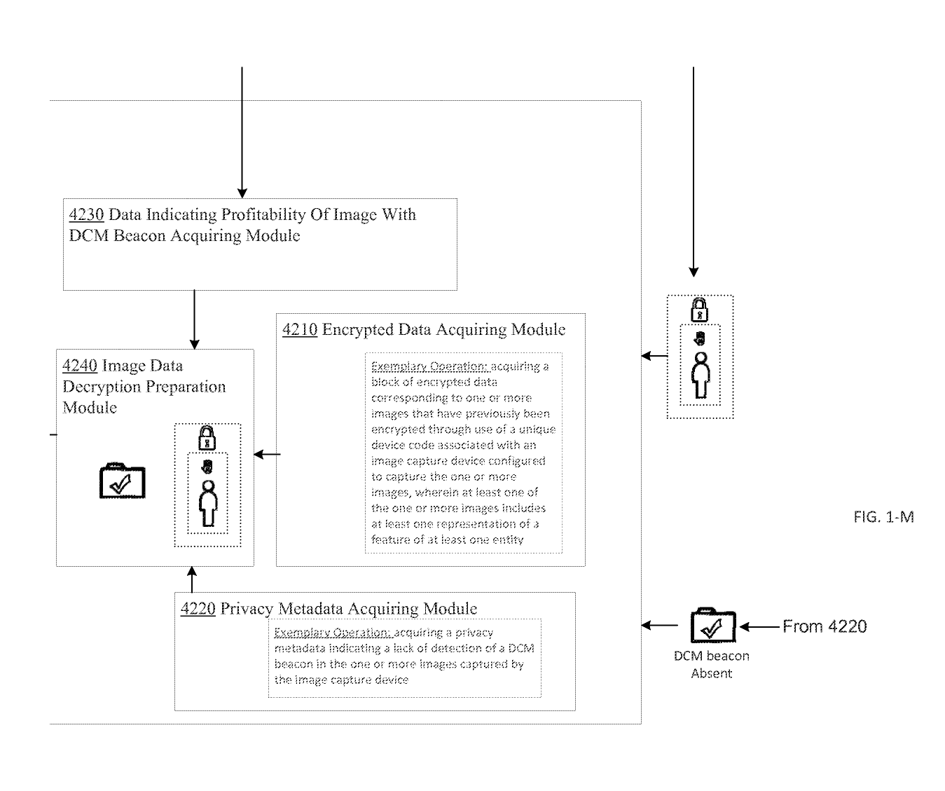

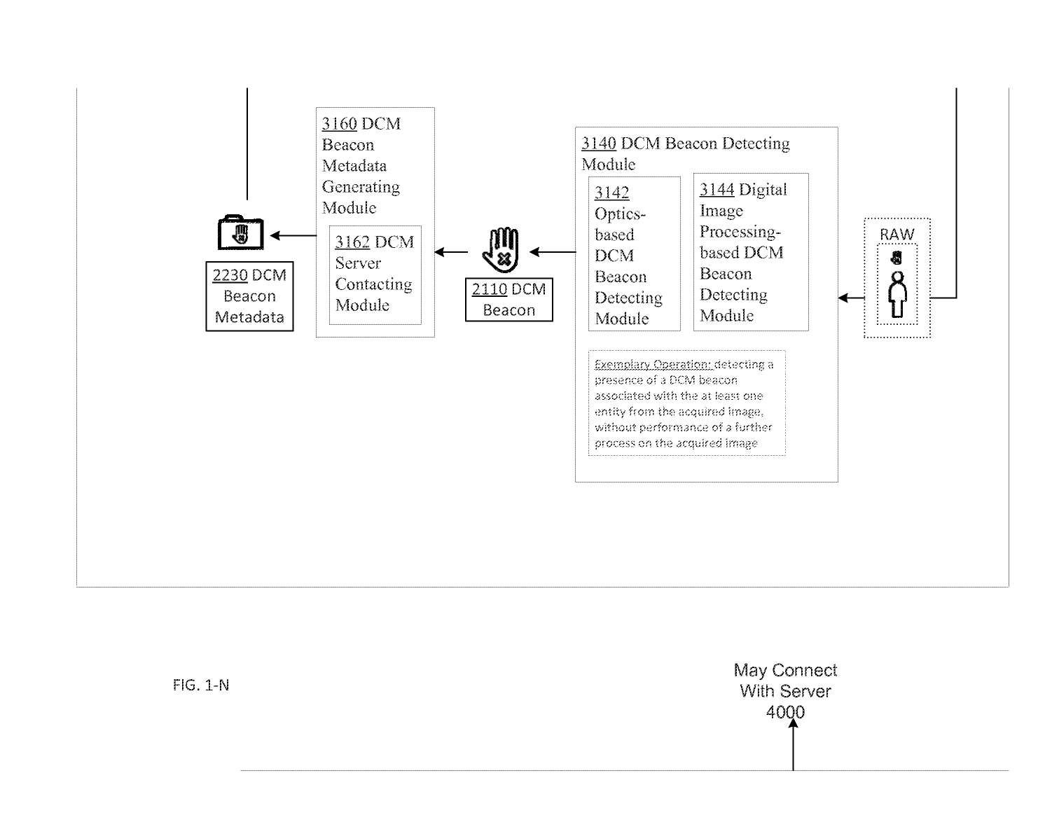

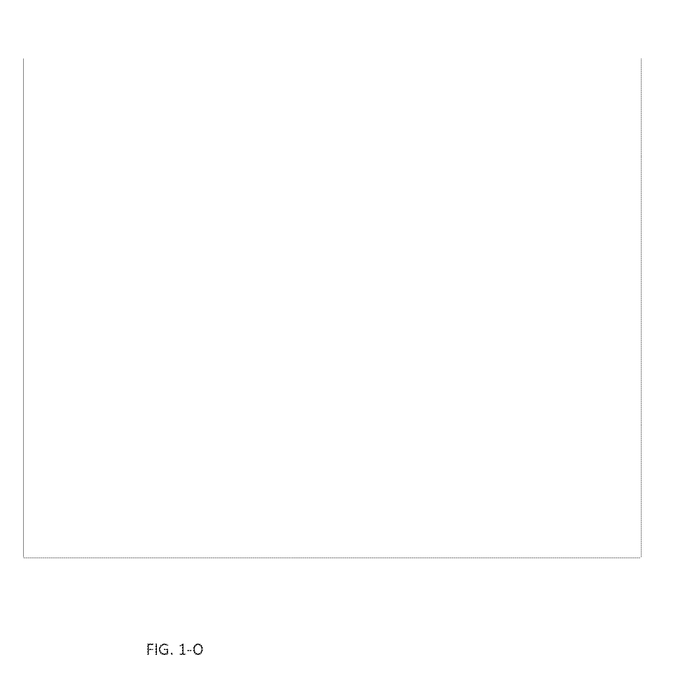

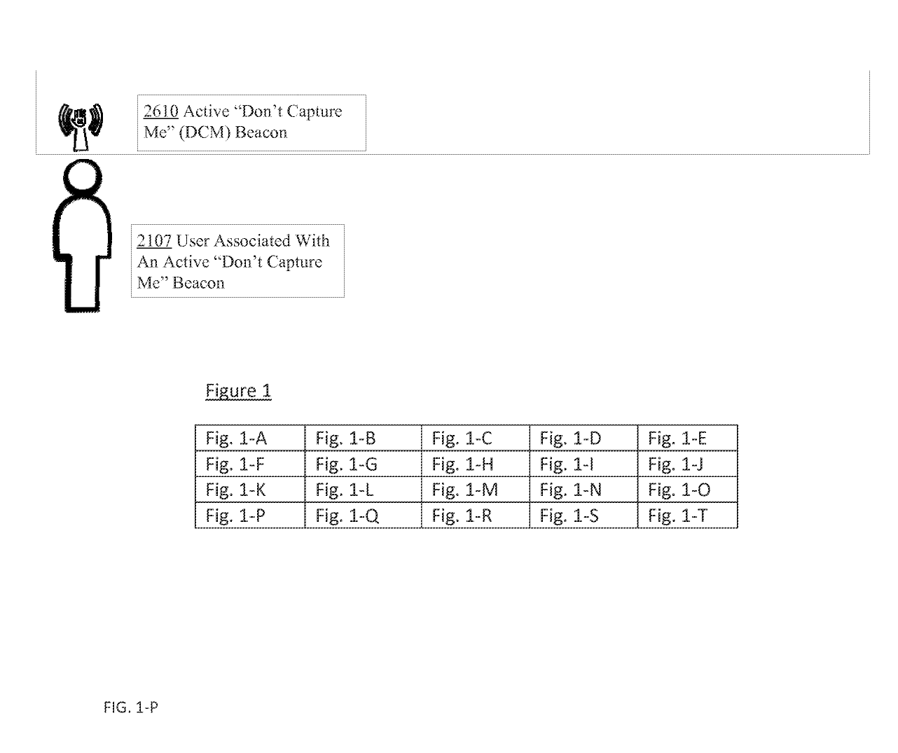

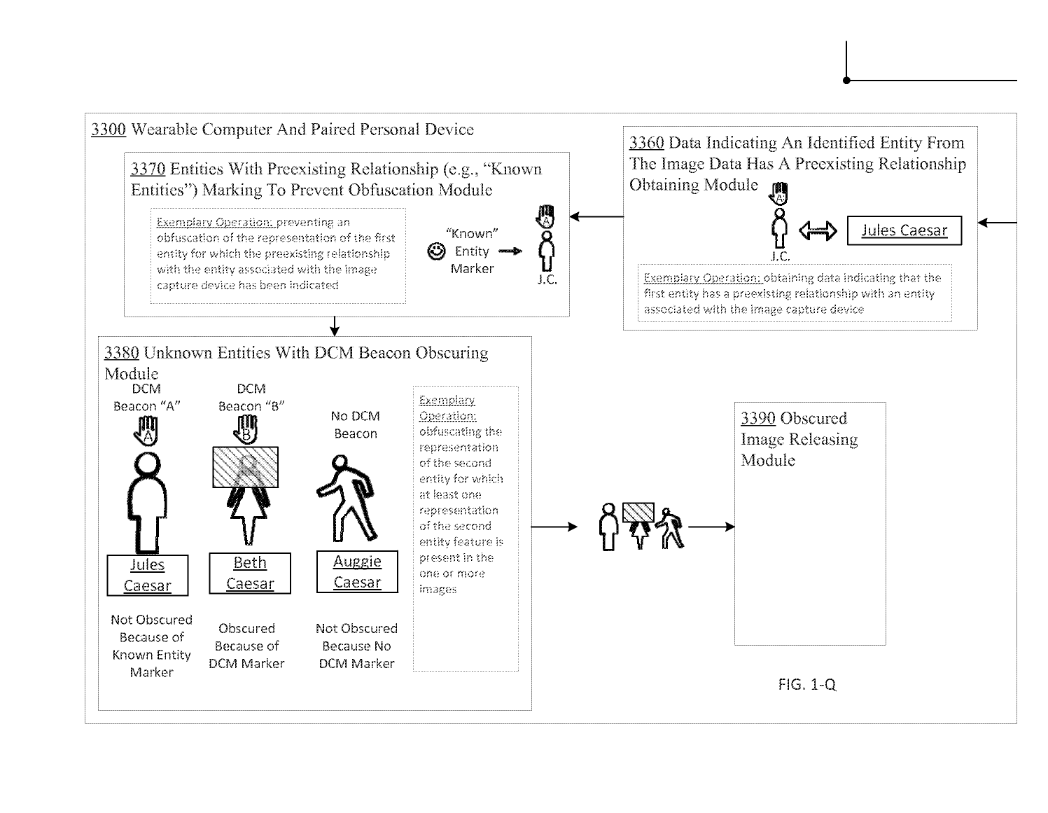

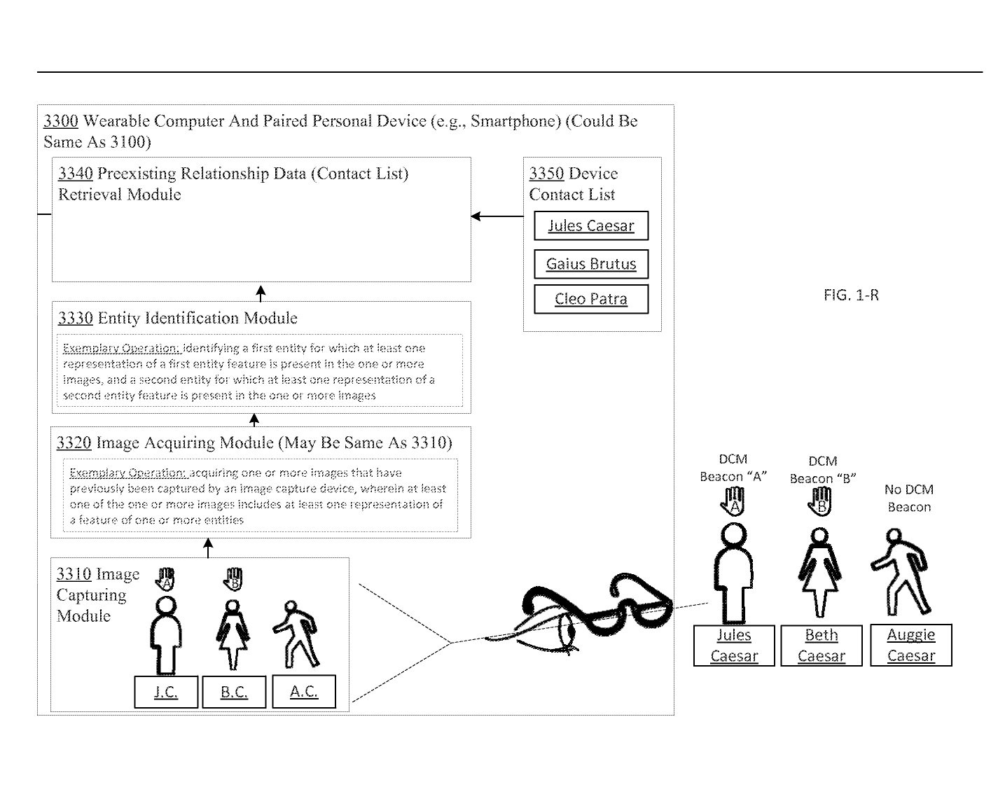

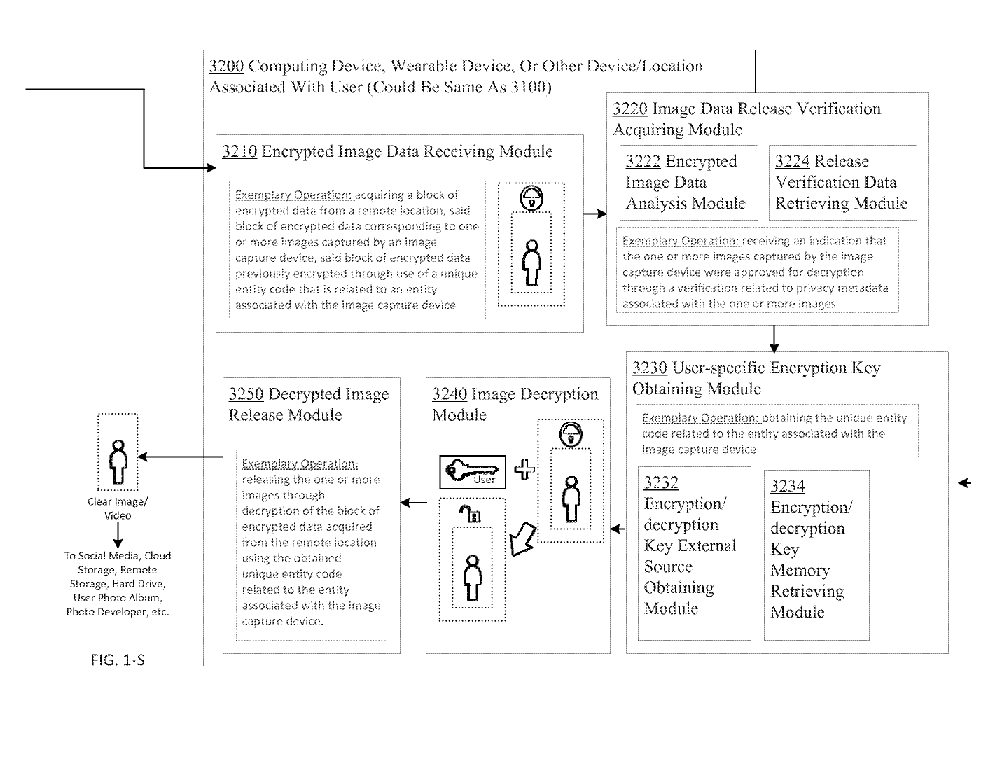

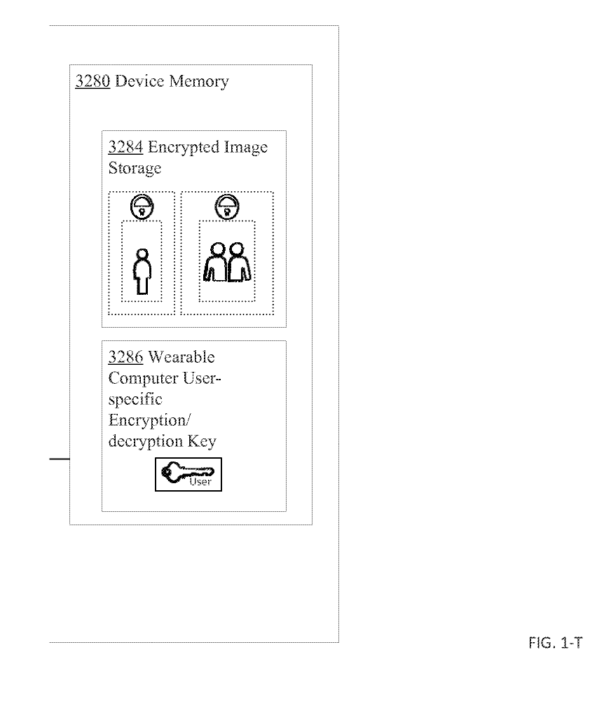

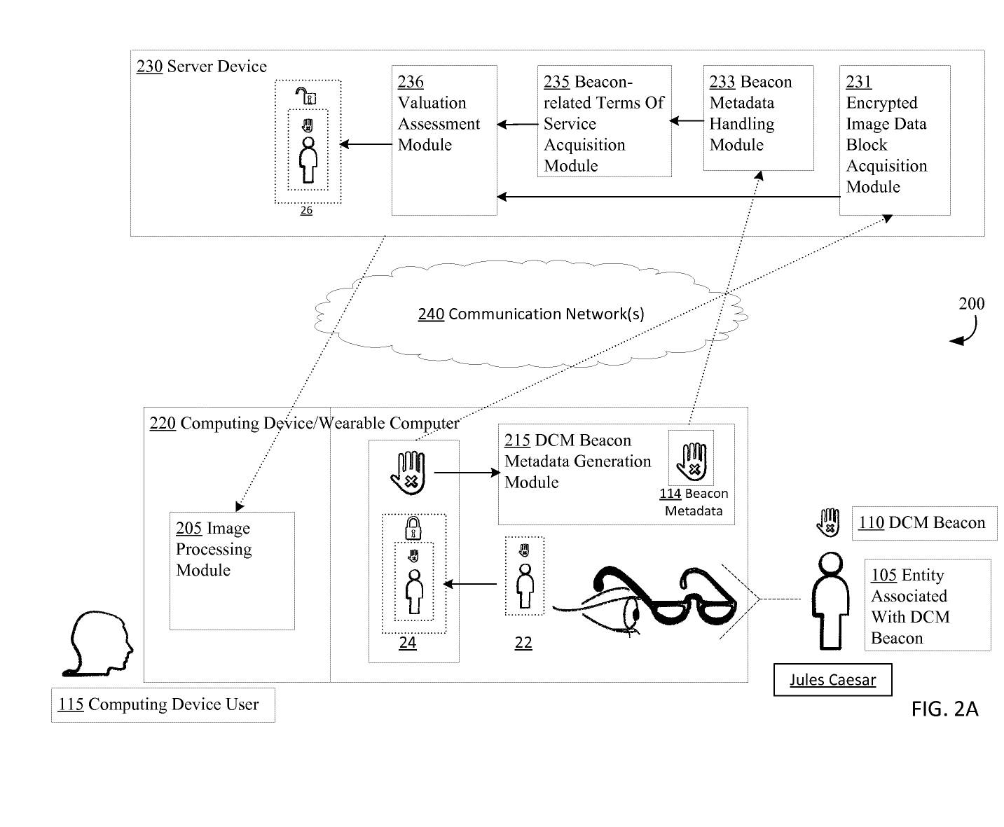

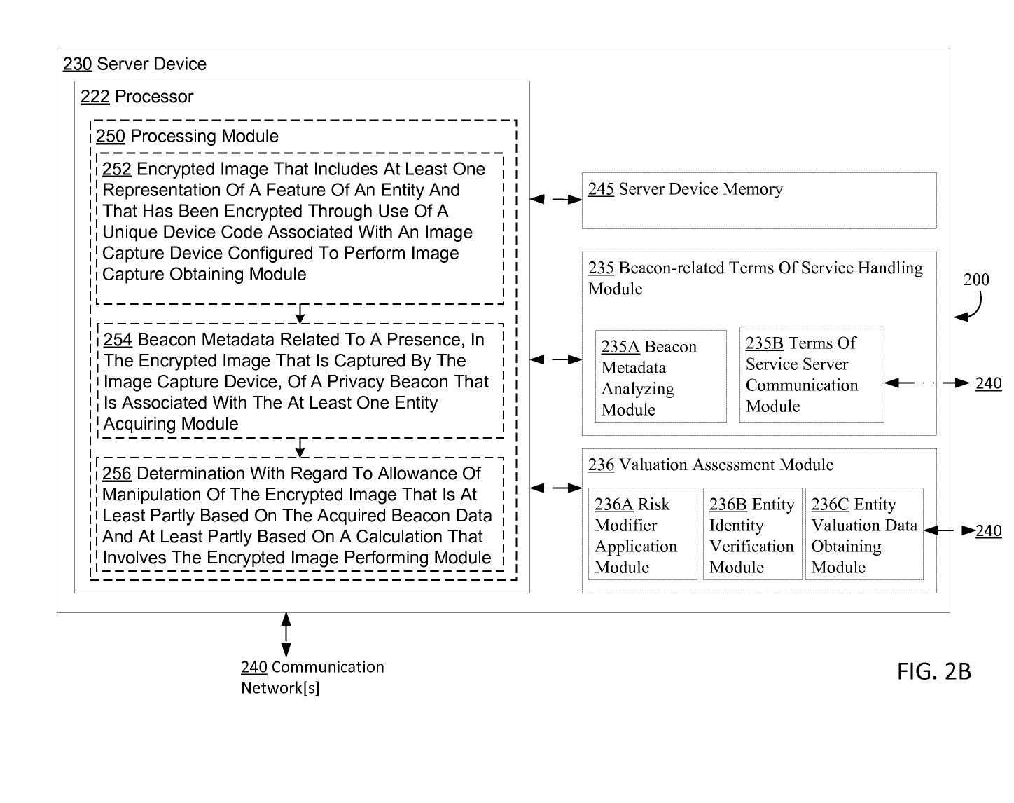

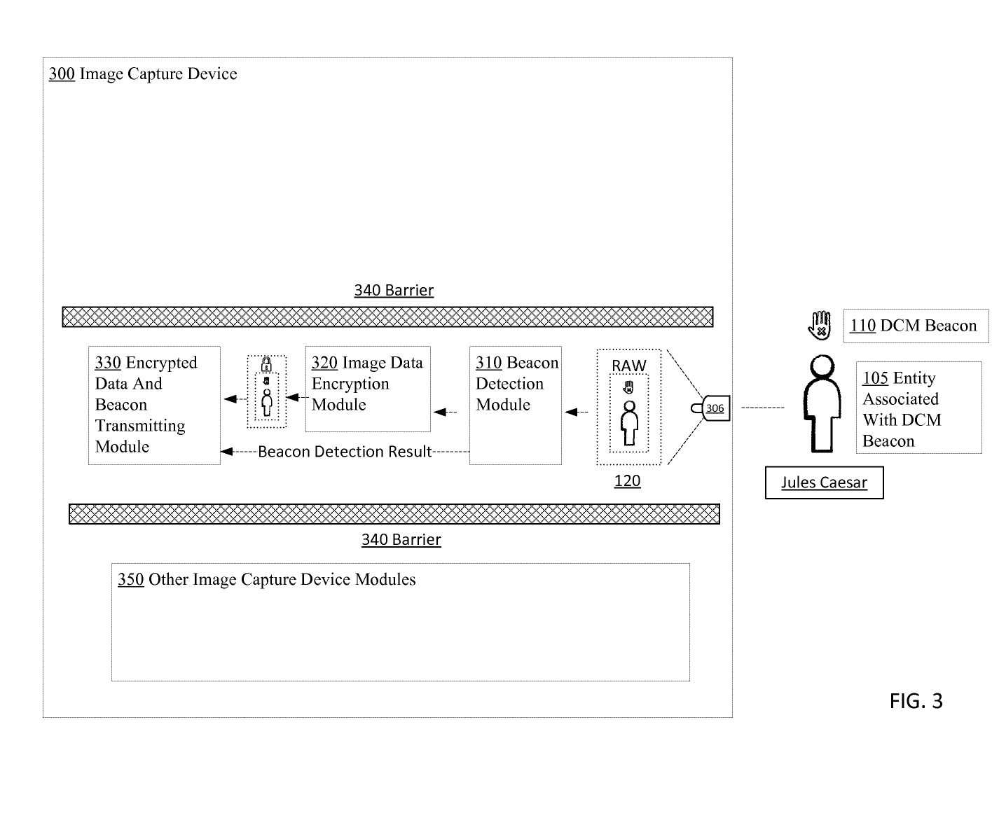

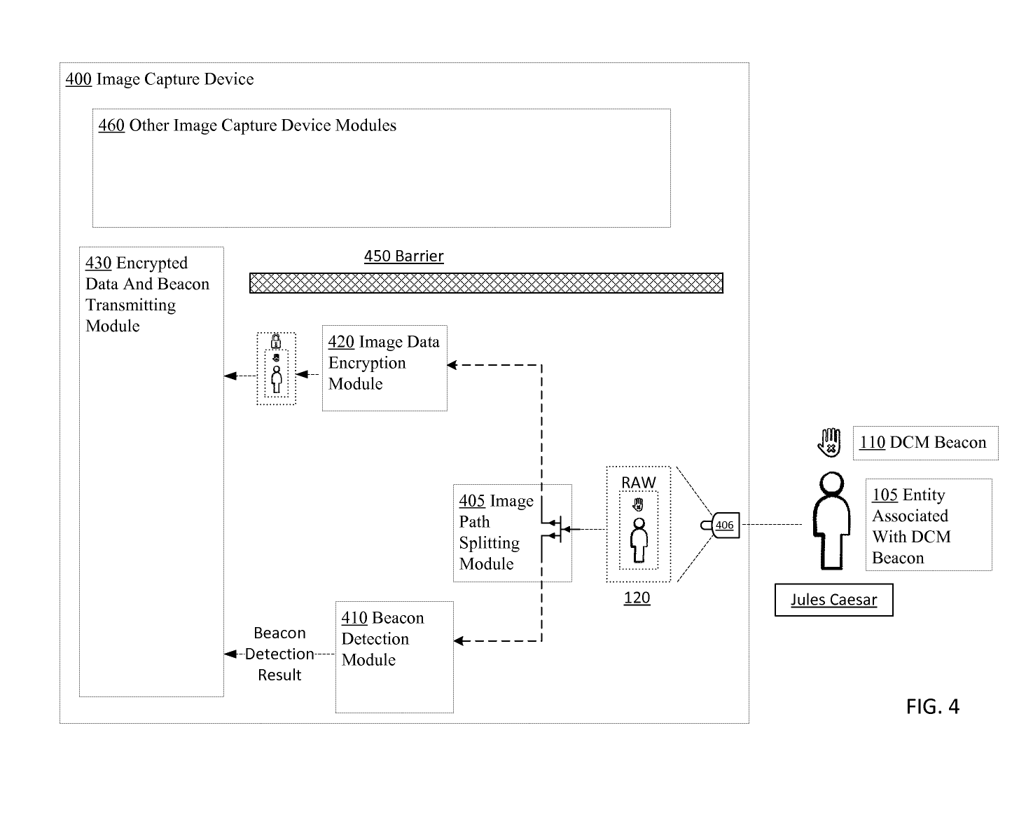

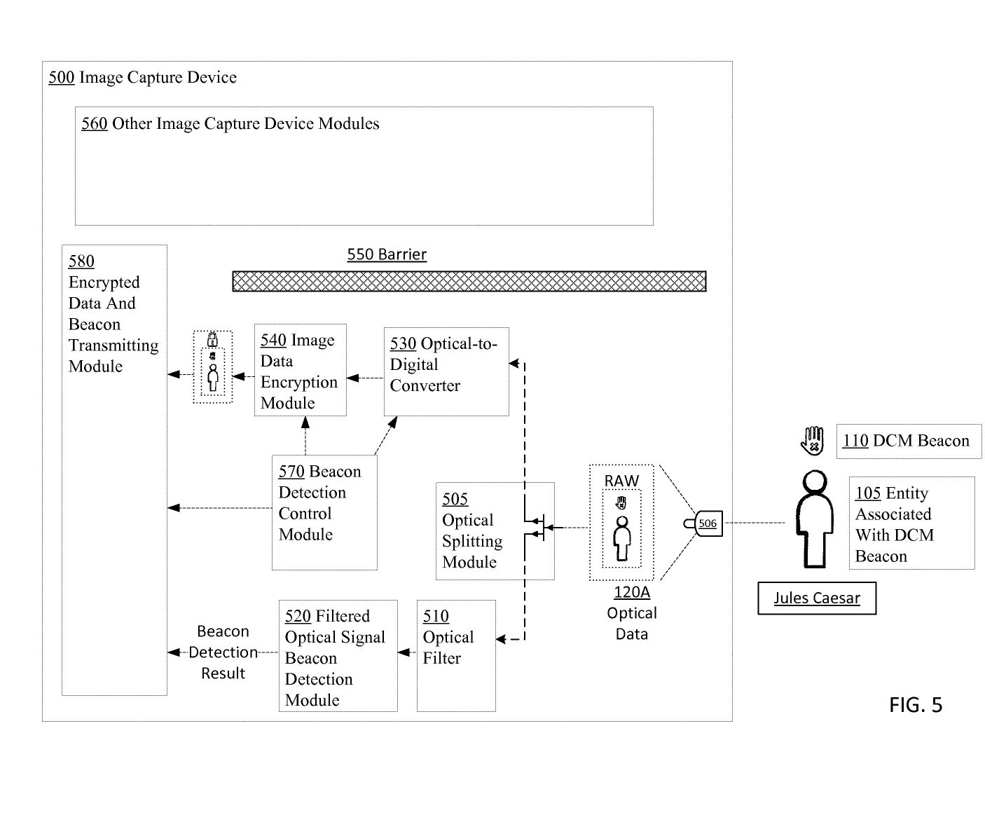

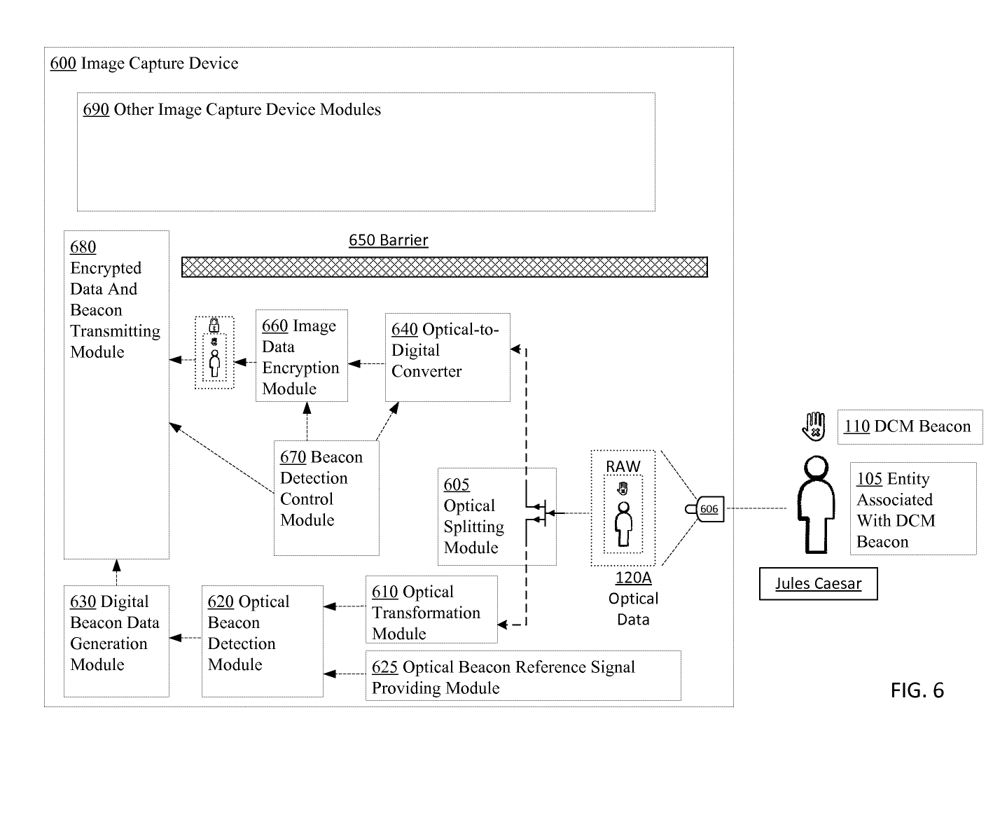

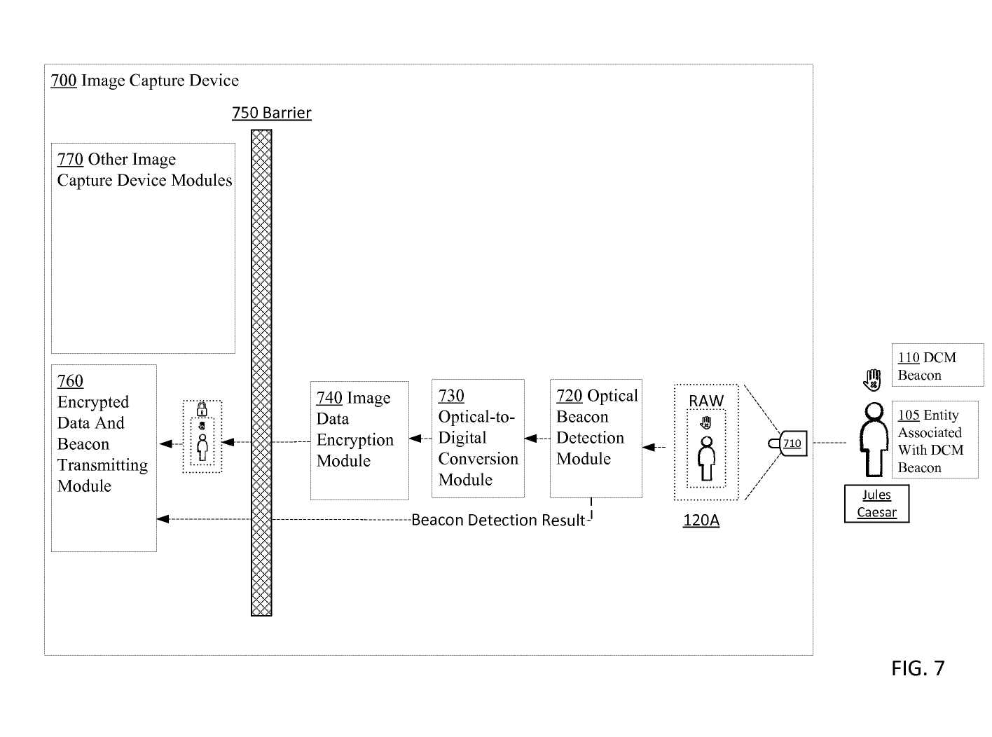

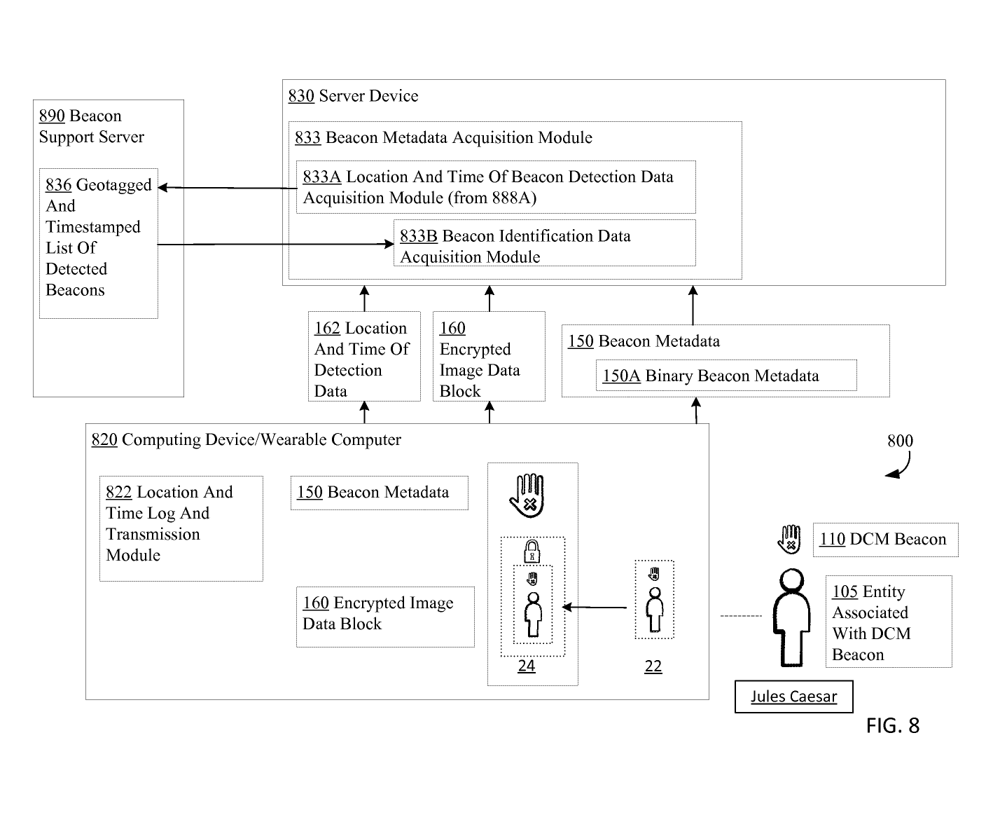

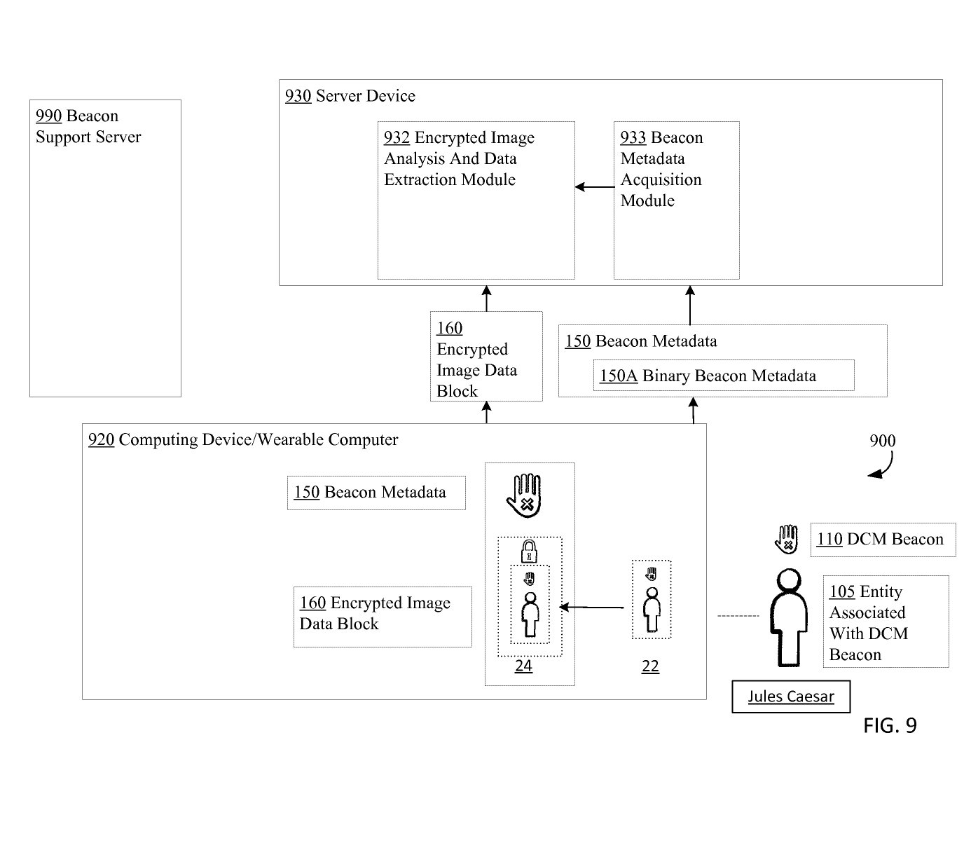

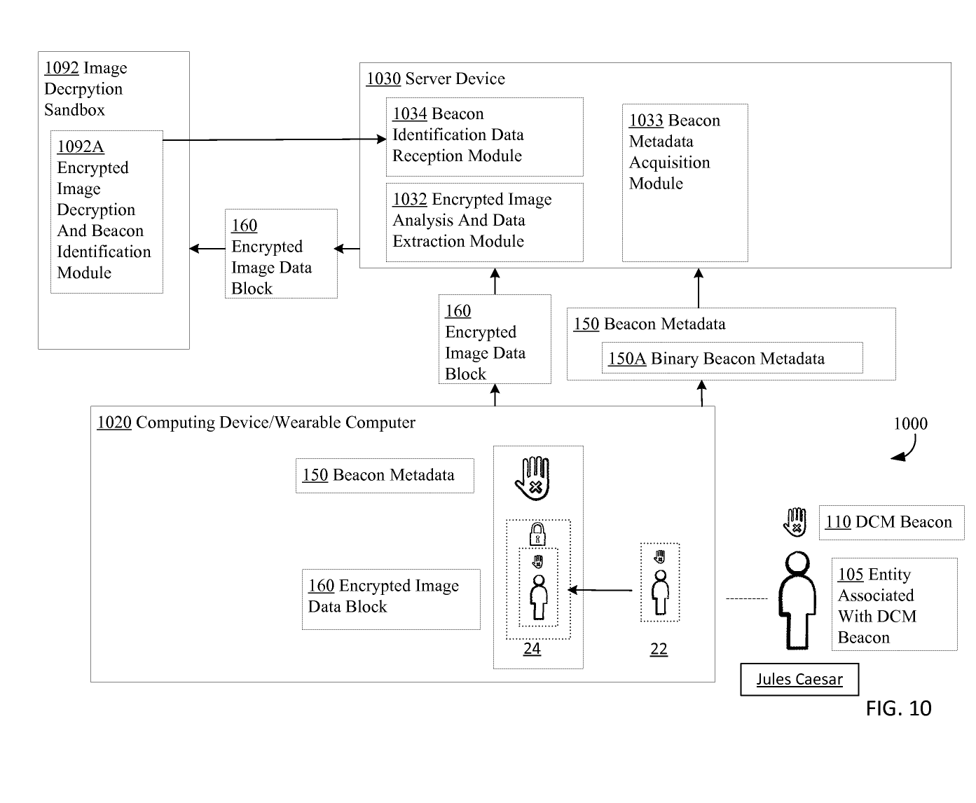

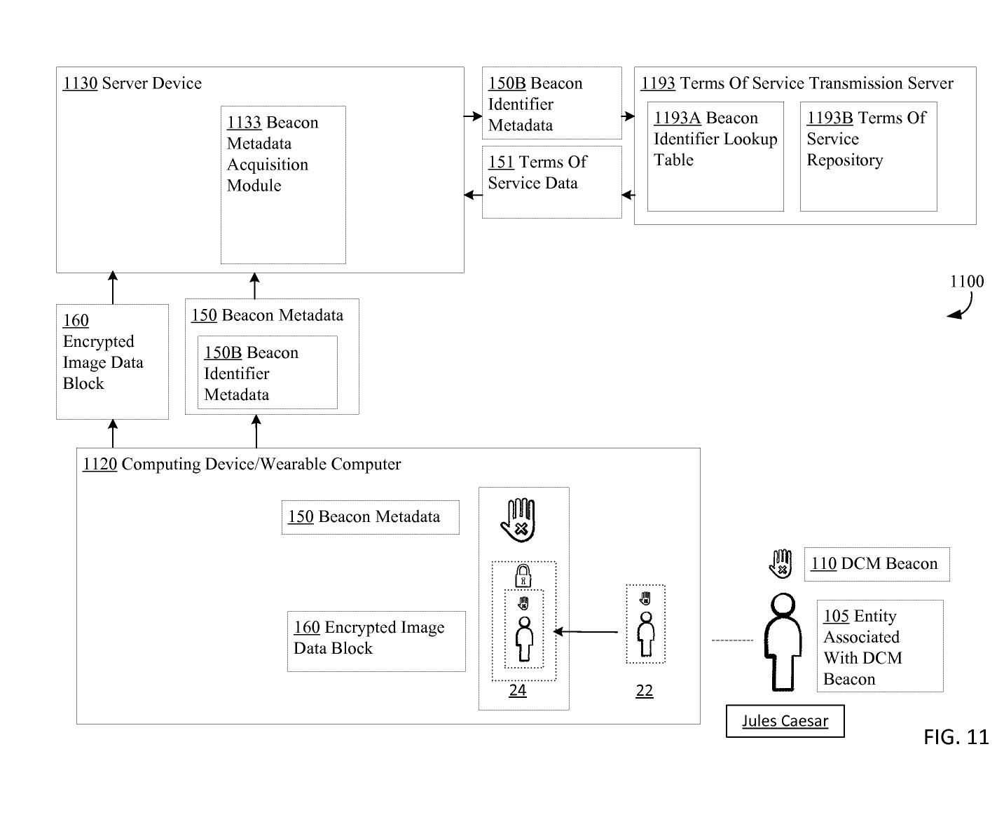

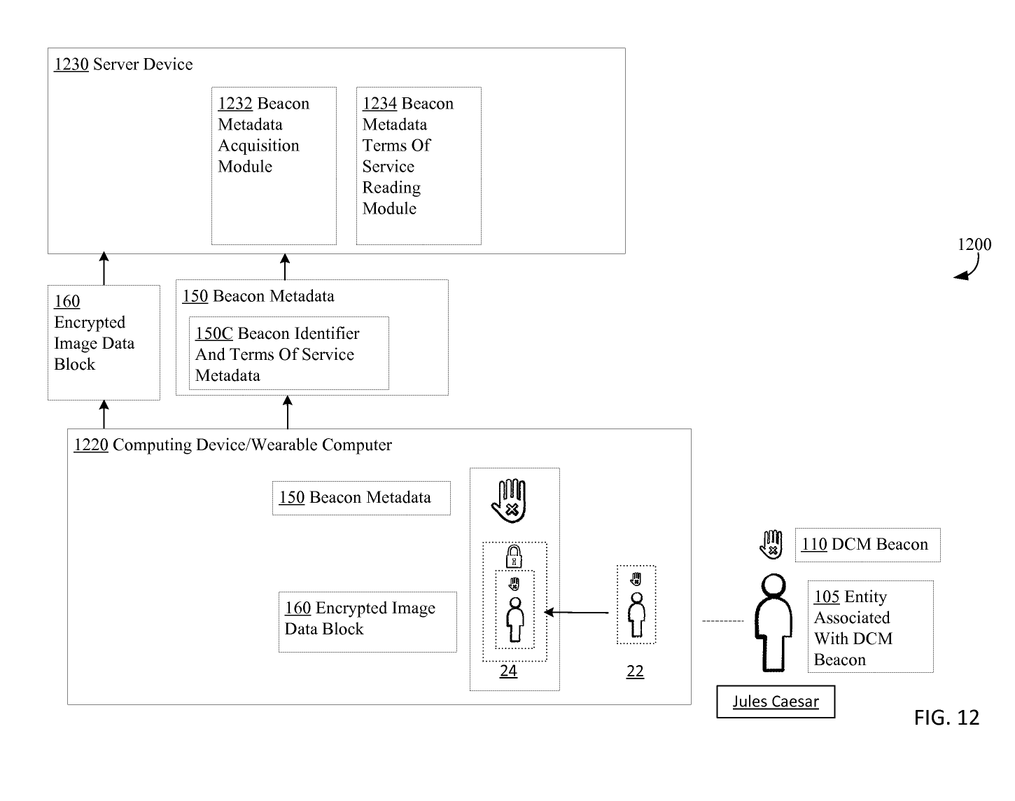

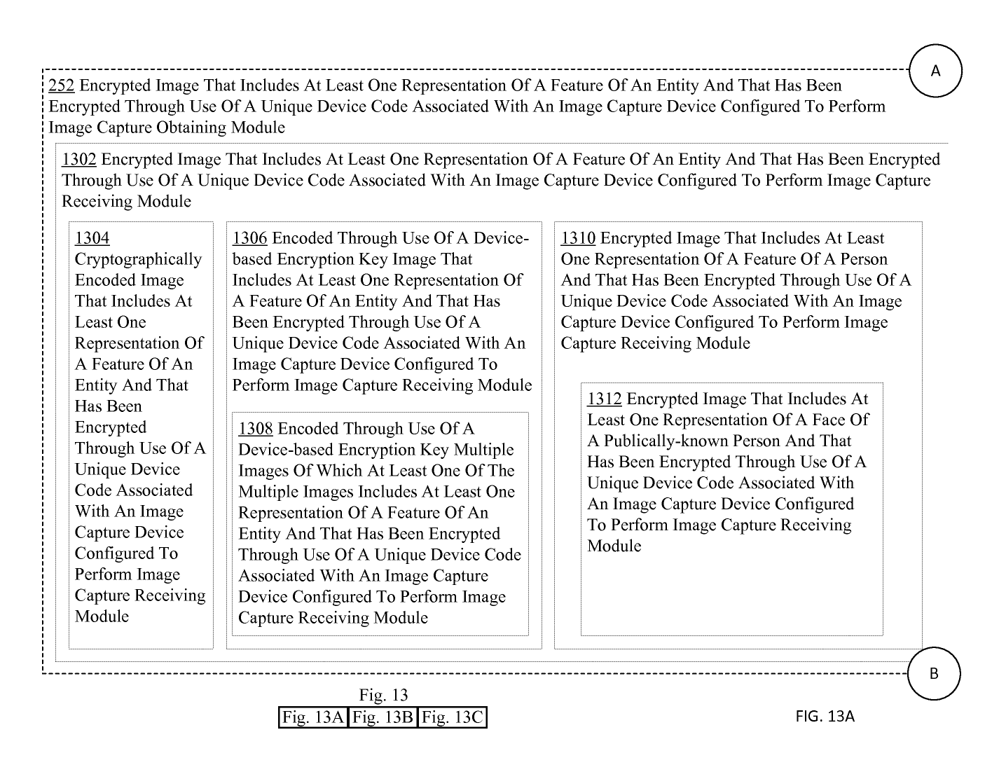

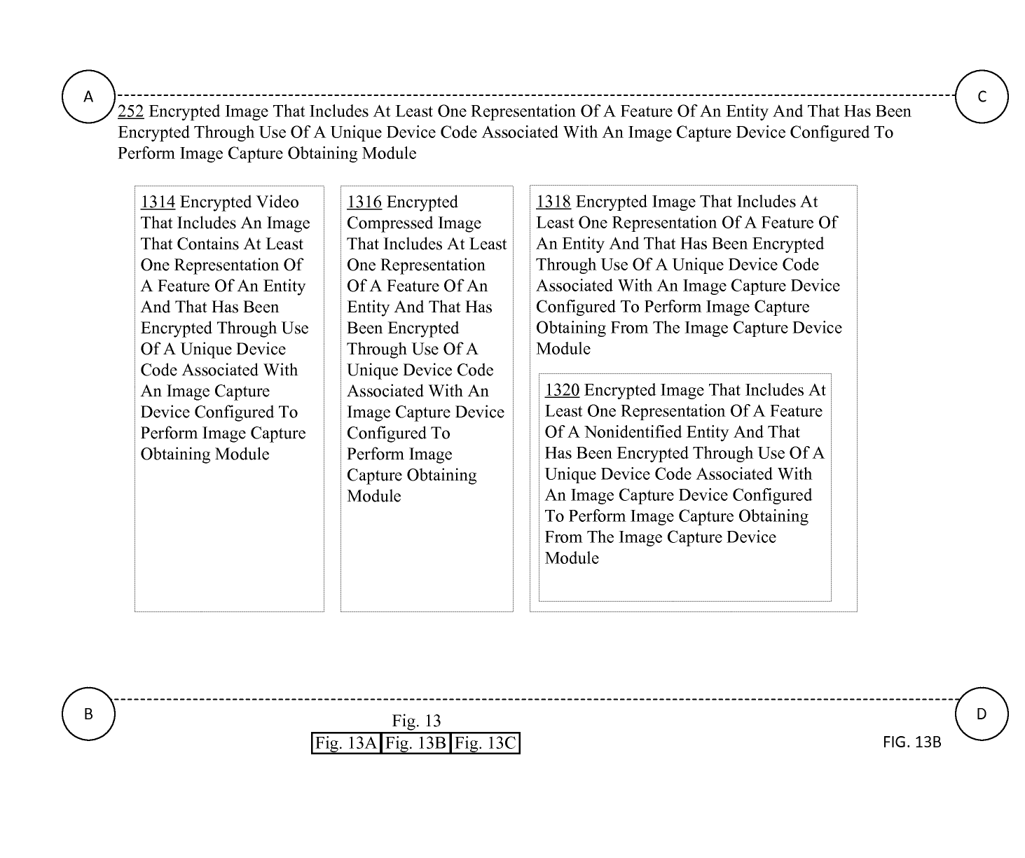

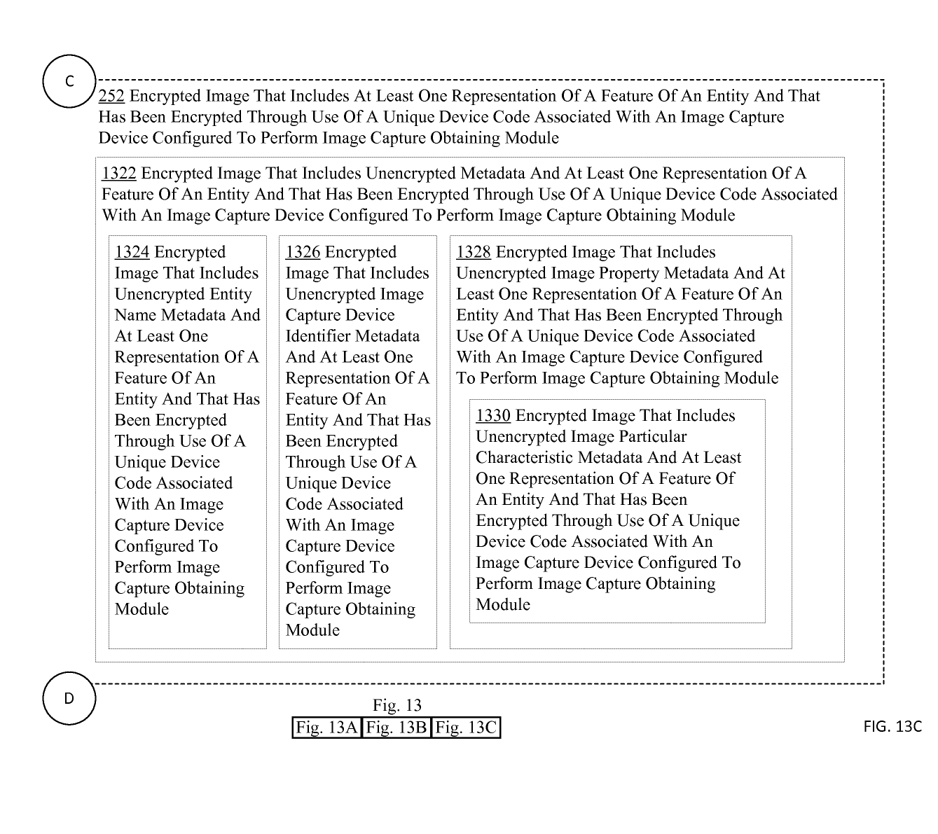

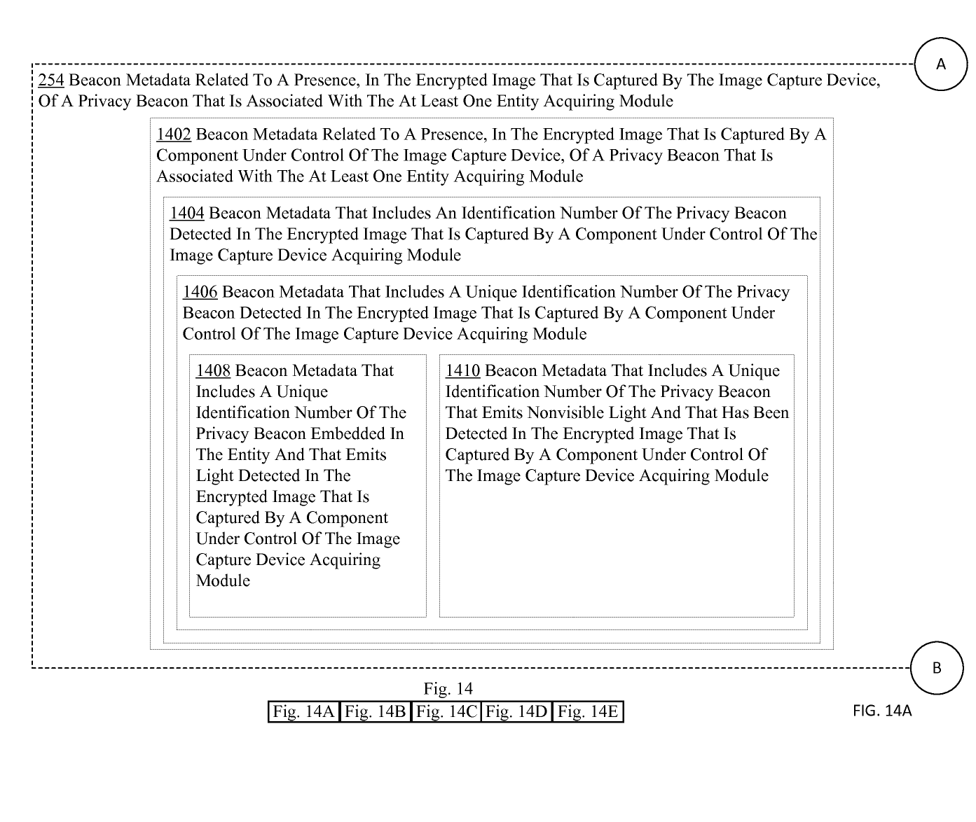

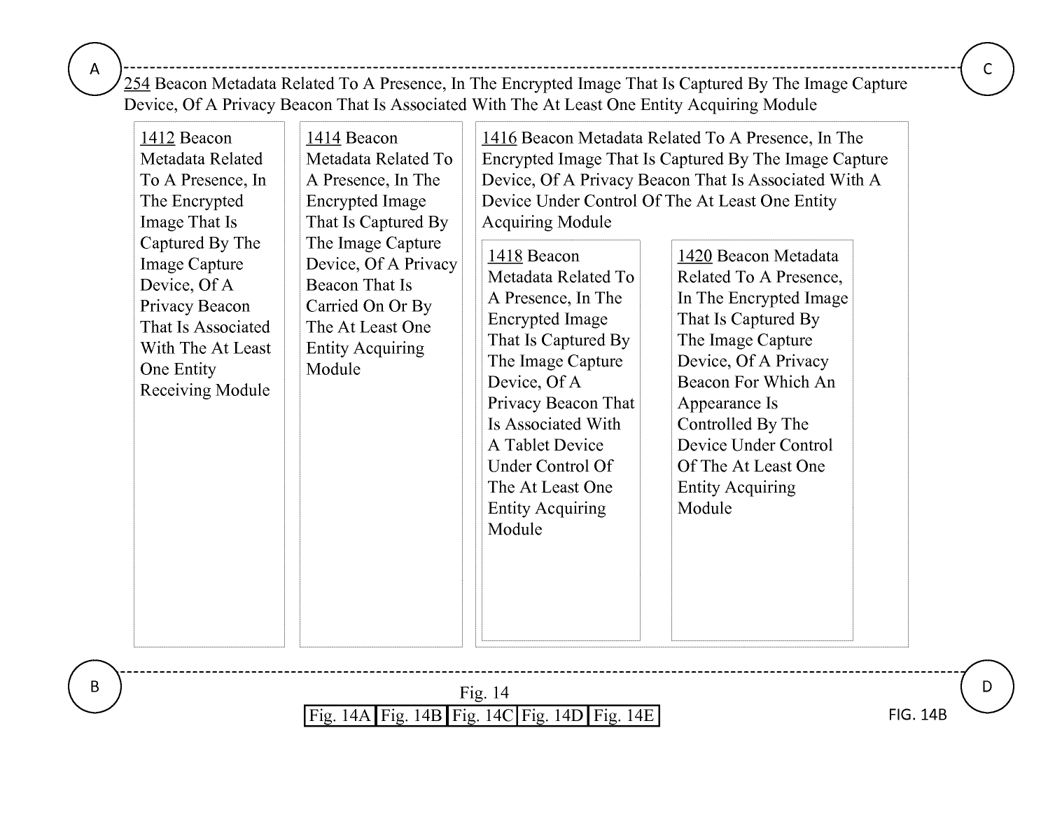

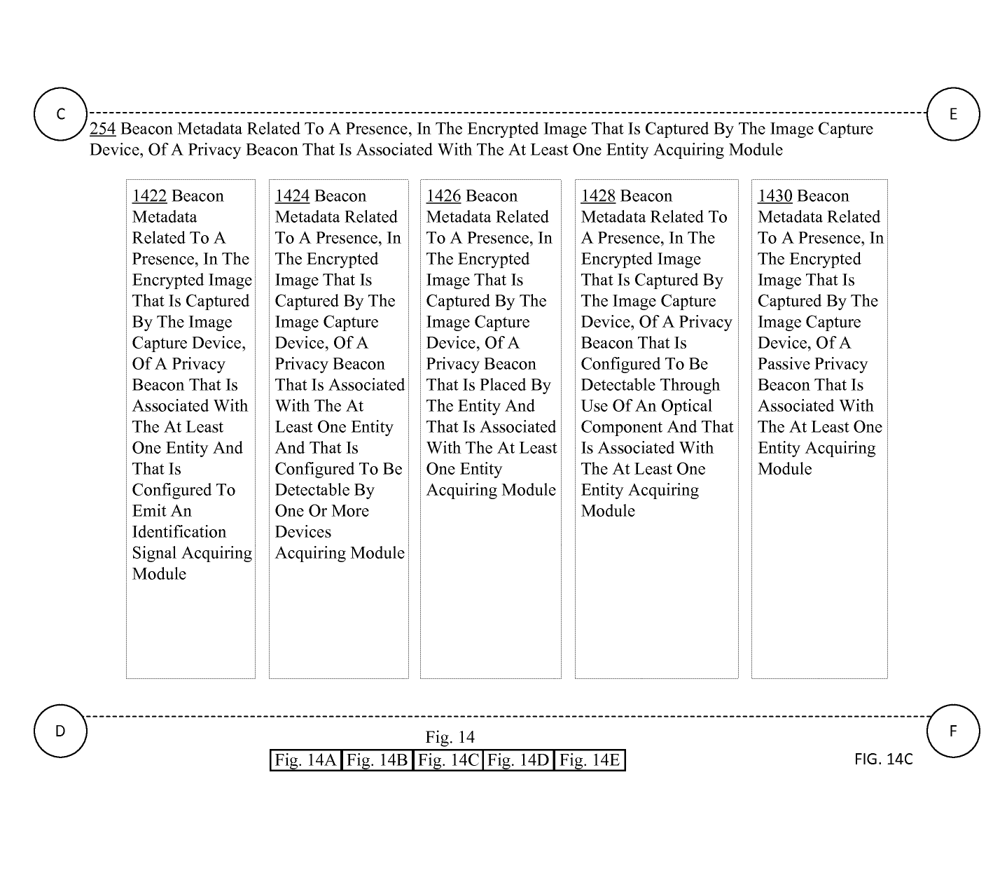

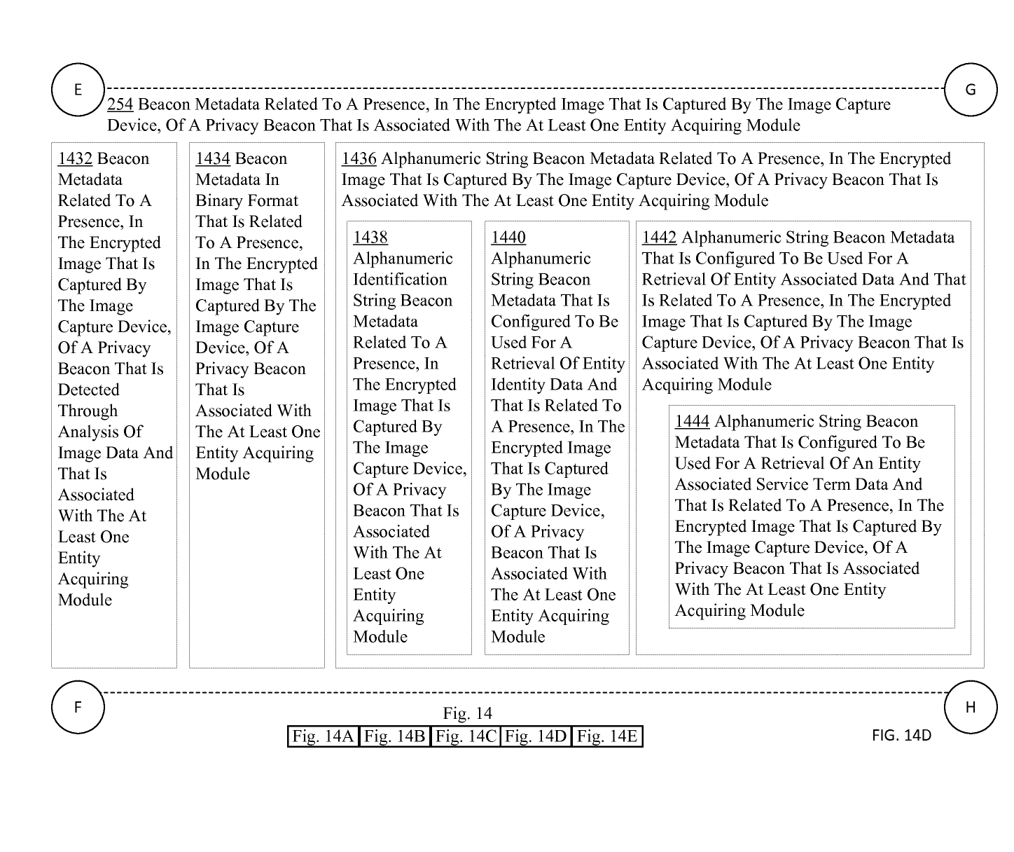

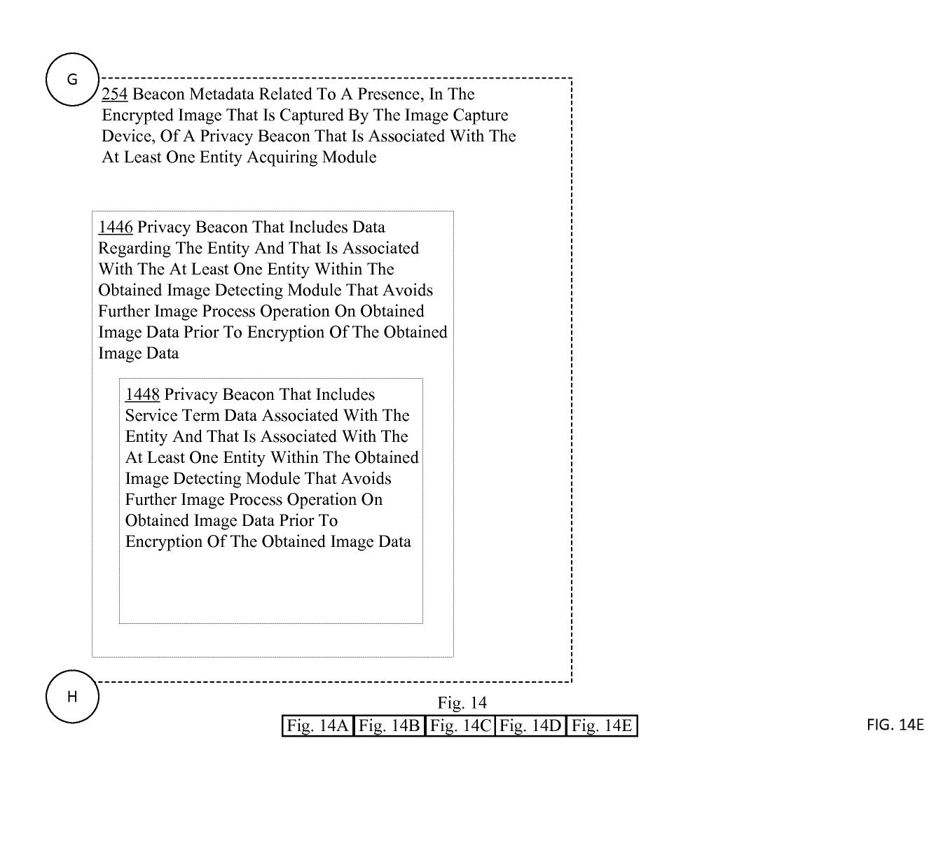

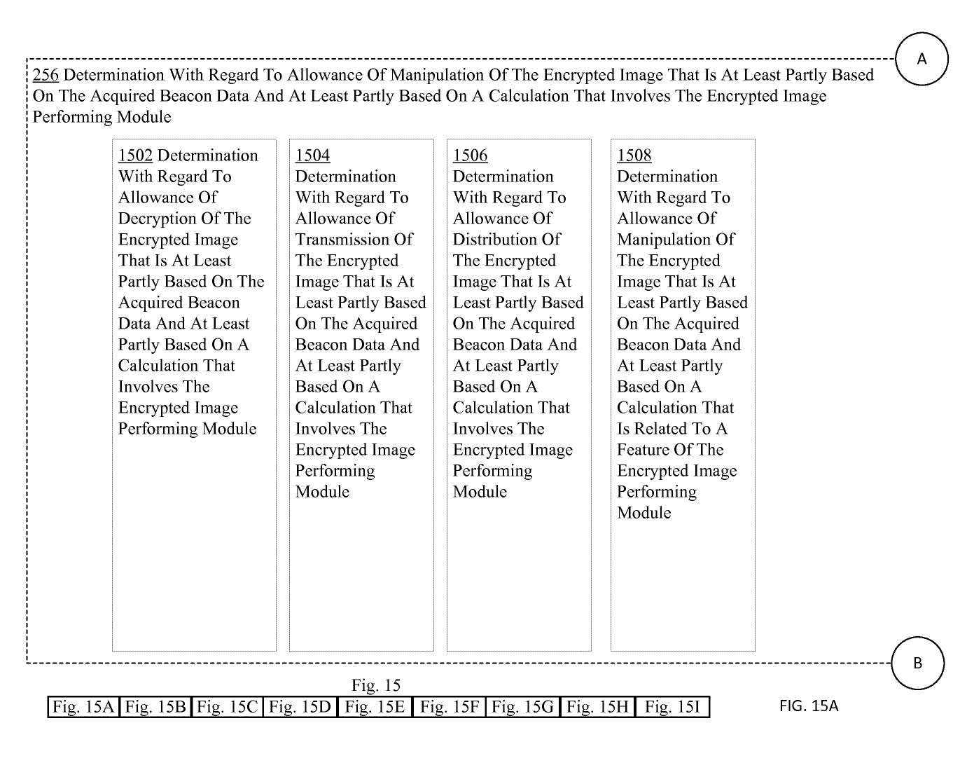

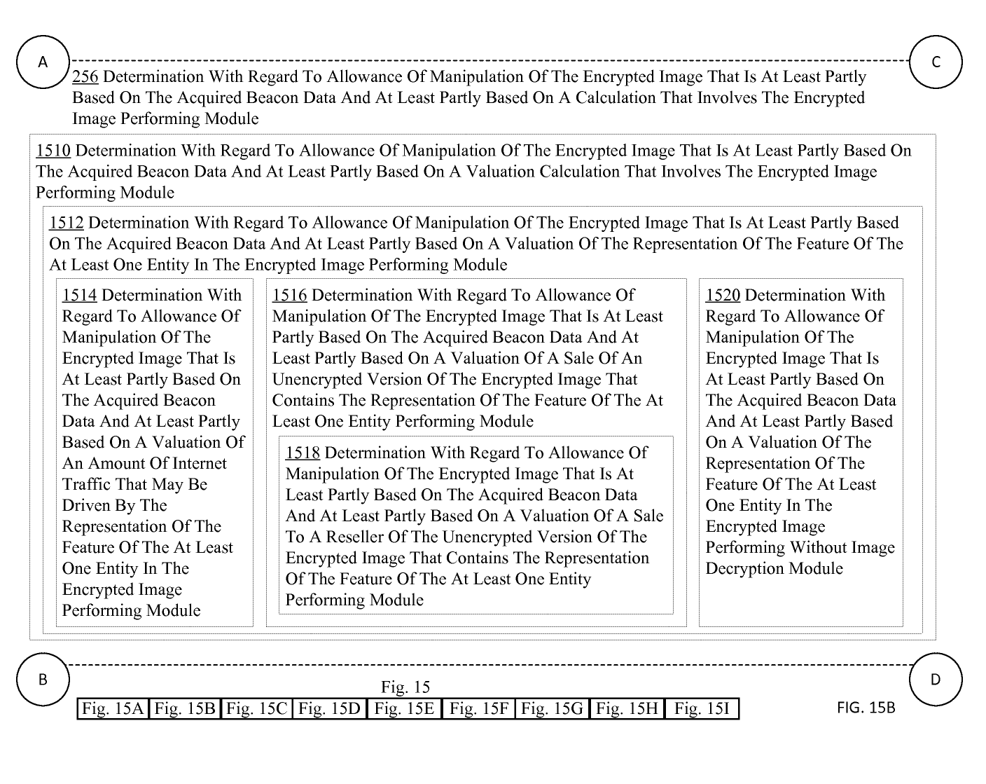

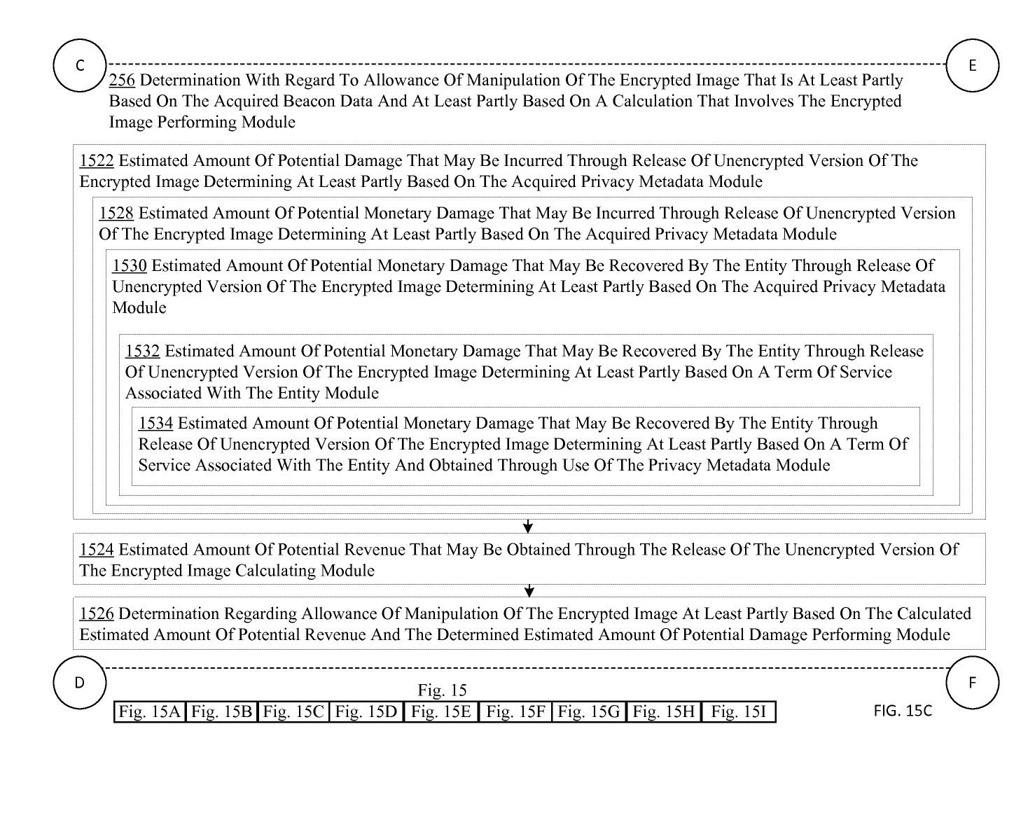

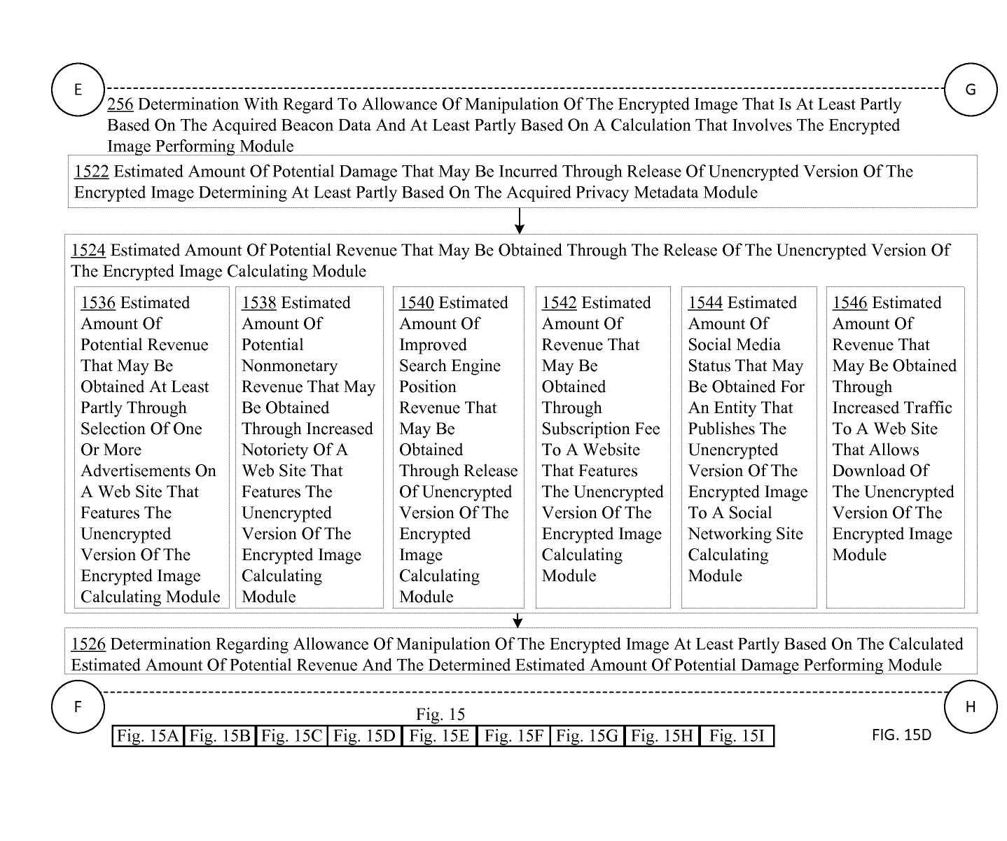

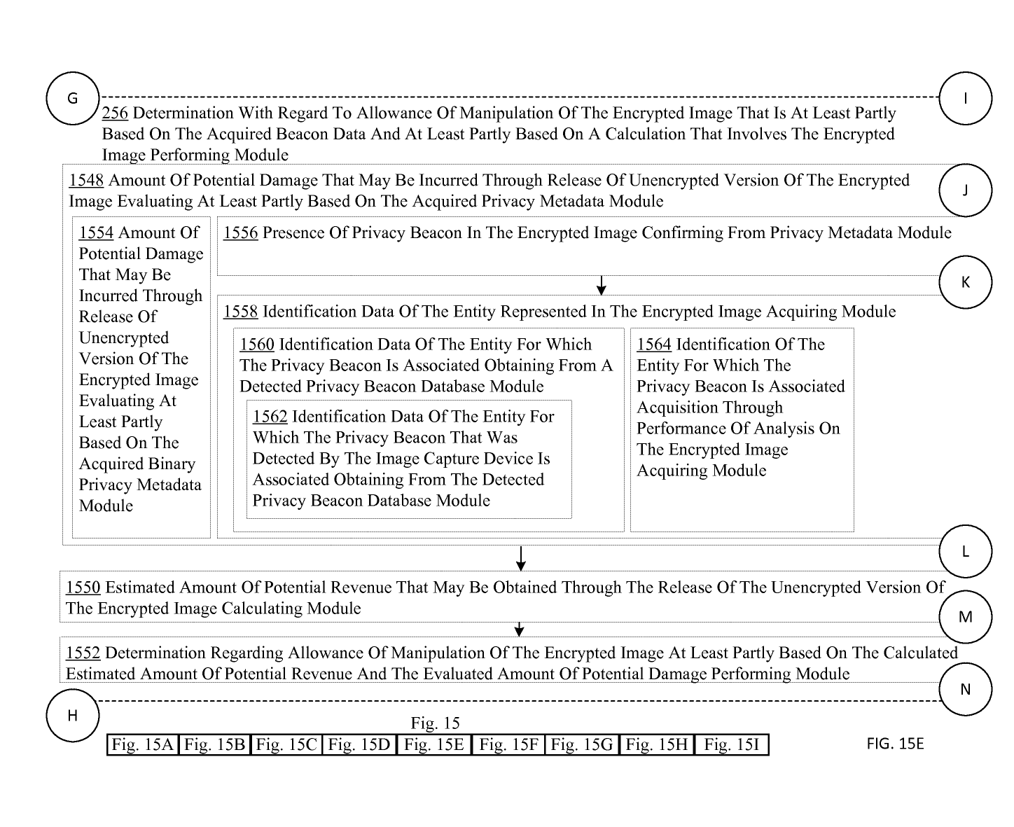

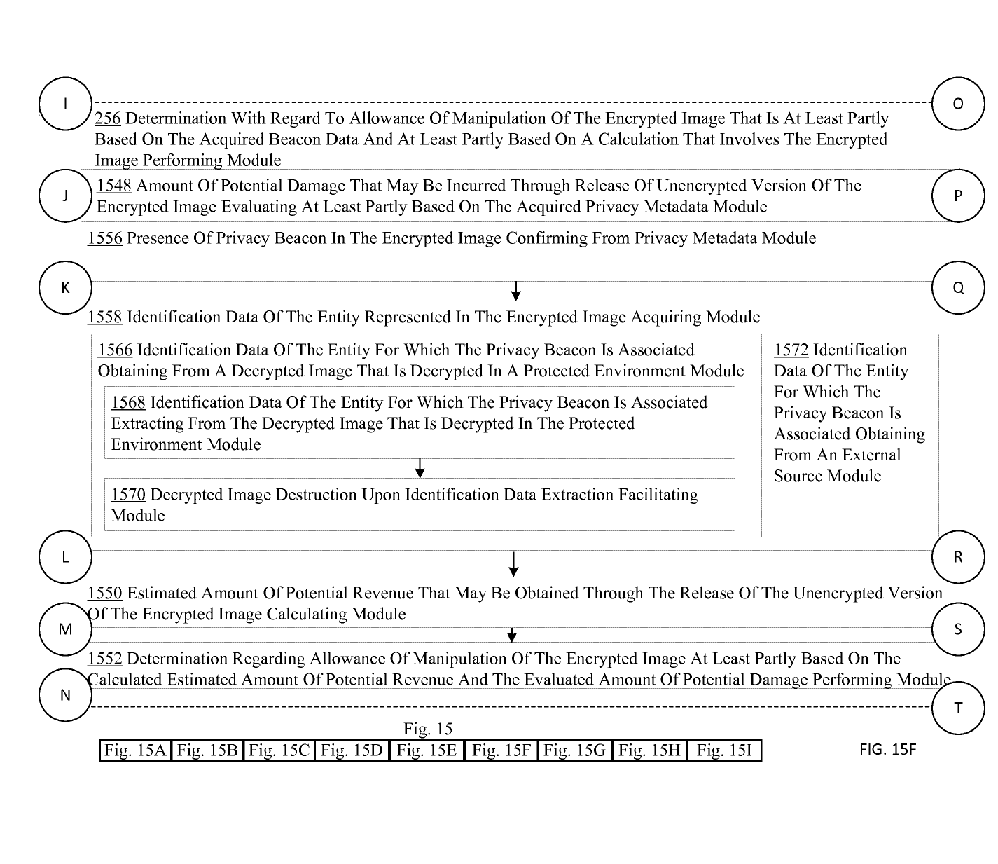

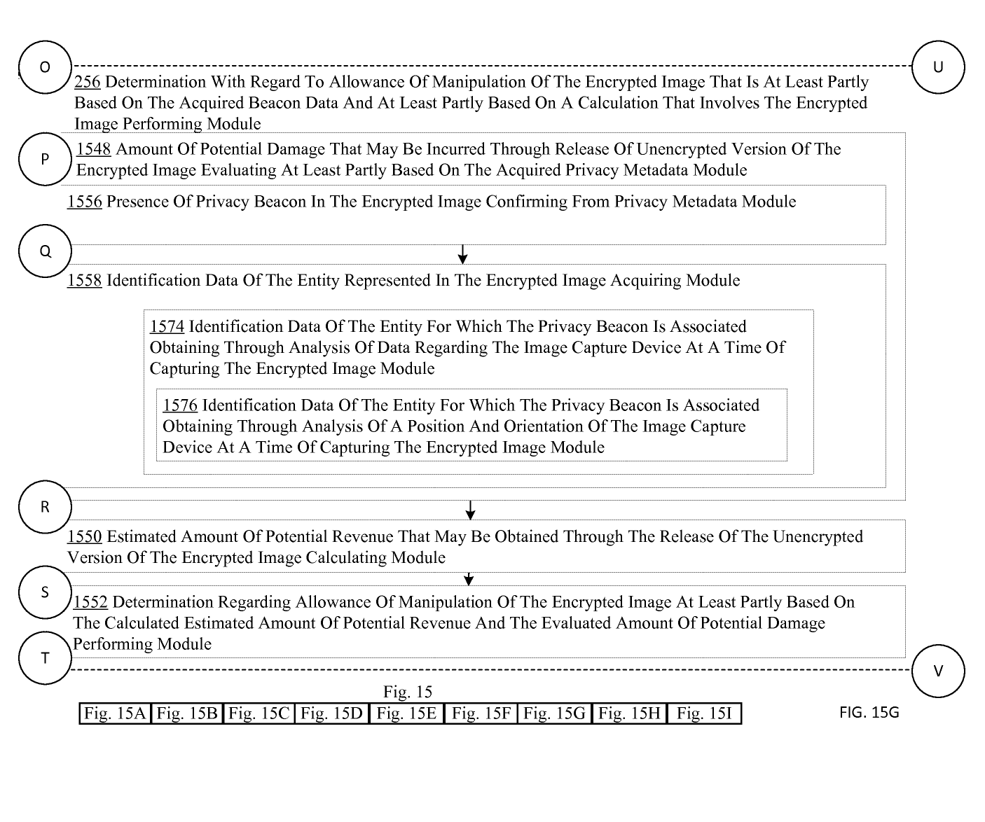

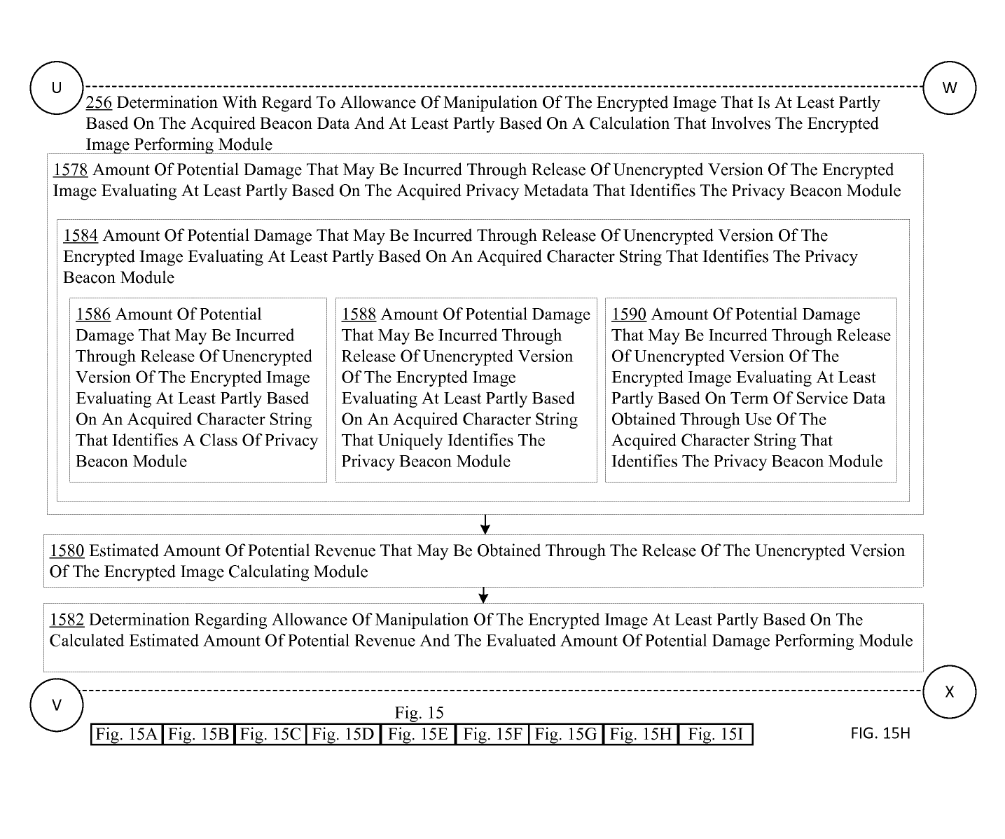

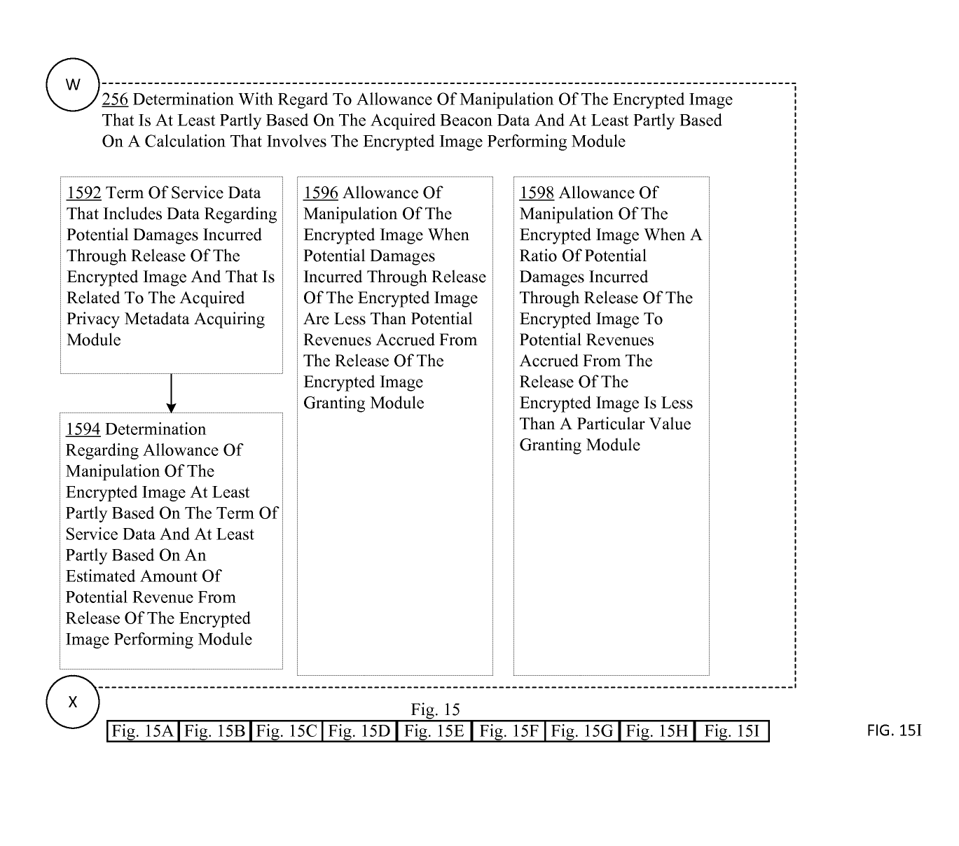

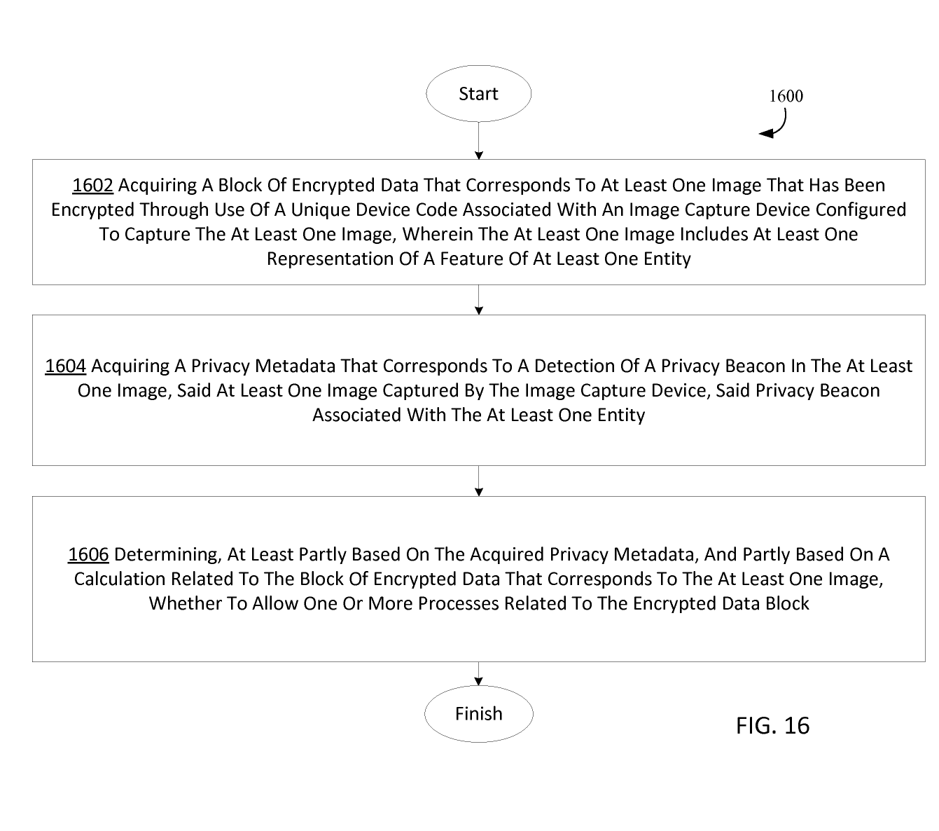

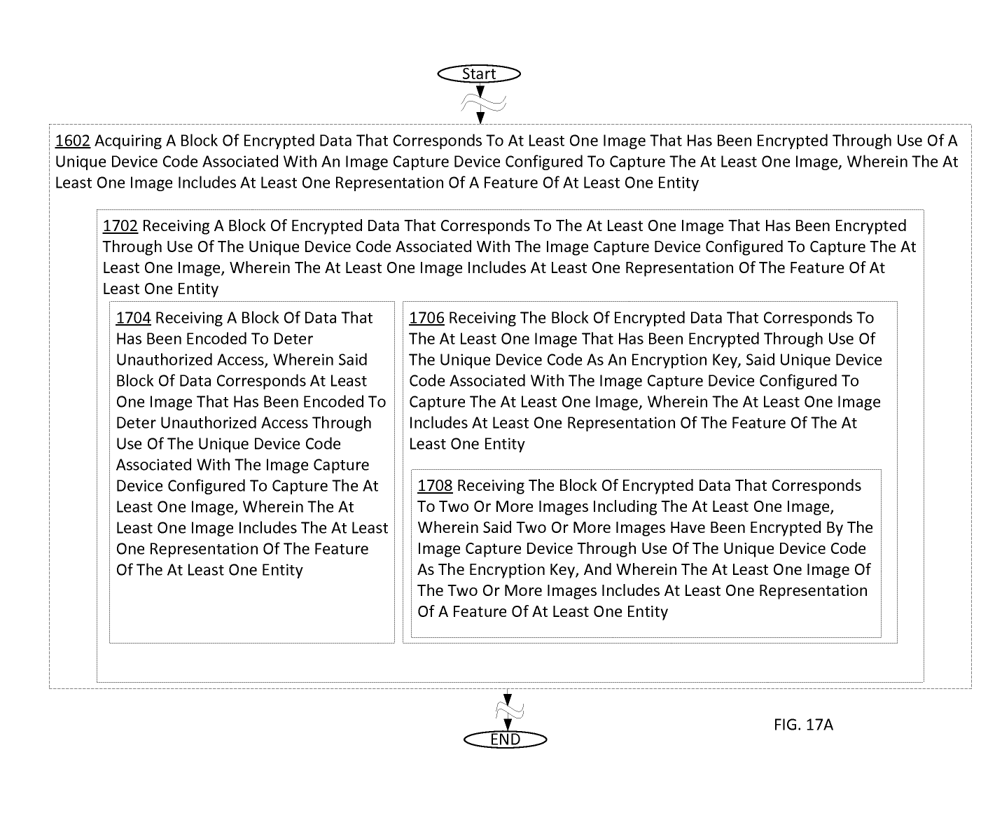

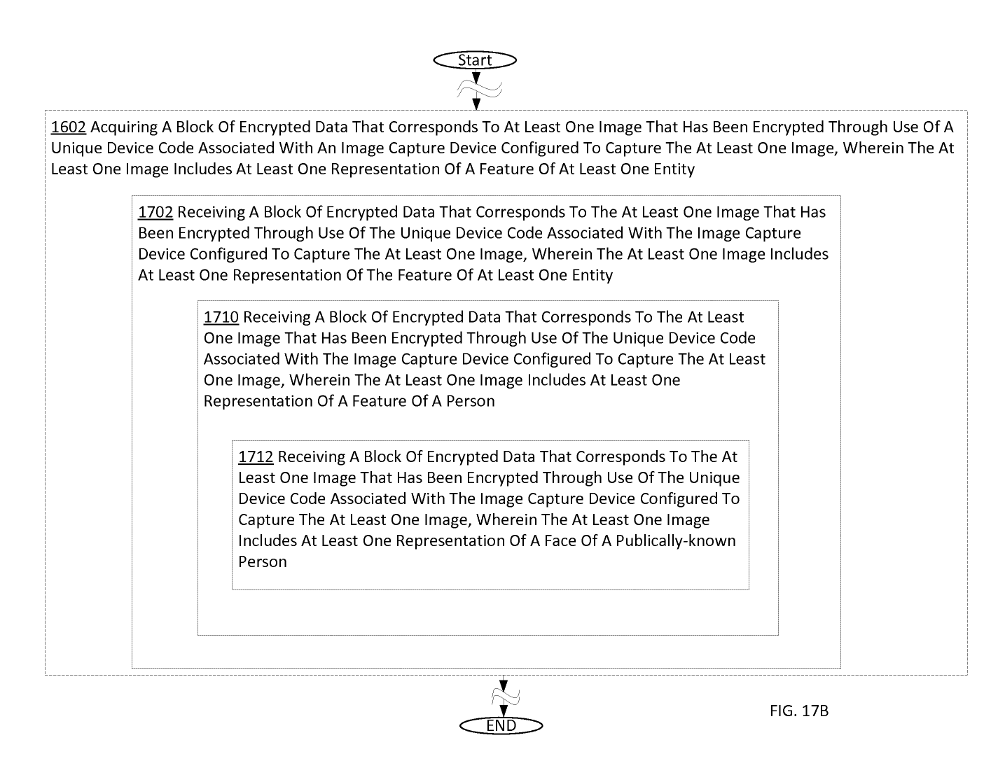

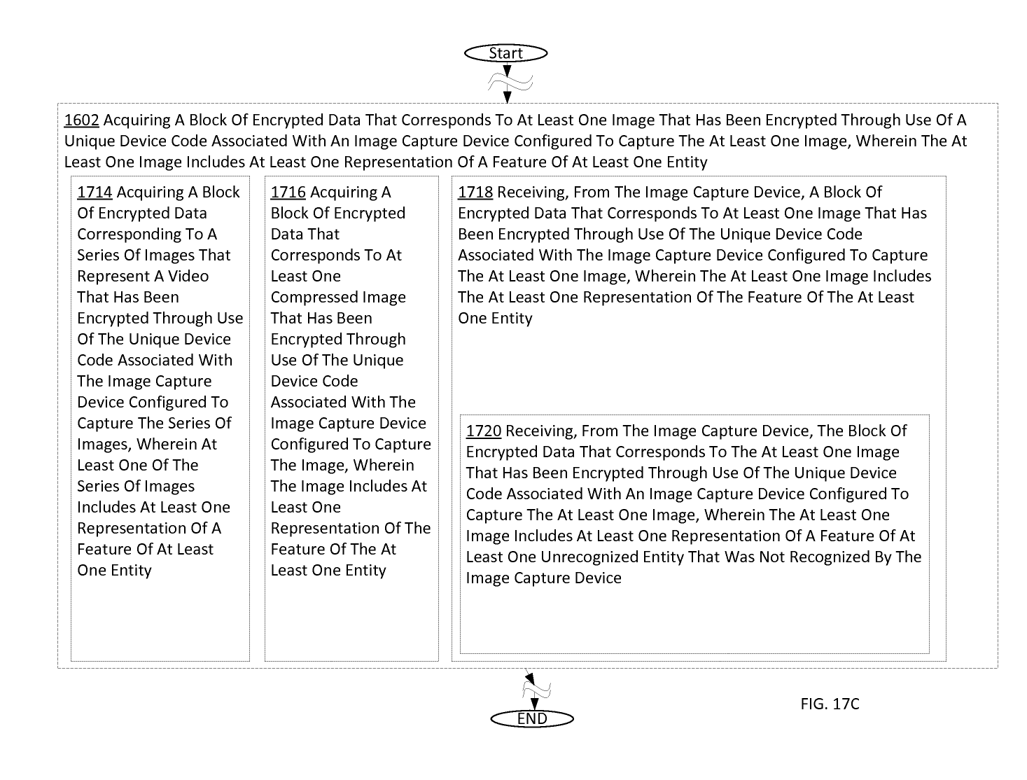

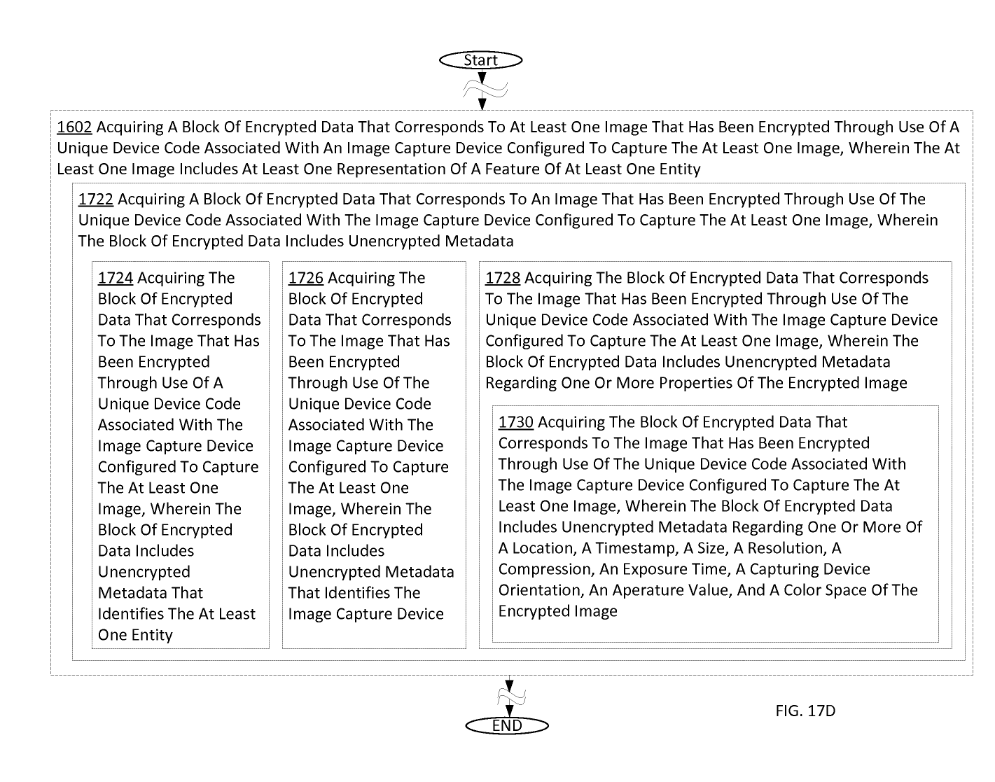

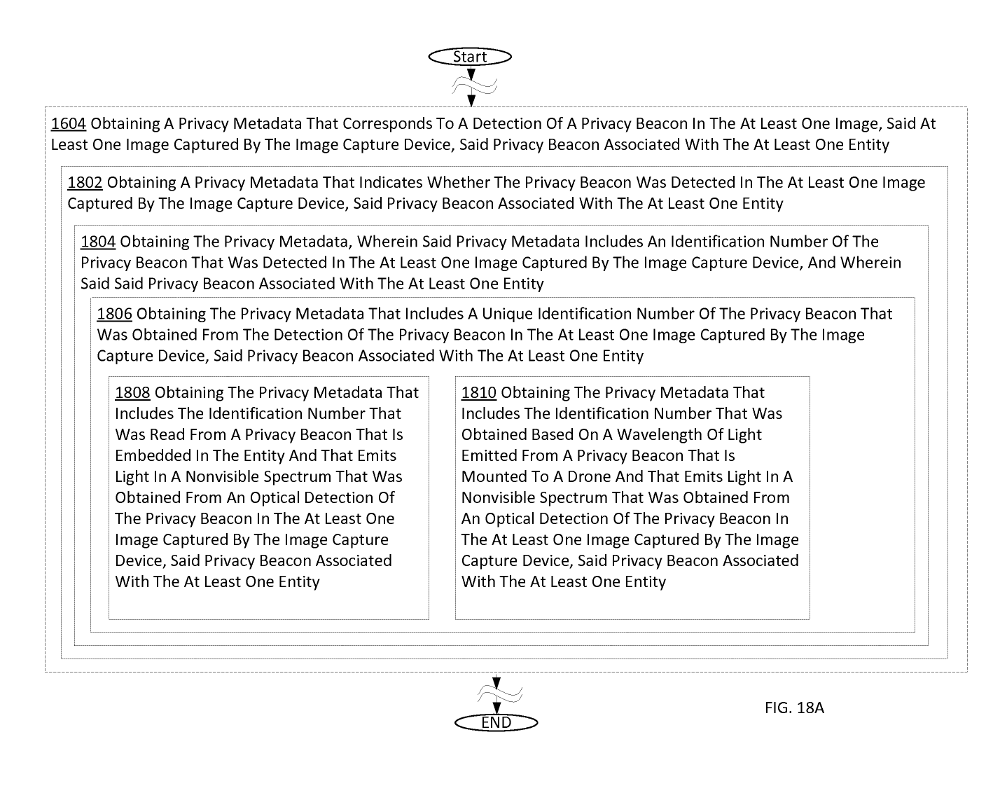

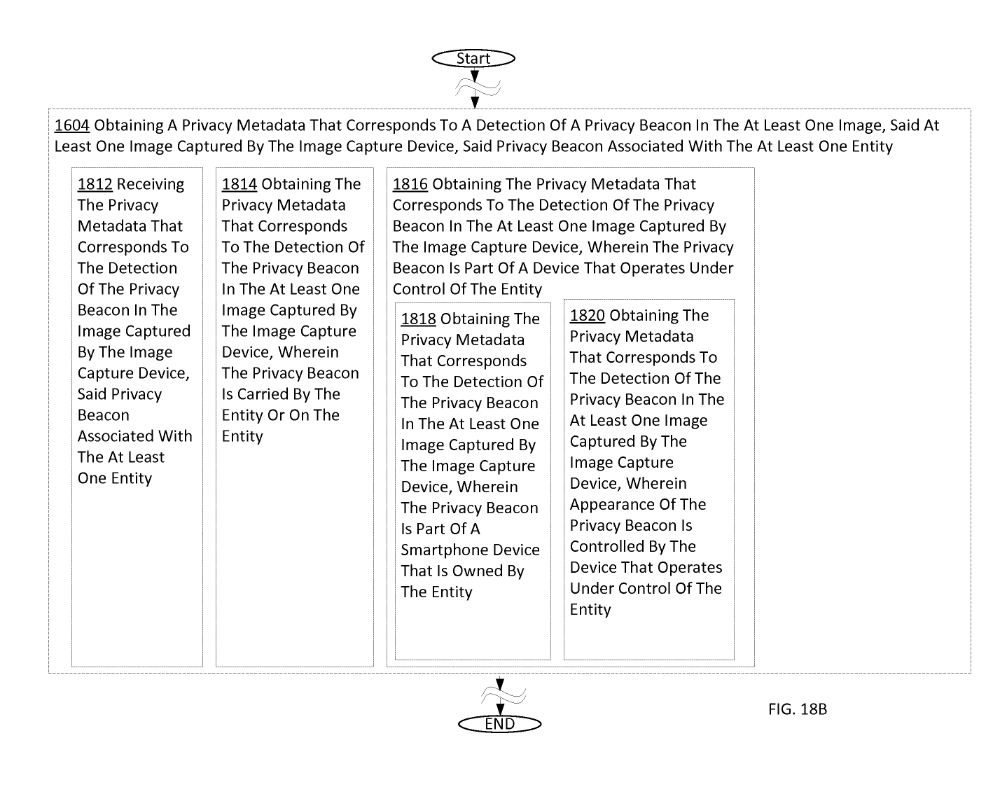

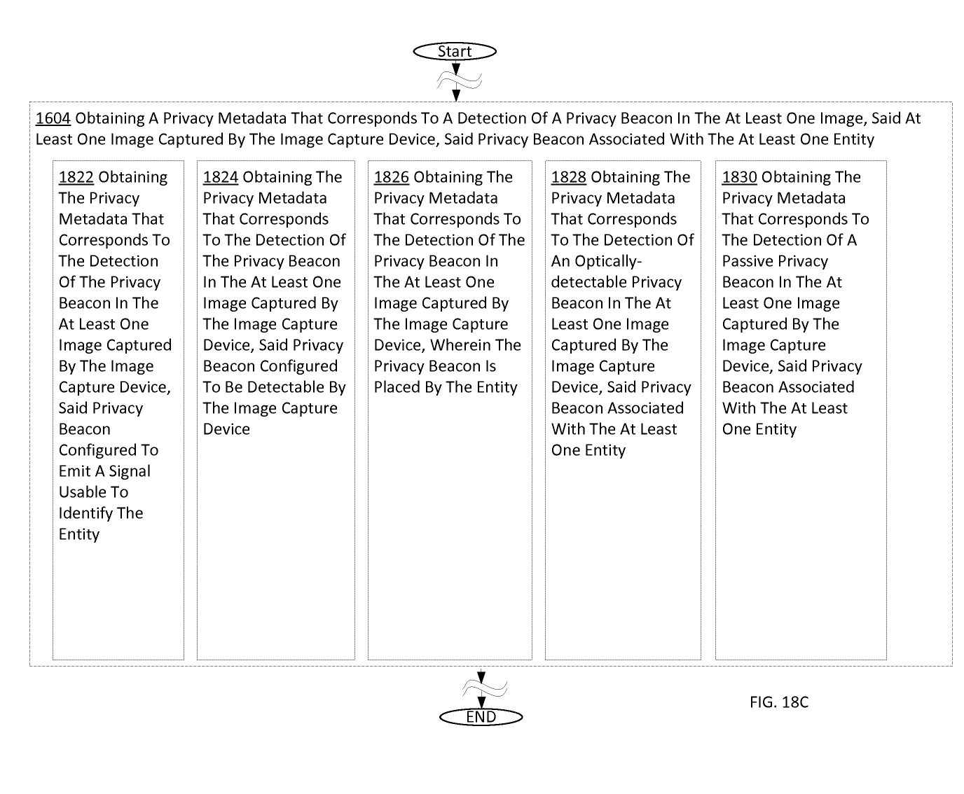

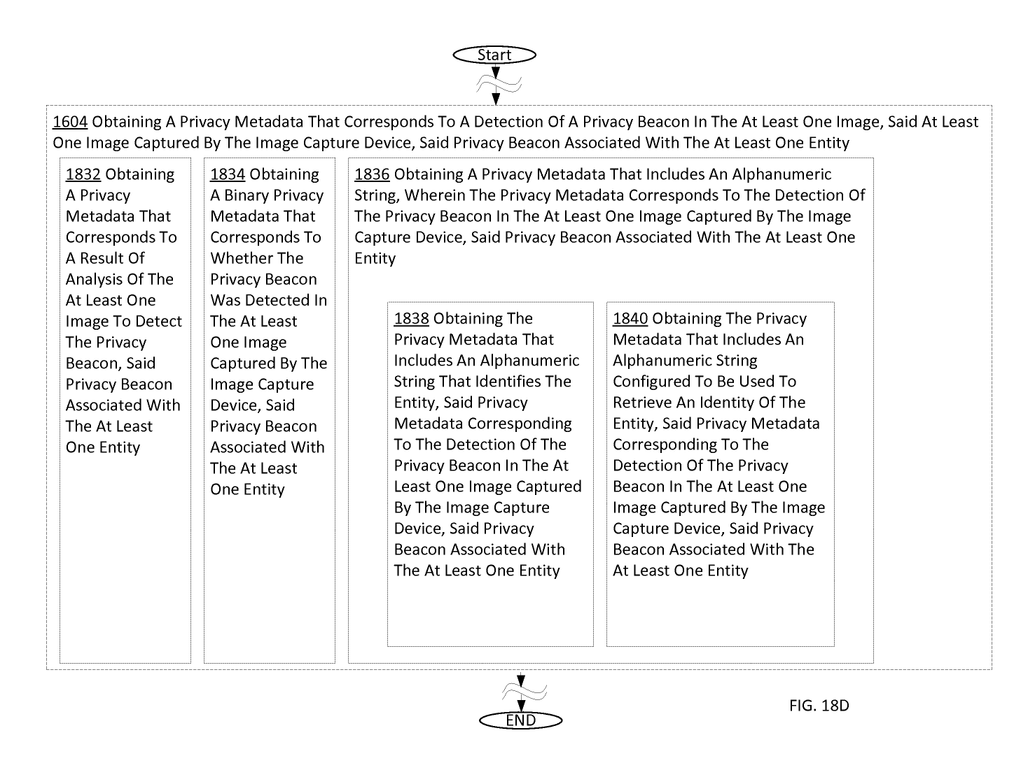

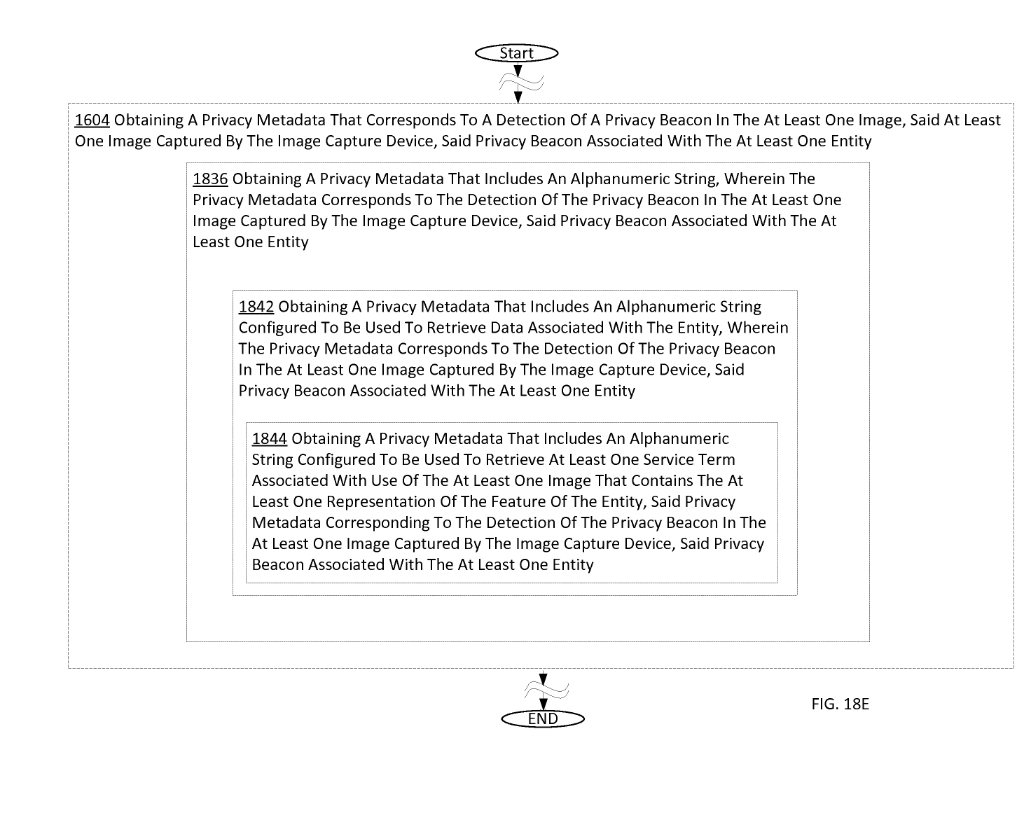

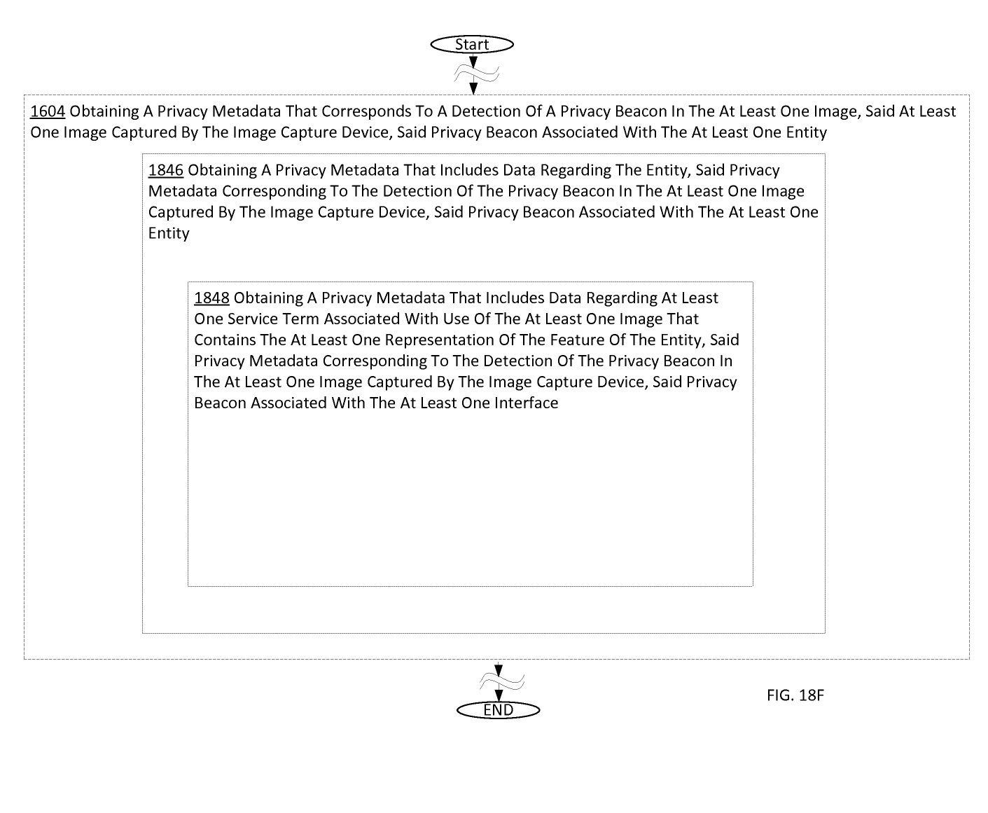

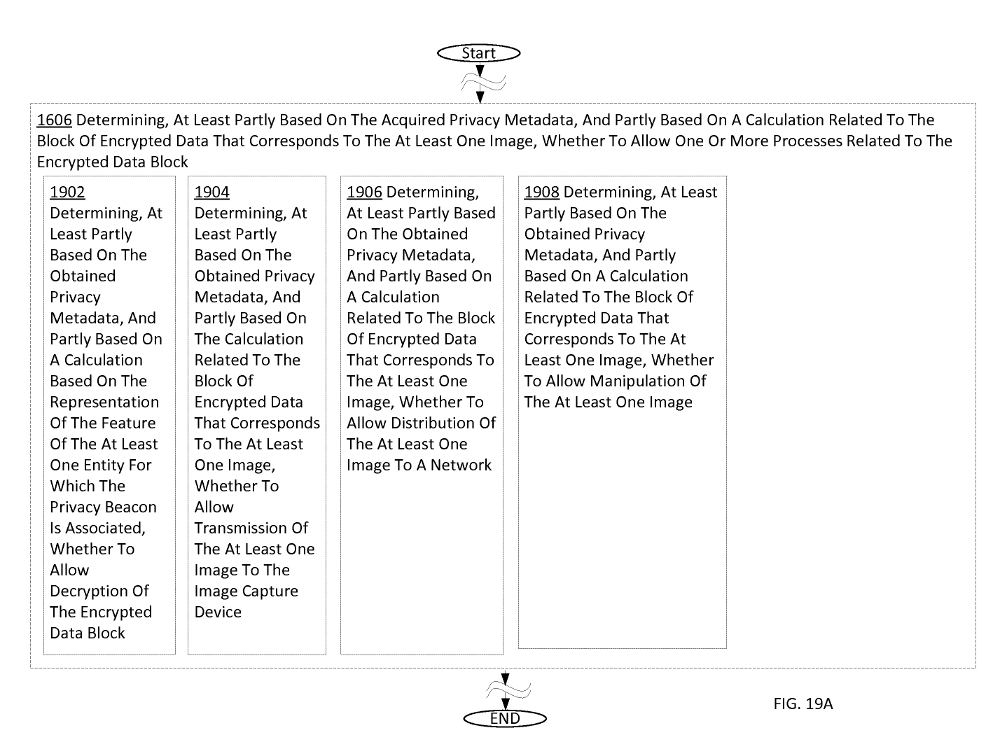

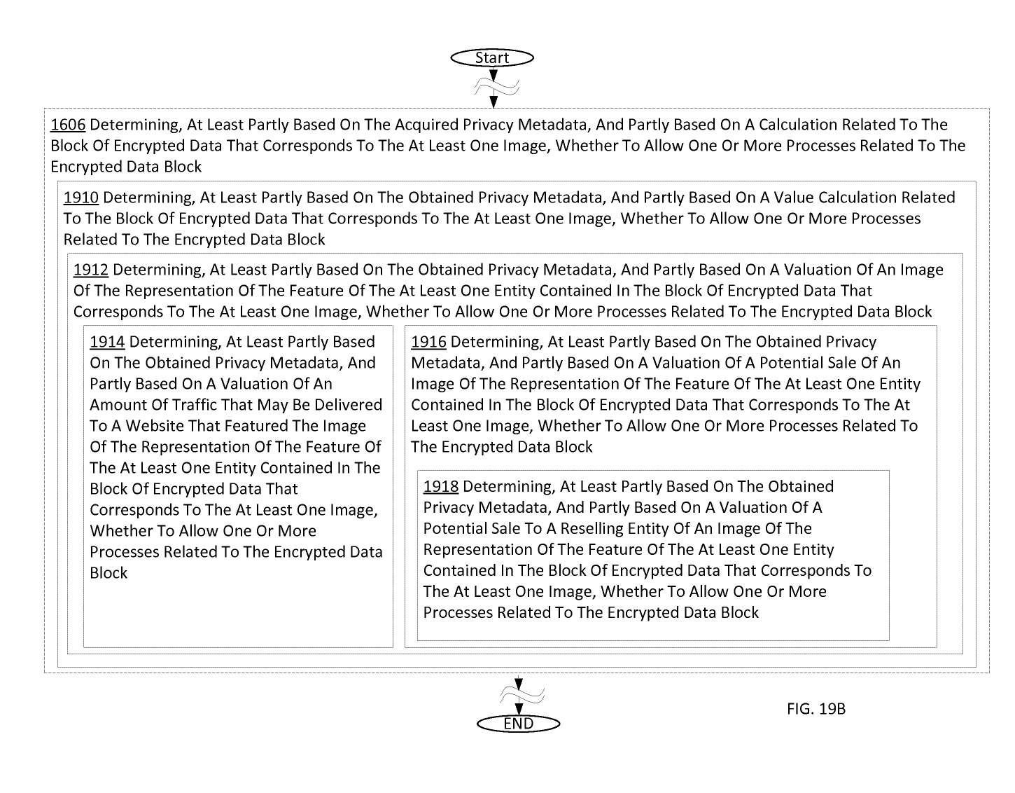

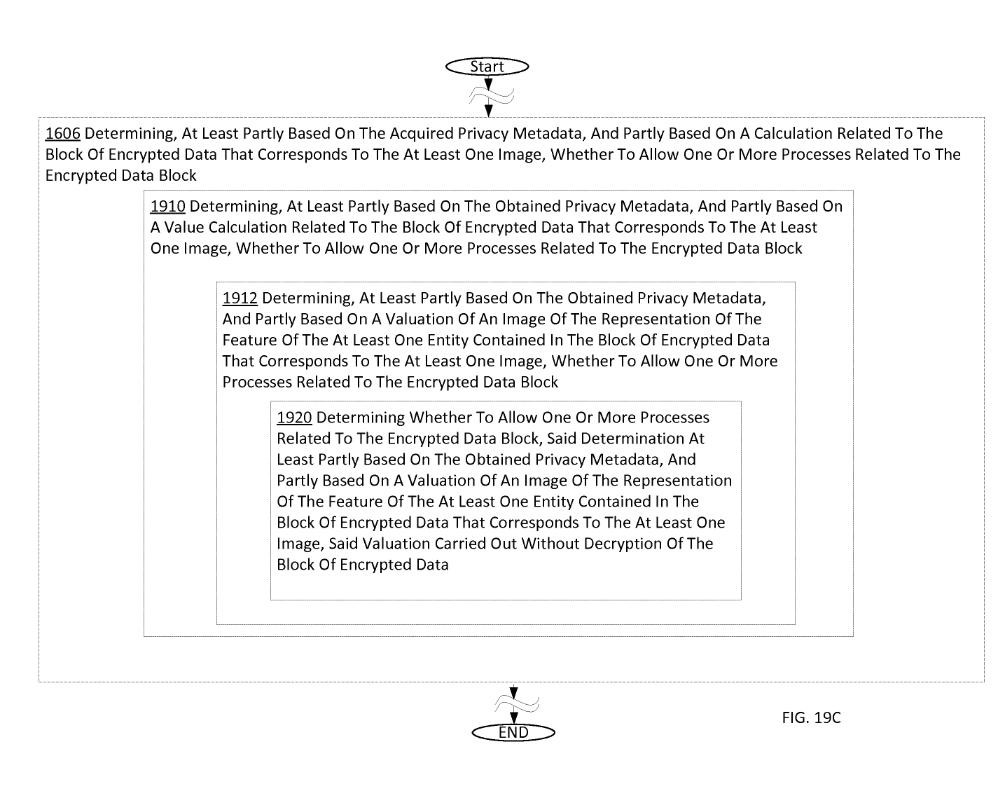

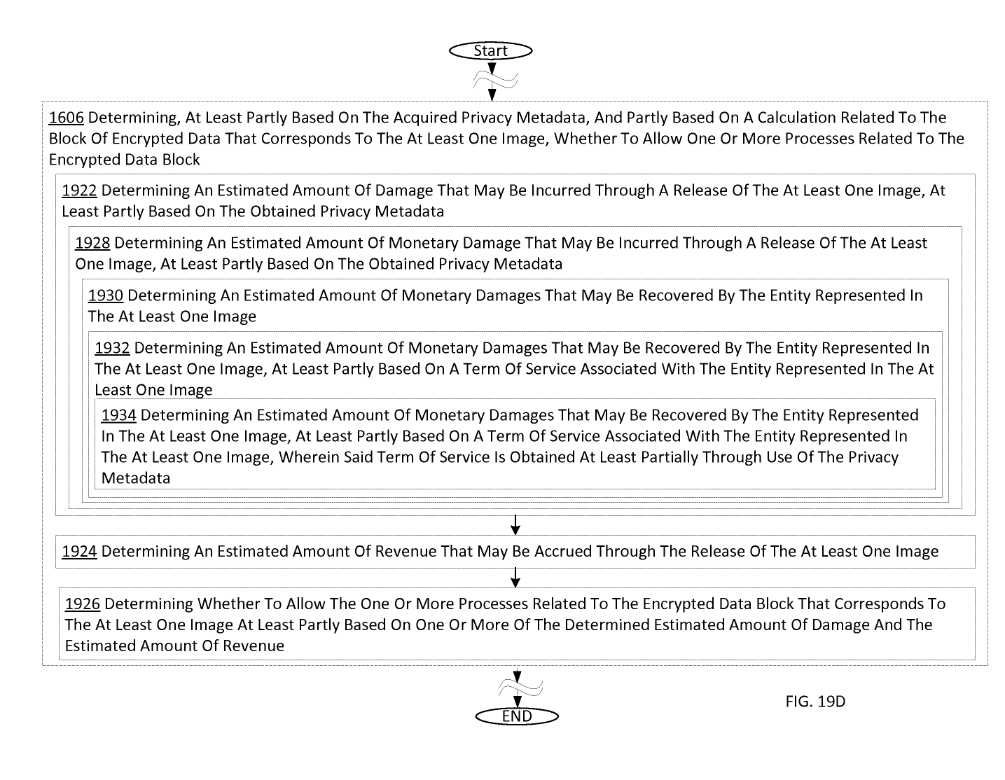

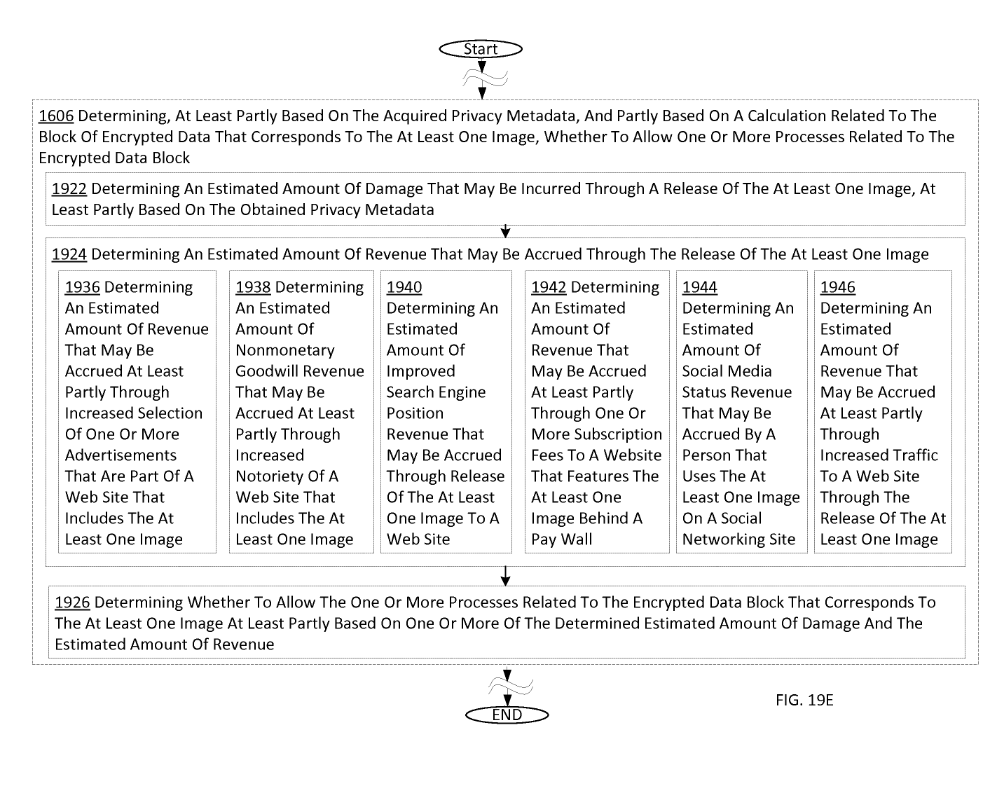

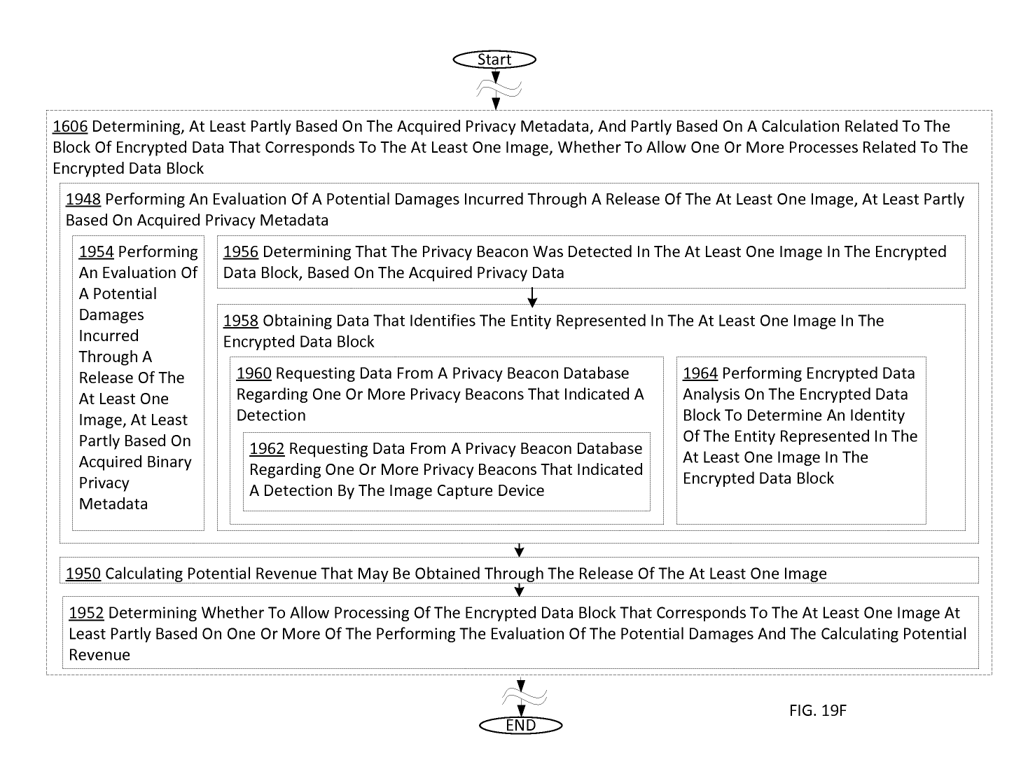

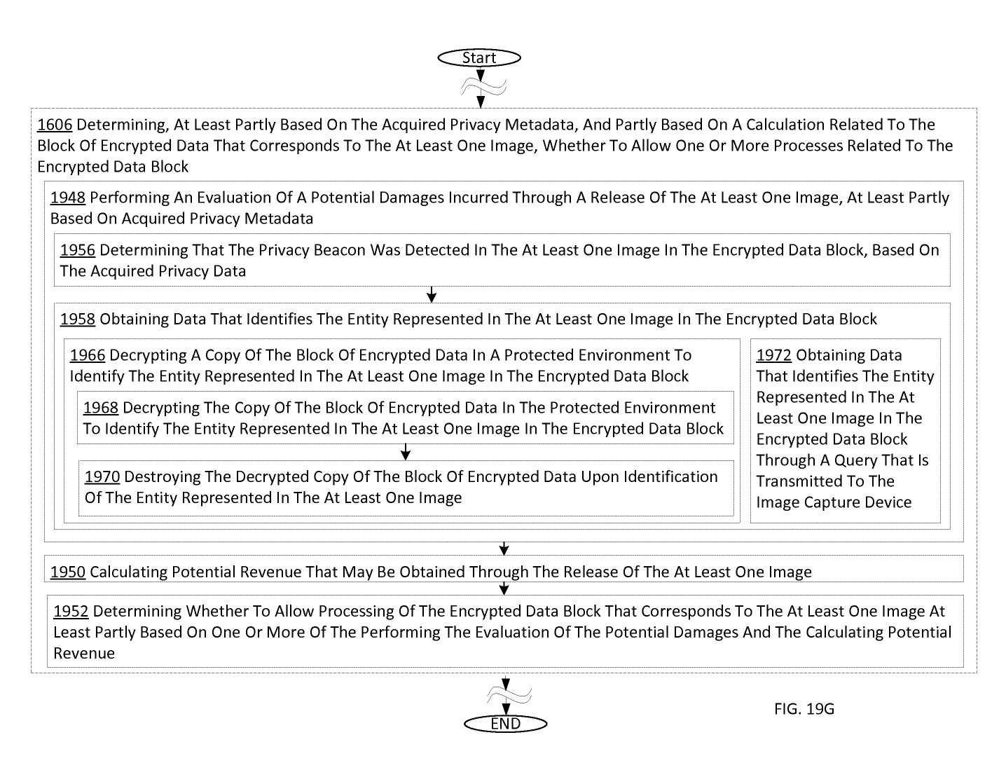

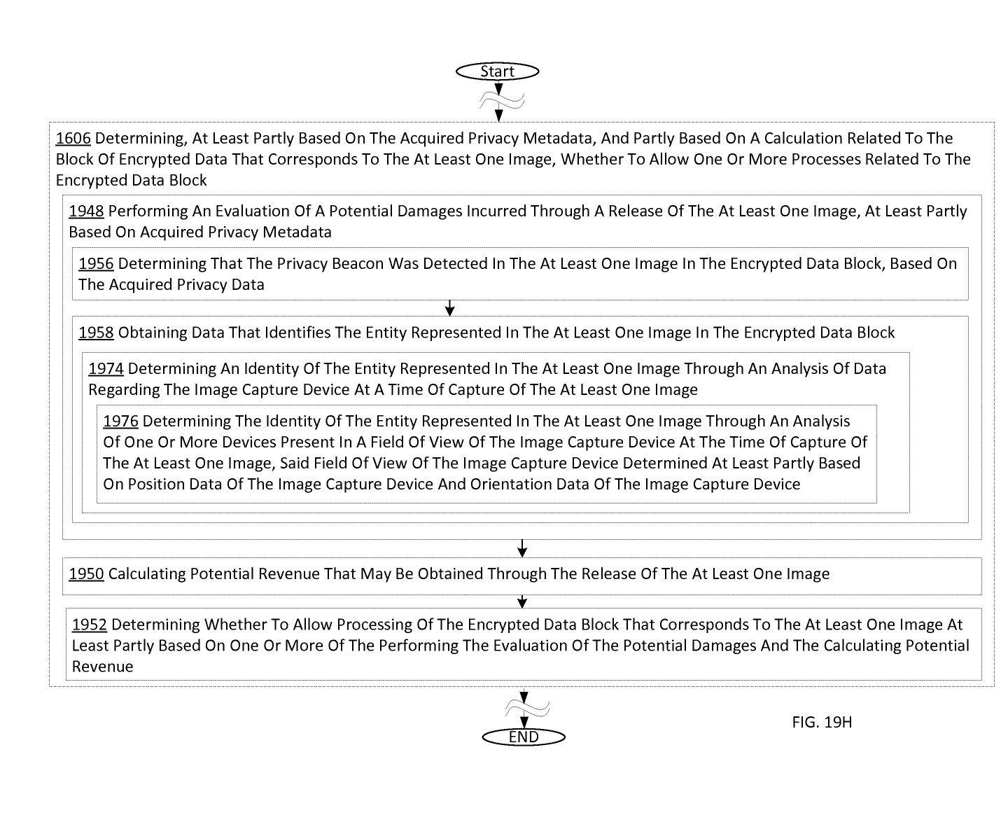

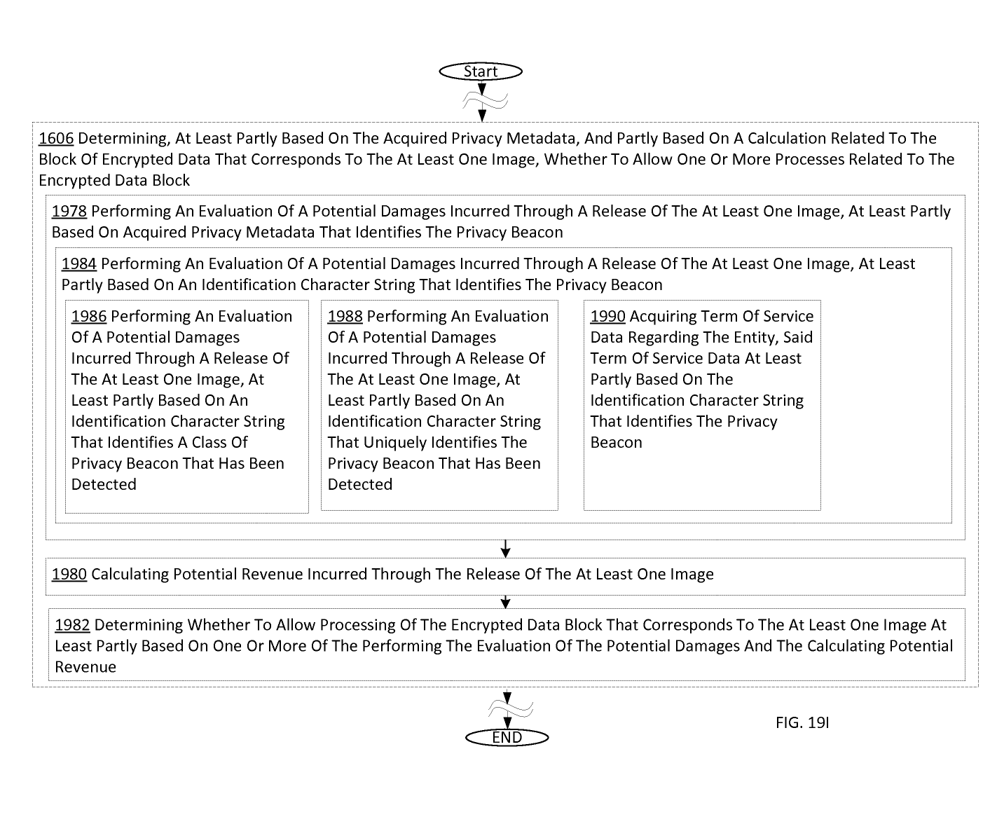

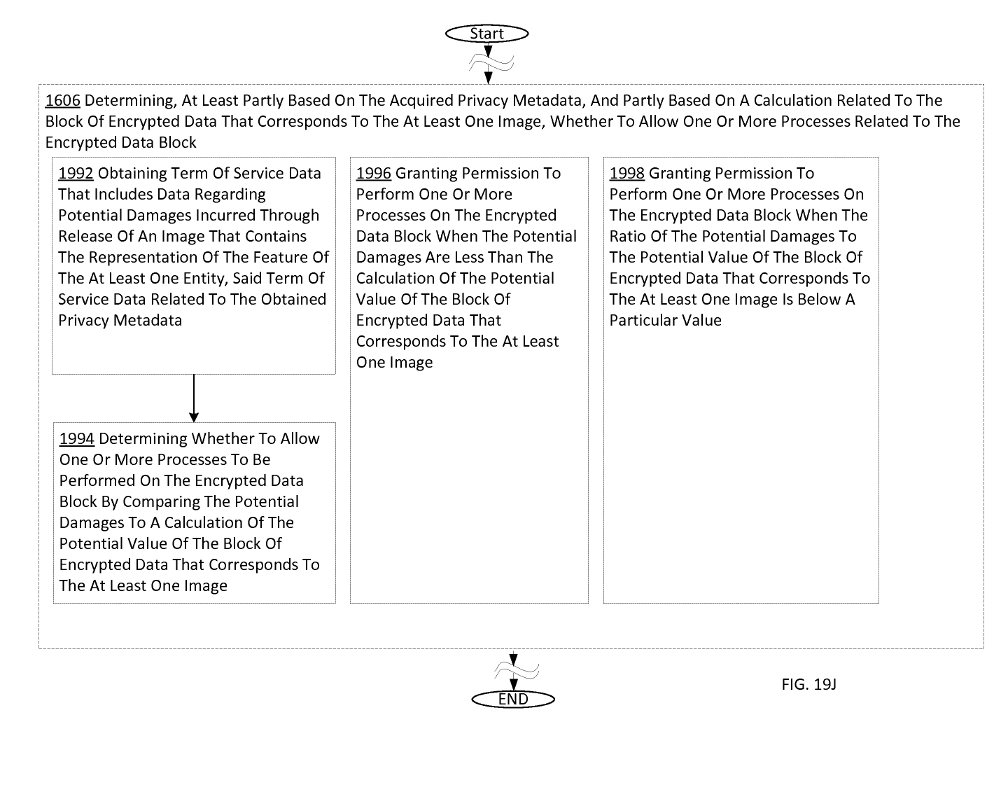

In accordance with 37 C.F.R. §1.84(h)(2), FIG. 1 shows “a view of a large machine or device in its entirety . . . broken into partial views . . . extended over several sheets” labeled FIG. 1-A through FIG. 1-T (Sheets 1-20). The “views on two or more sheets form, in effect, a single complete view, [and] the views on the several sheets . . . [are] so arranged that the complete figure can be assembled” from “partial views drawn on separate sheets . . . linked edge to edge. Thus, in FIG. 1, the partial view FIGS. 1-A through 1-T are ordered alphabetically, by increasing in columns from left to right, and increasing in rows top to bottom, as shown in the following table:

TABLE 1
Table showing alignment of enclosed drawings to form
partial schematic of one or more environments.

| | | | | |
|---|---|---|---|---|
| (1, 1) - | (1, 2) - | (1, 3) - | (1, 4) - | (1, 5) - |
| FIG. 1-A | FIG. 1-B | FIG. 1-C | FIG. 1-D | FIG. 1-E |
| (2, 1) - | (2, 2) - | (2, 3) - | (2, 4) - | (2, 5) - |
| FIG. 1-F | FIG. 1-G | FIG. 1-H | FIG. 1-I | FIG. 1-J |
| (3, 1) - | (3, 2) - | (3, 3) - | (3, 4) - | (3, 5) - |
| FIG. 1-K | FIG. 1-L | FIG. 1-M | FIG. 1-N | FIG. 1-O |
| (4, 1) - | (4, 2) - | (4, 3) - | (4, 4) - | (4, 5) - |
| FIG. 1-P | FIG. 1-Q | FIG. 1-R | FIG. 1-S | FIG. 1-T |

In accordance with 37 C.F.R. §1.84(h)(2), FIG. 1 is “ . . . a view of a large machine or device in its entirety . . . broken into partial views . . . extended over several sheets . . . [with] no loss in facility of understanding the view.” The partial views drawn on the several sheets indicated in the above table are capable of being linked edge to edge, so that no partial view contains parts of another partial view. As here, “where views on two or more sheets form, in effect, a single complete view, the views on the several sheets are so arranged that the complete figure can be assembled without concealing any part of any of the views appearing on the various sheets.” 37 C.F.R. §1.84(h)(2).

It is noted that one or more of the partial views of the drawings may be blank, or may not contain substantive elements (e.g., may show only lines, connectors, and the like). These drawings are included in order to assist readers of the application in assembling the single complete view from the partial sheet format required for submission by the USPTO, and, while their inclusion is not required and may be omitted in this or other applications, their inclusion is proper, and should be considered intentional.

FIG. 1-A, when placed at position (1,1), forms at least a portion of a partially schematic diagram of an environment(s) and/or an implementation(s) of technologies described herein.

FIG. 1-B, when placed at position (1,2), forms at least a portion of a partially schematic diagram of an environment(s) and/or an implementation(s) of technologies described herein.

FIG. 1-C, when placed at position (1,3), forms at least a portion of a partially schematic diagram of an environment(s) and/or an implementation(s) of technologies described herein.

FIG. 1-D, when placed at position (1,4), forms at least a portion of a partially schematic diagram of an environment(s) and/or an implementation(s) of technologies described herein.

FIG. 1-E, when placed at position (1,5), forms at least a portion of a partially schematic diagram of an environment(s) and/or an implementation(s) of technologies described herein.

FIG. 1-F, when placed at position (2,1), forms at least a portion of a partially schematic diagram of an environment(s) and/or an implementation(s) of technologies described herein.

FIG. 1-G, when placed at position (2,2), forms at least a portion of a partially schematic diagram of an environment(s) and/or an implementation(s) of technologies described herein.

FIG. 1-H, when placed at position (2,3), forms at least a portion of a partially schematic diagram of an environment(s) and/or an implementation(s) of technologies described herein.

FIG. 1-I, when placed at position (2,4), forms at least a portion of a partially schematic diagram of an environment(s) and/or an implementation(s) of technologies described herein.

FIG. 1-J, when placed at position (2,5), forms at least a portion of a partially schematic diagram of an environment(s) and/or an implementation(s) of technologies described herein.

FIG. 1-K, when placed at position (3,1), forms at least a portion of a partially schematic diagram of an environment(s) and/or an implementation(s) of technologies described herein.

FIG. 1-L, when placed at position (3,2), forms at least a portion of a partially schematic diagram of an environment(s) and/or an implementation(s) of technologies described herein.

FIG. 1-M, when placed at position (3,3), forms at least a portion of a partially schematic diagram of an environment(s) and/or an implementation(s) of technologies described herein.

FIG. 1-N, when placed at position (3,4), forms at least a portion of a partially schematic diagram of an environment(s) and/or an implementation(s) of technologies described herein.

FIG. 1-O, when placed at position (3,5), forms at least a portion of a partially schematic diagram of an environment(s) and/or an implementation(s) of technologies described herein.

FIG. 1-P, when placed at position (4,1), forms at least a portion of a partially schematic diagram of an environment(s) and/or an implementation(s) of technologies described herein.

FIG. 1-Q, when placed at position (4,2), forms at least a portion of a partially schematic diagram of an environment(s) and/or an implementation(s) of technologies described herein.

FIG. 1-R, when placed at position (4,3), forms at least a portion of a partially schematic diagram of an environment(s) and/or an implementation(s) of technologies described herein.

FIG. 1-S, when placed at position (4,4), forms at least a portion of a partially schematic diagram of an environment(s) and/or an implementation(s) of technologies described herein.

FIG. 1-T, when placed at position (4,5), forms at least a portion of a partially schematic diagram of an environment(s) and/or an implementation(s) of technologies described herein.

FIG. 2A shows a high-level block diagram of an exemplary environment 200, according to one or more embodiments.

FIG. 2B shows a high-level block diagram of a computing device, e.g., an image capturing device 220 operating in an exemplary environment 200, according to one or more embodiments.

FIG. 3 shows a high-level block diagram of an exemplary image capturing device 300, according to one or more embodiments.

FIG. 4 shows a high-level block diagram of an exemplary image capturing device 400, according to one or more embodiments.

FIG. 5 shows a high-level block diagram of an exemplary image capturing device 500, according to one or more embodiments.

FIG. 6 shows a high-level block diagram of an exemplary image capturing device 600, according to one or more embodiments.

FIG. 7 shows a high-level block diagram of an exemplary image capturing device 700, according to one or more embodiments.

FIG. 8 shows a high-level block diagram of an environment 800 including a server device 830, which may be an embodiment of server device 230, and a computing device 820 which may be an embodiment of computing device 220, according to one or more embodiments.

FIG. 9 shows a high-level block diagram of an environment 900 including a server device 930, which may be an embodiment of server device 230, and a computing device 920 which may be an embodiment of computing device 220, according to one or more embodiments.

FIG. 10 shows a high-level block diagram of an environment 1000 including a server device 1030, which may be an embodiment of server device 230, and a computing device 1020 which may be an embodiment of computing device 220, according to one or more embodiments.

FIG. 11 shows a high-level block diagram of an environment 1100 including a server device 1130, which may be an embodiment of server device 230, and a computing device 1120 which may be an embodiment of computing device 220, according to one or more embodiments.

FIG. 12 shows a high-level block diagram of an environment 1200 including a server device 1230, which may be an embodiment of server device 230, and a computing device 1220 which may be an embodiment of computing device 220, according to one or more embodiments.

FIG. 13, including FIGS. 13A-13C, shows a particular perspective of an encrypted image that includes at least one representation of a feature of an entity and that has been encrypted through use of a unique device code associated with an image capture device configured to perform image capture obtaining module 252 of processing module 250 of server device 230 of FIG. 2B, according to an embodiment.

FIG. 14, including FIGS. 14A-14E, shows a particular perspective of a beacon metadata related to a presence, in the encrypted image that is captured by the image capture device, of a privacy beacon that is associated with the at least one entity acquiring module 254 of processing module 250 of server device 230 of FIG. 2B, according to an embodiment.

FIG. 15, including FIGS. 15A-15I, shows a particular perspective of a determination with regard to allowance of manipulation of the encrypted image that is at least partly based on the acquired beacon data and at least partly based on a calculation that involves the encrypted image performing module 256 of processing module 250 of server device 230 of FIG. 2B, according to an embodiment.

FIG. 16 is a high-level logic flowchart of a process, e.g., operational flow 1600, according to an embodiment.

FIG. 17A is a high-level logic flow chart of a process depicting alternate implementations of an acquiring a block of encrypted data operation 1602, according to one or more embodiments.

FIG. 17B is a high-level logic flow chart of a process depicting alternate implementations of an acquiring a block of encrypted data operation 1602, according to one or more embodiments.

FIG. 17C is a high-level logic flow chart of a process depicting alternate implementations of an acquiring a block of encrypted data operation 1602, according to one or more embodiments.

FIG. 17D is a high-level logic flow chart of a process depicting alternate implementations of an acquiring a block of encrypted data operation 1602, according to one or more embodiments.

FIG. 18A is a high-level logic flow chart of a process depicting alternate implementations of obtaining a privacy metadata operation 1604, according to one or more embodiments.

FIG. 18B is a high-level logic flow chart of a process depicting alternate implementations of obtaining a privacy metadata operation 1604, according to one or more embodiments.

FIG. 18C is a high-level logic flow chart of a process depicting alternate implementations of obtaining a privacy metadata operation 1604, according to one or more embodiments.

FIG. 18D is a high-level logic flow chart of a process depicting alternate implementations of obtaining a privacy metadata operation 1604, according to one or more embodiments.

FIG. 18E is a high-level logic flow chart of a process depicting alternate implementations of obtaining a privacy metadata operation 1604, according to one or more embodiments.

FIG. 18F is a high-level logic flow chart of a process depicting alternate implementations of obtaining a privacy metadata operation 1604, according to one or more embodiments.

FIG. 19A is a high-level logic flow chart of a process depicting alternate implementations of a determining whether to allow one or more processes operation 1606, according to one or more embodiments.

FIG. 19B is a high-level logic flow chart of a process depicting alternate implementations of a determining whether to allow one or more processes operation 1606, according to one or more embodiments.

FIG. 19C is a high-level logic flow chart of a process depicting alternate implementations of a determining whether to allow one or more processes operation 1606, according to one or more embodiments.

FIG. 19D is a high-level logic flow chart of a process depicting alternate implementations of a determining whether to allow one or more processes operation 1606, according to one or more embodiments.

FIG. 19E is a high-level logic flow chart of a process depicting alternate implementations of a determining whether to allow one or more processes operation 1606, according to one or more embodiments.

FIG. 19F is a high-level logic flow chart of a process depicting alternate implementations of a determining whether to allow one or more processes operation 1606, according to one or more embodiments.

FIG. 19G is a high-level logic flow chart of a process depicting alternate implementations of a determining whether to allow one or more processes operation 1606, according to one or more embodiments.

FIG. 19H is a high-level logic flow chart of a process depicting alternate implementations of a determining whether to allow one or more processes operation 1606, according to one or more embodiments.

FIG. 19I is a high-level logic flow chart of a process depicting alternate implementations of a determining whether to allow one or more processes operation 1606, according to one or more embodiments.

FIG. 19J is a high-level logic flow chart of a process depicting alternate implementations of a determining whether to allow one or more processes operation 1606, according to one or more embodiments.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Thus, in accordance with various embodiments, computationally implemented methods, systems, circuitry, articles of manufacture, ordered chains of matter, and computer program products are designed to, among other things, provide an interface for acquiring a block of encrypted data that corresponds to at least one image that has been encrypted through use of a unique device code associated with an image capture device configured to capture the at least one image, wherein the at least one image includes at least one representation of a feature of at least one entity, obtaining a privacy metadata that corresponds to a detection of a privacy beacon in the at least one image, said at least one image captured by the image capture device, said privacy beacon associated with the at least one entity, and determining, at least partly based on the obtained privacy metadata, and at least partly based on a calculation related to the block of encrypted data that corresponds to the at least one image, whether to allow one or more processes related to the encrypted data block.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic, etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices, molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software (e.g., a high-level computer program serving as a hardware specification), and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software (e.g., a high-level computer program serving as a hardware specification), and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software (e.g., a high-level computer program serving as a hardware specification) implementation; or, yet again alternatively, the implementer may opt for some combination of hardware, software (e.g., a high-level computer program serving as a hardware specification), and/or firmware in one or more machines, compositions of matter, and articles of manufacture, limited to patentable subject matter under 35 U.S.C. §101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software (e.g., a high-level computer program serving as a hardware specification), and or firmware.

In some implementations described herein, logic and similar implementations may include computer programs or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software (e.g., a high-level computer program serving as a hardware specification) or firmware, or of gate arrays or programmable hardware, such as by performing a reception of or a transmission of one or more instructions in relation to one or more operations described herein. Alternatively or additionally, in some variants, an implementation may include special-purpose hardware, software (e.g., a high-level computer program serving as a hardware specification), firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operation described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

The term module, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of module (e.g., at a first time), as a second type of module (e.g., at a second time, which may in some instances coincide with, overlap, or follow a first time), and/or as a third type of module (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first module that has a first purpose, then a second module that has a second purpose and then, a third module that has a third purpose, and so on. The transition of a reconfigurable and/or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different modules in as little as a few nanoseconds. A component may reconfigure on-the-fly, e.g., the reconfiguration of a component from a first module into a second module may occur just as the second module is needed. A component may reconfigure in stages, e.g., portions of a first module that are no longer needed may reconfigure into the second module even before the first module has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, and/or multiple components that similarly reconfigure, and/or special purpose reconfigurable components.

To the extent that formal outline headings are present in this application, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, any use of formal outline headings in this application is for presentation purposes, and is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although user 105 is shown/described herein, e.g., in FIG. 1, and other places, as a single illustrated figure, those skilled in the art will appreciate that user 105 may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

It is noted that “wearable computer” is used throughout this specification, and in the examples given, it is generally a wearable computer that captures images. However, this is merely for exemplary purposes. The same systems may apply to conventional digital cameras, and any other camera, including security cameras, surveillance cameras, motor vehicle mounted cameras, road/traffic cameras, cameras at automated teller machines, and the like.

Referring now to FIG. 1, in an embodiment, an entity, e.g., a user of a privacy beacon, e.g., user 2105, e.g., a person, e.g., “Jules Caesar,” may be associated with a “Don't Capture Me” (hereinafter “DCM”) privacy beacon, e.g., DCM Beacon 2110. In an embodiment, a DCM beacon may be active, e.g., may contain circuitry and be an active unit, e.g., something wearable, e.g., on a piece of clothing, or on a ring, or on a drone associated with the user. In an embodiment, the DCM beacon may be passive, e.g., it may be something that can be detected in the electromagnetic spectrum, or can be otherwise detected but does not contain any circuitry or advanced logic gates of its own. In an embodiment, the DCM beacon may be a combination of the two.

In an embodiment, a DCM beacon may be detectable by a machine or a human being (e.g., a stop sign painted on a user's forehead may be a DCM beacon). In an embodiment, a DCM beacon may be detectable by a particular type of machine, structure, or filter, and may be otherwise undetectable or difficult to detect through human senses. For example, in an embodiment, a DCM beacon may be seen using ultraviolet or infrared light, or a DCM beacon may emit light outside the visible spectrum. In an embodiment, a DCM beacon may be visible or detectable after a filter is applied, e.g., a DCM beacon may be visible after a red filter is applied, or after a transformation is applied to a captured image, e.g., a Fourier transformation.

In an embodiment, a DCM beacon may be detected optically. In another embodiment, a DCM beacon may be detected by sensing a different kind of wave emitted by a DCM beacon, e.g., a wave in the nonvisible electromagnetic spectrum, a sound wave, an electromagnetic wave, and the like. In an embodiment, a DCM beacon may use quantum entanglement (e.g., through use of an entanglement-based protocol, among others).

In an embodiment, a DCM beacon may transmit data, e.g., a terms of service for the user (e.g., user 2105) for which the DCM beacon (e.g., DCM beacon 2110) is associated or linked. In an embodiment, a DCM beacon may be encoded with a location of data, e.g., a web address of a server where terms of service for the user (e.g., user 2105) for which the DCM beacon (e.g., DCM beacon 2110) is associated.

In an embodiment, a DCM beacon may be provided by a drone, of any size, e.g., nanometers to full-sized aircraft, that is associated with the user.

In an embodiment, a DCM beacon may be provided by a piece of electronics that a user carries, e.g., a cellular telephone, tablet, watch, wearable computer, or otherwise.

In an embodiment, a DCM beacon may be embedded in the user, ingested by the user, implanted in the user, taped to the skin of the user, or may be engineered to grow organically in the user's body.

In an embodiment, a DCM beacon may be controlled by a magnetic field or other field emitted by a user, either through a user's regular electromagnetic field or through a field generated by a device, local or remote, associated with the user.

Referring again to FIG. 1, in an embodiment, a different user, e.g., a wearable computer user 3105, may have a wearable computer 3100. A wearable computer may be a pair of eyeglasses, a watch, jewelry, clothing, shoes, a piece of tape placed on the user's skin, it may be ingested by the user or otherwise embedded into the user's body. Wearable computer 3100 may be a piece of electronics carried by a user 3105. Wearable computer 3100 may not be a “wearable” computer in a traditional sense, but may be a laptop computer, tablet device, or smartphone carried by a user. In an embodiment, wearable computer 3100 may not be associated with a user at all, but may simply be a part of a surveillance system, e.g., a security camera, or a camera at an Automated Teller Machine (“ATM”).

Wearable Computer That Captures the Image (FIGS. 1-I; 1-J, 1-N, 1-O).

Referring now to FIG. 1, e.g., FIG. 1-J, wearable computer 3100 may include a wearable computer image capturing device 3110, e.g., a lens. Wearable computer image capturing device 3110 may include functionality to capture images, e.g., an image sensor, e.g., a charge-coupled device (“CCM”) or a complementary metal-oxide semiconductor (“CMOS”), an analog-to digital converter, and/or any other equipment used to convert light into electrons. Wearable computer image capturing device 3110 may capture the optical data, which may remain as light data, or may be converted into electrons through an image sensor, as raw data. This raw data, e.g., raw data 2200 may be captured by the optical image data acquiring module 3120 of wearable computer 3100. Optical image data acquiring module 3120 may be configured to acquire an image, e.g., an image of user 2105. As described above, a DCM beacon 2110 may be associated with user 2105. In an embodiment, at this point in the operation of wearable computer 3100, no processing has been performed on the raw image data 2200.

Although not pictured here, wearable computer image capturing device 3110 may also include circuitry to detect audio (e.g., a microphone) and/or video (e.g., the ability to capture frames above a certain rate of frames per second). This circuitry and its related explanation have been omitted to maintain simplicity of the drawing, however, through this application, “raw image data 2200” should be considered to also possibly include still pictures, video, and audio, in some embodiments.

Referring now to FIG. 1-I, in an embodiment, wearable computer 3100 then may transfer the raw/optical image data 2200 to an image path splitting module 3130. This splitting path may be optical, e.g., a set of mirrors/lenses, for the case in which raw image data 2200 is still in optical form, or digital, e.g., through use of known electrical signal splitters. Image path splitting module 3130 may be implemented as hardware, software, or a combination thereof.

Referring again to FIG. 1, e.g., FIG. 1-I, in an embodiment, the north (upper) branch, as illustrated in FIG. 1, transmits the raw image data 2200 to an image prior-to-processing encryption module 3150. Image prior-to-processing encryption module 3150 may receive the raw image data 2200. From there, image prior-to-processing encryption module 3150 may acquire an encryption key that is device-specific, e.g., wearable computer device specific encryption key 3182. In an embodiment, wearable computer device-specific encryption key 3182 may be stored in wearable computer device memory 3180, which also may include encrypted image storage 3184, and a wearable computer user-specific encryption key 3186. In another embodiment, device-specific encryption key 3182 may be retrieved from elsewhere, e.g., cloud storage. In another embodiment, device-specific encryption key 3182 may be generated in real time by the device. In another embodiment, device-specific encryption key 3182 may be generated in real time by the device based on random user input (e.g., the last five words spoken by the device and recorded).

In an embodiment, image prior-to-processing encryption module 3150 may generate encrypted image data 2210. Encrypted image data 2210 may be stored in encrypted image storage 3184 of wearable computer device memory 3180. In an embodiment, encrypted image data 2210 also may be transmitted to central server encrypted data and beacon metadata transmission module 3170.

Referring again to FIG. 1-I and FIG. 1-N, in an embodiment, the south (lower) branch, as illustrated in FIG. 1, may transmit the raw image data 2200 to a DCM beacon detecting module 3140. In an embodiment, DCM beacon detecting module 3140 may include one or more of optics-based DCM beacon detecting module 3142, which may be configured to detect the DCM beacon in an optical signal (e.g., light). In an embodiment, DCM beacon detecting module 3140 may include digital image processing-based DCM beacon detecting module 3144, which may be configured to detect the DCM beacon in a converted electron signal (e.g., data signal). In an embodiment, DCM beacon detecting module 3140 is configured to detect a presence or an absence of a DCM beacon, e.g., DCM beacon 2110, associated with the entity (e.g., user 2105, e.g., “Jules Caesar”), without performing any additional processing on the image, or releasing the image for other portions of wearable computer 3100 to use. In an embodiment, for example, raw image data 2200 is not stored in device memory of wearable computer 3100 in a form that is accessible to other applications and/or programs available to wearable computer 3100 or other computing devices that may communicate with wearable computer 3100. For example, a user 3105 of wearable computer 3100 may not, at this stage in processing, capture the raw data 2200 and upload it to a social networking site, e.g., Facebook. In an embodiment, DCM beacon detecting module 3140 may be implemented in hardware, which may prevent users or third parties from bypassing the DCM beacon detecting module 3140, without disassembling the device and physically altering the circuit/logic.

Referring now to FIG. 1-N, in an embodiment, the DCM beacon detecting module 3140 may detect the DCM beacon 2110. For example, in the exemplary embodiment shown in FIG. 1, DCM beacon detecting module 3140 may detect the DCM beacon 2110 that is associated with user 2105, e.g., Jules Caesar. Thus, DCM beacon detecting module 3140 now knows to lock the image data and prevent unencrypted image data from being accessed on the device. Although not shown in this example, if the DCM beacon had not been found, then in an embodiment, the image data 2200 would have been released for use by the device, e.g., for uploading to social network or cloud storage, for example.

In an embodiment, the detected DCM beacon 2110 associated with Jules Caesar may be transmitted to DCM beacon metadata generating module 3160. DCM beacon metadata generating module 3160 may generate metadata based on the detection of the beacon. The metadata may be as simple as “the image data contains a privacy beacon,” e.g., Boolean data. In an embodiment, the metadata may be more complex, and may identify the user associated with the privacy beacon, e.g., the metadata may describe “A privacy beacon associated with Jules Caesar has been found in the image data.” In another embodiment, the metadata may include the terms of service associated with the personality rights of Jules Caesar, an example of which terms of service will be provided in more detail herein.

In an embodiment, the detected DCM beacon 2110 may be very simple (e.g., optically detectable), and to obtain/generate metadata associated with the detected DCM beacon 2110, DCM beacon metadata generating module 3160 may include a DCM server contacting module 3162, which may contact one or more entities to obtain more information regarding the DCM beacon 2110. The DCM beacon metadata generating module 3160 may, in some embodiments, transmit the DCM beacon, or the image in which the DCM beacon was captured, to the external entity, in order to obtain more accurate data. For example, the DCM server contacting module 3162 may contact service term management server 5000, which may have DCM beacon registry 5010, which will be discussed in more detail further herein.

In an embodiment, DCM beacon metadata generating module 3160 may generate the DCM beacon metadata 2230, and transfer DCM beacon metadata 2230 to central server encrypted data and beacon metadata transmission module 3170.

Referring again to FIG. 1, e.g., FIG. 1-I, central server encrypted data and beacon metadata transmission module 3170 may receive the encrypted image data 2210 and the DCM beacon metadata 2230 (e.g., see FIG. 1-N). In an embodiment, central server encrypted data and beacon metadata transmission module 3170 may facilitate the transmission of encrypted image data 2210 and DCM beacon metadata 2230 to a server, e.g., wearable computer encrypted data receipt and determination server 4000, which will be discussed in more detail herein. In an embodiment, central server encrypted data and beacon metadata transmission module 3170 may include one or more of DCM beacon metadata transmission module 3172, which may be configured to transmit the DCM beacon metadata 2230, and encrypted data transmission module 3174, which may be configured to transmit the encrypted image data 2210.

Wearable Computer server (FIGS. 1-H, 1-G)

Referring again to FIG. 1, e.g., FIG. 1-H, in an embodiment, a system may include a wearable computer server, e.g., wearable computer encrypted data receipt and determination server 4000. In an embodiment, a wearable computer server may be provided by a manufacturer of the wearable device 3100. In an embodiment, a wearable computer server may be provided by a developer of one or more software applications for the wearable device 3100. In an embodiment, wearable computer server 4000 may not have a direct relationship with wearable device 3100 prior to receiving the encrypted image data and the DCM beacon metadata 2230, as will be discussed in more detail herein. In an embodiment, a wearable computer server 4000 may be implemented at a home computer of a user, for example, and may communicate only with wearable devices that are associated with that user. In another embodiment, a wearable computer server 4000 may communicate with many wearable devices 3100, which may or may not have some relationship. In an embodiment, wearable computer server 4000 may communicate with one or more wearable devices 3100 through use of a communication network, which may use any known form of device communication. In an embodiment, wearable computer server 4000 may be chosen by wearable device 3100, either due to proximity or due to one or more properties or characteristics of wearable computer server 4000. In an embodiment, wearable computer server 4000 may be free to agree or disagree to process DCM beacon and image data received from various wearable devices 3100. In an embodiment, wearable computer server 4000 may be distributed across many computers and/or servers.

In an embodiment, wearable computer encrypted data receipt and determination server 4000 may include an encrypted data and beacon metadata reception module 4100. Encrypted data and beacon metadata reception module 4100 may receive encrypted image data 2210 and DCM beacon metadata 2230 from wearable computer 3100, e.g., central server encrypted data and beacon metadata transmission module 3170. In an embodiment, encrypted data and beacon metadata reception module 4100 may include a DCM beacon metadata reception module 4104. DCM beacon metadata reception module 4104 may be configured to acquire a privacy metadata, e.g., DCM beacon metadata 2230, corresponding to a detection of a DCM beacon, e.g., DCM beacon 2110, in the one or more images captured by the image capture device, e.g., wearable computer 3100. In an embodiment, encrypted data and beacon metadata reception module 4100 may include encrypted data reception module 4102. In an embodiment, encrypted data reception module 4102 may be configured to acquire one or more of a block of encrypted data corresponding to one or more images that previously have been encrypted, e.g., encrypted image data 2210. In an embodiment, encrypted data module 4102 may transmit, or facilitate the transmission of, encrypted image data 2210 to an entity that will perform a secondary detection of the privacy beacon, e.g., DCM beacon detection test duplicating server 4800, which will be discussed in more detail further herein.

Referring again to FIG. 1-H, in an embodiment, encrypted data and beacon metadata reception module 4100 may transmit the received DCM beacon metadata to DCM beacon metadata reading module 4120. If the DCM beacon metadata 2230 indicates that a DCM beacon was not found, then, in an embodiment, processing may transfer to module 4220, which will be discussed in more detail further herein. In the example shown in FIG. 1, the DCM beacon 2110 associated with Jules Caesar was found, and the DCM beacon metadata 2230 indicates this state to DCM beacon metadata reading module 4120.

Referring now to FIG. 1-G, in an embodiment, when the presence of the DCM beacon 2110 is determined through the DCM beacon metadata, e.g., DCM beacon metadata 2230, then a DCM beacon TOS retrieval module 4122 may retrieve term data from a location, which may be a remote location, e.g., a DCM beacon management server 5100, which will be discussed in more detail further herein. In an embodiment, DCM beacon TOS retrieval module 4122 may retrieve term data that includes a terms of service that specifies one or more conditions in which the image containing the DCM beacon 2110 may be used. In an embodiment, the TOS may also specify one or more penalties for using the personality rights that may be associated with the image, without acquiring permission or paying a licensing fee prior to releasing or utilizing the image. In an embodiment, the TOS also may include language forcing the entity that viewed the privacy beacon to accept the TOS upon viewing of the beacon. The TOS will be described in more detail with respect to modules 5000 and 5100.

Referring again to FIG. 1-G, in an embodiment, wearable computer encrypted data receipt and determination server 4000 also may include an encrypted data value calculation module 4130. Encrypted data value calculation module 4130 may use one or more algorithms or other methods of inducing or deducing an estimate regarding how much advertising or other revenue may be garnered by using the images containing the entity associated with the privacy beacon. For example, in an embodiment, encrypted data value calculation module 4130 may include a facial recognition program to recognize the person or persons associated with the beacon. In another embodiment, however, this may not be necessary, because the DCM beacon metadata and/or the ToS may identify the person. In an embodiment, encrypted data value calculation module 4130 may use various heuristics to calculate ad revenue, e.g., based on models used by popular advertising methods, or based on prior releases of images of the person associated with the DCM beacon 2110. In an embodiment, module 4130 may use social networking to acquire a focus group and test the image on the focus group, in order to assist in revenue determination. For example, in the example shown in FIG. 1, the image in question is of Jules Caesar, who is the reclusive leader of the Roman Empire, and so the ad revenue generated from having an actual picture of Jules Caesar, or a video of Jules Caesar drinking a mead-and-tonic, may have high net value.

Referring again to FIG. 1-G, in an embodiment, the ToS acquired from DCM beacon TOS retrieval module 4122, and the encrypted data valuation calculated from encrypted data value calculation module 4130 may be sent to release of encrypted data determination module 4140. Release of encrypted data determination module 4140 may make a determination, at least partly based on the acquired metadata, and at least partly based on a value calculation based on the representation of the feature of the person associated with the DCM beacon 2110 (e.g., Jules Caesar drinking a mead-and-tonic). That determination may be regarding whether to allow an action, e.g., processing, decryption, distribution, editing, releasing, sharing, saving, posting to a social network, and the like, of the image. In an embodiment, the decision may be based on whether the potential advertising revenue outweighs the potential damages retrieved from the terms of service. In an embodiment, this calculation may be a strict number comparison (e.g., is “revenue” greater than “damages”). In an embodiment, the calculation may include more complex factors, e.g., likelihood of success on a damages claim, likelihood that revenues will increase, secondary revenue factors from increased traffic and/or brand awareness, and the like. In addition, in an embodiment, the comparison may not be strictly less than/greater than, e.g., in a risk adverse algorithm, if the numbers are close, then the determination may be to not release the encrypted data, even if the potential ad revenue is calculated as larger than the potential damages by a small amount.

Referring again to FIG. 1-G, if the determination made by release of encrypted data determination module 4140 is “NO,” e.g., the potential revenue is less than the potential damages, then the encrypted data 2210 is moved to an encrypted data holding and/or quarantine module 4150. In an embodiment, the data from encrypted data holding and/or quarantine module 4150 is deleted after a predetermined time period, e.g., seven days. In an embodiment, the data is simply stored, encrypted and locked away. In an embodiment, the encrypted image data 2210 may be transmitted to an ad replacement value determination server 4400, shown in FIG. 1-F, which will be discussed in more detail herein.

Referring again to FIG. 1-G, if the determination made by release of encrypted data determination module 4140 is “YES,” e.g., the potential revenue is more than the potential damages, then the encrypted data 2210 is transferred to encrypted data decryption enabling module 4152, shown in FIG. 1-H. In an embodiment, encrypted data decryption enabling module 4152 may be configured to determine whether to perform decryption of at least a portion of the encrypted data 2210 based on the result from module 4140 by transmitting the encrypted image data 2210 to wearable computer acquired encrypted data decryption and re-encryption server 4200, which will be discussed in more detail.

Wearable Computer Acquired Encrypted Data Decryption And Re-Encryption Server 4200 (FIGS. 1-L and 1-M)

Referring now to FIG. 1-M, in an embodiment, the system may include wearable computer acquired encrypted data decryption and re-encryption server 4200. In an embodiment, wearable computer acquired encrypted data decryption and re-encryption server 4200 may be a portion of wearable computer server 4000. In an embodiment, however, wearable computer acquired encrypted data decryption and re-encryption server 4200 may be a different server than wearable computer server 4000, and may be controlled by a different entity. For example, in an embodiment, the owner of the wearable computer 3100 hardware may control wearable computer server 4000. After the decision is made to decrypt the data at the wearable computer server 4000, control may be handed off to a different server in control of software on the wearable computer, e.g., software that handles pictures taken by the wearable computer 3100. In another embodiment, wearable computer acquired encrypted data decryption and re-encryption server 4200 may be controlled by a social networking/media site, e.g., Facebook, who may have an agreement to acquire the image data at the same time as the device.

Referring again to FIG. 1-M, in an embodiment, wearable computer acquired encrypted data decryption and re-encryption server 4200 may include encrypted data acquiring module 4210, which may acquire the encrypted image data 2210 from the wearable computer server 4000. In an embodiment, wearable computer acquired encrypted data decryption and re-encryption server 4200 may include a privacy metadata acquiring module 4220, which may acquire privacy metadata from module 4120, if the DCM beacon was never detected and the image is free to be used. For example, in an embodiment, image data with no DCM beacon may be treated similarly to image data with a DCM beacon, but that has been determined to have an advertising value greater than a potential damages value. For example, in an embodiment, image data with no DCM beacon may be treated as image data with potential damages value of zero.

Referring again to FIG. 1-M, in an embodiment, wearable computer acquired encrypted data decryption and re-encryption server 4200 may include data indicating profitability of image with DCM beacon acquiring module 4230, which may receive data from module 4150 of wearable computer server 4000 indicating that the image should be decrypted regardless of the DCM beacon because of its potential profitability.

Referring again to FIG. 1-M, in an embodiment, wearable computer acquired encrypted data decryption and re-encryption server 4200 may include image data decryption preparation module 4240, which may receive data from one or more of data indicating profitability of image with DCM beacon acquiring module 4230, encrypted data acquiring module 4210, and privacy metadata acquiring module 4220. In an embodiment, module 4240 may prepare the image or images for decryption, e.g., perform pre-processing, check image integrity, reconfirm the privacy beacon calculations, and the like.

Referring now to FIG. 1-L, wearable computer acquired encrypted data decryption and re-encryption server 4200 may include device-specific key retrieving module 4250 which may retrieve the device-specific key used to encrypt/decrypt the encrypted image data 2210. In an embodiment, device-specific key retrieving module 4250 may include a device-specific key retrieving from device module 4252, which may be configured to retrieve the device-specific key directly from the device that encrypted the image, e.g., wearable computing device 3100. In an embodiment, device-specific key retrieving module 4250 may include a device-specific key retrieving from server module 4254, which may be configured to retrieve the device-specific key from a server, e.g., from wearable computer encrypted data receipt and determination server 400, or from DCM beacon detection test duplicating server 4800, or from another server not depicted in FIG. 1.

Referring again to FIG. 1-L, in an embodiment, image data decryption with device-specific key module 4260 may take the device-specific key retrieved from module 4250, and apply it to the encrypted image data 2210 to generate decrypted image data 2280, as shown by the icon with the unlocked lock in FIG. 1-L.

Referring again to FIG. 1-L, the image data has been decrypted. However, to protect security, in some embodiments, the data may be re-encrypted with a key that is not tied to a specific device, but may be tied to a specific user of the device, e.g., the key may be related to user 3105, rather than wearable device 3100. This embodiment will be described in more detail herein. This embodiment allows the re-encrypted data to be securely sent to a different device belonging to the user, e.g., a smart TV, a home computer, a video game system, or another portable electronic device, e.g., a cellular smartphone. In an embodiment, the re-encryption with a user specific key may be omitted.

In an embodiment, wearable computer acquired encrypted data decryption and re-encryption server 4200 may include a user-specific key retrieving module 4270, that may be configured to obtain, through generation, acquisition, reception, or retrieval, of a user-specific encryption key. The user-specific encryption key may be delivered to image data encrypting with user-specific key module 4280, which, in an embodiment, also may receive the decrypted image data 2280.

Referring again to FIG. 1-L, in an embodiment, image data encrypting with user-specific key module 4280 may be configured to encrypt the block of decrypted data through use of a unique user code that is related to the user 3105 of the wearable device 3100. The again-encrypted image data then may be transferred to encrypted image data transmitting module 4290. In an embodiment, encrypted image data transmitting module 4290 may transmit the image data that has been encrypted with a user-specific key to one or more other devices, which will be discussed in more detail herein.

Computing Device That Receives the Image Data (FIGS. 1-S and 1-T).

Referring now to FIG. 1-S, in an embodiment, the system may include a computing device 3200, which may be a wearable computer or other device. In an embodiment, computing device 3200 may be the same as wearable computer 3100, but it does not necessarily have to be the same. In an embodiment, computing device 3200 receives the image data. In an embodiment, as described above, the received image data has been encrypted with a user-specific code. Thus, in such an embodiment, computing device 3200 may be associated with user 3105 of the wearable computing device 3100. For example, a user 3105 may have a wearable computing device 3100 that captures images of people. After processing those images at the server 4000, for example, the images, which, in some embodiments, now may be encrypted with a user-specific code, may be transmitted to computing device 3200, which may be the user 3105's home media center back at her house. In another embodiment, computing device 3200 may be user 3105's laptop device, or user 3105's smartphone or tablet device. And, as previously mentioned, in another embodiment, computing device 3200 may simply be the user 3105's wearable computing device 3100 that captured the images originally.

In an embodiment, the computing device 3200 and the wearable computing device 3100 pictured in FIG. 1 are the same device. In an embodiment, the encryption, transmission to a server, decryption, and transmission back, may occur invisibly to the user 3105, e.g., to the user 3105 of the wearable computing device 3100, the images are available to her after they are recorded and saved, with a delay that is not specified. In some embodiments, the user 3105 may not be informed of the path taken by the captured image data.

In an embodiment, wearable computing device 3100 may include an encrypted image data receiving module 3210 configured to acquire the data encrypted by the user-specific key code from encrypted image data transmitting module 4290 of wearable computer 4200. In an embodiment, computing device 3200 may include image data release verification acquiring module 3220, which may be configured to determine that the images received from the encrypted image data transmitting module 4290 of wearable computer 4200 have been approved for release and/or use. In an embodiment, the determination may be made based on the ground that the images are encrypted with a user-specific key rather than a device specific key, if it is possible to tell from the encrypted information (e.g., in some embodiments, different types of encryption that may leave a different “signature” may be used). In an embodiment, the determination may be made by again analyzing the image data. In an embodiment, image data release verification acquiring module 3220 may include encrypted image data analysis module 3222 which may perform analysis on the encrypted image data, including, but not limited to, reading metadata attached to the encrypted image data, to verify that the received encrypted image data is approved for release and/or processing. In an embodiment, image data release verification acquiring module 3220 may include release verification data retrieving module 3224, which may be configured to obtain release verification data from the device that performed the verification, e.g., server 4000, or from a different device.

Referring now to FIG. 1-T, in an embodiment, computing device 3200 may include device memory 3280. Device memory 3280 may store the wearable computer user-specific encryption/decryption key 3286, which may be used to decrypt the received encrypted image data. In an embodiment, device memory 3280 also may include encrypted image storage 3284, which may include one or more image data, which may be encrypted.

Referring again to FIG. 1-S, in an embodiment, computing device 3200 may include user-specific decryption key obtaining module 3230, which may obtain the user-specific encryption/decryption key. In an embodiment, user-specific decryption key obtaining module 3230 may include encryption/decryption key external source obtaining module 3232, which may be configured to obtain the encryption/decryption key from an external source, e.g., server 4000. In an embodiment, user-specific decryption key obtaining module may include encryption/decryption key memory retrieving module 3234, which may be configured to retrieve the encryption/decryption key from device memory 3280 of computing device 3200.

Referring again to FIG. 1-S, in an embodiment, computing device 3200 may include image decryption module 3240, which may use the user-specific encryption/decryption key to decrypt the image data. In an embodiment, the decrypted image data then may be sent to decrypted image release module 3250, where the clear image data may be accessed by the device, and transmitted to other locations, posted to social networking or cloud storage, be shared, manipulated, saved, edited, and otherwise have open access to the decrypted image data.

Ad Replacement Value Determination Server (FIG. 1-F).

Referring back to FIG. 1-G, as discussed briefly above, release of encrypted data determination module 4140 may determine not to release the encrypted data, which may be stored in an encrypted data holding and/or quarantine module 4150. In an embodiment, the encrypted data and the DCM beacon may be transmitted to an ad replacement value determination server, as shown in FIG. 1-F.

Referring now to FIG. 1-F, in an embodiment, the system may include an ad replacement value determination server 4400. Ad replacement value determination server 4400 may take the encrypted image data and determine if there is a way to monetize the images such that the monetization may outweigh the potential damages. For example, ad replacement value determination server 4400 may calculate potential earnings and limited damages liability, if, for example, an entity with the DCM beacon, e.g., Jules Caesar, is instead shown with an advertisement where his head would normally be. In an embodiment, ad replacement value server may be controlled by a different entity than server 4000, and there may be an agreement in place for the ad replacement value determination server 4400 to receive encrypted data for which the server 4000 decides it does not want to allow distribution. For example, ad replacement value server 4400 may be run by a smaller social networking site that cares less about potential damages because they have fewer assets, or are less risk-averse. In another embodiment, ad replacement value determination server 4400 may be part of server 4000, and it may be a practice of server 4000 to send an encrypted image for further analysis after the server 4000 determines that the image is not likely to be profitable without modification.

Referring again to FIG. 1-F, in an embodiment, ad replacement value determination server 4400 may include a DCM beacon metadata reception module 4410 configured to receive the DCM beacon metadata from the wearable computer encrypted data receipt and determination server 4000. In an embodiment, ad replacement value determination server 4400 may include an encrypted data reception module 4420 that may be configured to receive the encrypted data from the wearable computer encrypted data receipt and determination server 4000, e.g., from the encrypted data holding module 4150.

Referring again to FIG. 1-F, in an embodiment, ad replacement value determination server 4400 may include a DCM beacon term acquiring module 4430, which may acquire one or more terms of service from service term management server 5000 and/or DCM beacon management server 5100, similarly to DCM beacon terms-of-service retrieval module 4122 of wearable computer encrypted data receipt and determination server 4000. In an embodiment, DCM beacon term acquiring module may include DCM beacon remote retrieval module 4432. In an embodiment, DCM beacon term acquiring module may be configured to retrieve term data from a remote location, e.g., service term management server 5000, which term data may correspond to a term of service associated with a release of image data that includes the person with which the DCM beacon is associated, e.g., Jules Caesar.

Referring again to FIG. 1-F, in an embodiment, ad replacement value determination server 4400 may include an encrypted data value calculation with standard ad placement module 4440. In an embodiment, standard ad placement module 4440 may perform a similar calculation as encrypted data value calculation module 4130 of wearable computer encrypted data receipt and determination server 4000. In an embodiment, for example, encrypted data value calculation with standard ad placement module 4440 may calculate whether an estimated advertising revenue from one or more advertisement images placed in the encrypted image data will be greater than an estimated potential liability for distribution of the images. In an embodiment, the estimated potential liability is based at least in part on the terms of service which may be retrieved by the DCM beacon term acquiring module 4430.

Referring again to FIG. 1-F, in an embodiment, ad replacement value determination server 4400 may include encrypted image data modification with intentionally obscuring ad placement module 4450. In an embodiment, encrypted image data modification with intentionally obscuring ad placement module 4450 may be configured to modify the encrypted image data (e.g., which, in some embodiments, may require limited decryption and then re-encryption) by replacing one or more areas associated with the entity related to the DCM beacon, e.g., Jules Caesar's face (e.g., or in another embodiment, Jules Caesar's genitalia, if, e.g., it was a naked picture of Jules Caesar), with one or more advertisement images.

Referring again to FIG. 1-F, in an embodiment, ad replacement value determination server 4400 may include modified encrypted data value calculation with intentionally obscuring ad placement module 4460. In an embodiment, modified encrypted data value calculation with intentionally obscuring ad placement module 4460 may be configured to calculate an estimated advertising revenue from the modified image data. In an embodiment, the modified image data then may be distributed through modified encrypted data distributing module 4470.

Tracking Server (FIG. 1-E).

Referring now to FIG. 1-E, in an embodiment, a system may include tracking server 9000. Tracking server 9000 may be configured to log use of a “Don't Capture Me” (hereinafter “DCM”) beacon by one or multiple users. In an embodiment, tracking server 9000 may track active DCM beacons, e.g., beacon 2110, through communication with said one or more beacons. In an embodiment, tracking server may track DCM beacons through other means, e.g., social networking and the like. The DCM beacon does not need to be an active DCM beacon in order to be tracked by tracking server 9000.

In an embodiment, tracking server 9000 may include deployment of one or more active and/or passive DCM beacons monitoring module 9010. Deployment of one or more active and/or passive DCM beacons monitoring module 9010 may include one or more of active DCM beacon monitoring module 9012 and passive DCM beacon monitoring/data gathering module 9020. In an embodiment, passive DCM beacon monitoring/data gathering module 9020 may gather data about the passive DCM beacon by observing it, e.g., through satellite video capture, through other image capturing devices, e.g., phone cameras, security cameras, laptop webcams, and the like, or through other means. In an embodiment, passive DCM beacon monitoring/data gathering module 9020 may include user input module 9022, which may receive an indication from a user, e.g., a switch flipped on a user's cell phone, indicating that the user is using the DCM beacon. In an embodiment, passive DCM beacon monitoring/data gathering module 9020 may include a device status module which tracks a device with which the passive DCM beacon is associated, e.g., a wearable computer that is a shirt, or a cellular phone device in the pocket. In an embodiment, passive DCM beacon monitoring/data gathering module 9020 may include a social media monitoring module that monitors posts on social networking sites to determine if the DCM beacon is being used, and a location of the user.

Referring again to FIG. 1-E, in an embodiment, tracking server 9000 may include a record of the deployment of the one or more active and/or passive DCM beacons storing module 9030, which may be configured to store a record of usage and/or detection logs of the DCM beacons that are monitored. In an embodiment, record of the deployment of the one or more active and/or passive DCM beacons storing module 9030 may store a record of the deployment in deployment record storage 9032. In an embodiment, record of the deployment of the one or more active and/or passive DCM beacons storing module 9030 may transmit all or portions of the recorded record through record of the deployment of one or more active and/or passive DCM beacons transmitting module 9040.

Service Term Management Server 5000 (FIG. 1-A)

Referring now to FIG. 1-A, in an embodiment, the system may include service term management server 5000, which may manage terms of service that are associated with a DCM beacon and/or a person. In an embodiment, service term management server 5000 may include a DCM beacon registry 5010. In an embodiment, the DCM beacon registry 5010 may include one or more of a user's name, e.g., Jules Caesar, a terms of service associated with Jules Caesar, which may be custom to Jules Caesar, or may be a generic terms of service that is used for many persons, and various representations of portions of Jules Caesar, e.g., likeness, handprint, footprint, voiceprint, pictures of private areas, and the like.

Referring again to FIG. 1-A, in an embodiment, the system may include a terms of service generating module 5020. Terms of service generating module 5020 may create a terms of service for the user Jules Caesar. A sample Terms of Service is shown in FIG. 1-A and is reproduced here. It is noted that this is a condensed Terms of Service meant to illustrate an exemplary operation of the system in the environment, and accordingly, several necessary legal portions may be omitted. Accordingly, the example Terms of Service should not be considered as a binding, legal document, but rather a representation of what the binding, legal document would look like, that would enable one skilled in the art to create a full Terms of Service.

Exemplary Terms of Service for User 2105 (Jules Caesar)

1. By capturing an image of any part of the user Jules Caesar (hereinafter “Image”), or providing any automation, design, resource, assistance, or other facilitation in the capturing of the Image, you agree that you have captured these Terms of Service and that you acknowledge and agree to them. If you cannot agree to these Terms of Service, you should immediately delete the captured Image. Failure to do so will constitute acceptance of these Terms of Service.

2. The User Jules Caesar owns all of the rights associated with the Image and any representation of any part of Jules Caesar thereof;

3. By capturing the Image, you agree to provide the User Jules Caesar just compensation for any commercialization of the User's personality rights that may be captured in the Image.

4. By capturing the Image, you agree to take all reasonable actions to track the Image and to provide an accounting of all commercialization attempts related to the Image, whether successful or not.

5. By capturing the Image, you accept a Liquidated Damages agreement in which unauthorized use of the Image will result in mandatory damages of at least, but not limited to, $1,000,000.

In an embodiment, terms of service generating module may include one or more of a default terms of service storage module 5022, a potential damage calculator 5024, and an entity interviewing for terms of service generation module. In an embodiment, default terms of service storage module 5022 may store the default terms of service that are used as a template for a new user, e.g., when Jules Caesar signs up for the service, this is the terms of service that is available to him. In an embodiment, potential damage calculator 5024 may determine an estimate of how much in damages that Jules Caesar could collect for a breach of his personality rights. In an embodiment, for example, potential damage calculator may search the internet to determine how much Jules Caesar appears on social media, blogs, and microblog (e.g., Twitter) accounts. In an embodiment, entity interviewing for terms of service generation module 5026 may create an online questionnaire/interview for Jules Caesar to fill out, which will be used to calculate potential damages to Jules Caesar, e.g., through determining Jules Caesar's net worth, for example.

In an embodiment, service term management server 5000 may include terms of service maintenance module 5030, which may maintain the terms of service and modify them if, for example, the user becomes more popular, or gains a larger online or other presence. In an embodiment, terms of service maintenance module 5030 may include one or more of a social media monitoring module 5042, that may search social networking sites, and an entity net worth tracking module 5034 that may have access to the entity's online bank accounts, brokerage accounts, property indexes, etc., and monitor the entity's wealth.

In an embodiment, serviced term management server 5000 may include a use of representations of an entity detecting module 5040. In an embodiment, use of representations of an entity detecting module 5040 may include one or more of a social media monitoring module 5042, a public photo repository monitoring module 5044, and a public blog monitoring module 5046. In an embodiment, use of representations of an entity detecting module 5040 may track uses of representations, e.g., images, of the user Jules Caesar, to try to detect violations of the terms of service, in various forums.

DCM Beacon Management Server 5100 (FIG. 1-C)

Referring now to FIG. 1-C, in an embodiment, the system may include a DCM beacon management server 5100, which may be configured to manage the DCM beacon associated with a user, e.g., DCM beacon 2110 for user 2105, e.g., Jules Caesar. In an embodiment, DCM beacon management server 5100 and service term management server 5000 may be the same server. In another embodiment, DCM beacon management server 5100 and service term management server 5000 may be hosted by different entities. For example, a specialized entity may handle the terms of service generation, e.g., a valuation company that may be able to determine a net “social network” worth of a user, e.g., Jules Caesar, and use that to fashion the terms of service.

Referring again to FIG. 1-C, in an embodiment, DCM beacon management server 5100 may include DCM beacon communication with entity wanting to avoid having their image captured module 5110. DCM beacon communication with entity wanting to avoid having their image captured module 5110 may be configured to communicate with a user, e.g., user 2105, e.g., Jules Caesar, and may handle the creation, generation, maintenance, and providing of the DCM beacon 2110 to Jules Caesar, whether through electronic delivery or through conventional delivery systems (e.g., mail, pickup at a store, etc.). In an embodiment, DCM beacon communication with entity wanting to avoid having their image captured module 5110 may include one or more of DCM beacon transmission module 5112, DCM beacon receiving module 5114, and DCM beacon generating module 5116.

In an embodiment, DCM beacon management server 5100 may include entity representation acquiring module 5120. Entity representation acquiring module 5100 may be configured to receive data regarding one or more features of the user that will be associated with the DCM beacon. For example, the user might upload pictures of his body, face, private parts, footprint, handprint, voice recording, hairstyle, silhouette, or any other representation that may be captured and/or may be deemed relevant.

In an embodiment, DCM beacon management server 5100 may include DCM beacon association with one or more terms of service and one or more entity representations module 5130. In an embodiment, DCM beacon association with one or more terms of service and one or more entity representations module 5130 may be configured to, after generation of a DCM beacon, obtain a terms of service to be associated with that DCM beacon. In an embodiment, the terms of service may be received from service term management server 5000.

In an embodiment, DCM beacon management server 5100 may include a DCM beacon capture detecting module 5140. DCM beacon capture detection module 5140 may detect when a DCM beacon is captured, e.g., if it is an active beacon, or it may receive a notification from various servers (e.g., server 4000) and/or wearable devices (e.g., wearable device 3100) that a beacon has been detected, if it is a passive DCM beacon.

In an embodiment, when a DCM beacon is detected, DCM beacon management server 5100 may include terms of service associated with DCM beacon distributing module, which may be configured to provide the terms of service associated with the DCM beacon to an entity that captured the image including the DCM beacon, e.g., to module 4122 of wearable computer encrypted data receipt and determination server 4000, or DCM beacon remote retrieval module 4430 of ad replacement value determination server 4400, for example.

Wearable Computer with Optional Paired Personal Device 3300 (FIGS. 1-Q and 1-R)

Referring now to FIG. 1-R, in an embodiment, the system may include a wearable computer 3300. Wearable computer 3300 may have additional functionality beyond capturing images, e.g., it may also store a user's contact list for emails, phone calls, and the like. In another embodiment, wearable computer 3300 may be paired with another device carried by a user, e.g., the user's smartphone device, which stores the user's contact list. As will be described in more detail herein, wearable computer 3300 operates similarly to wearable computer 3100, except that entities with DCM beacons are obscured, unless they have a preexisting relationship with the user. It is noted that DCM beacon detection and encryption may operate similarly in wearable computer 3300 as in wearable computer 3100, and so substantially duplicated parts have been omitted.

Referring again to FIG. 1-R, in an embodiment, wearable computer 3300 may include an image capturing module 3310, which may capture an image of Jules Caesar, who has DCM beacon “A”, Beth Caesar, who has DCM beacon “B”, and Auggie Caesar, who has no DCM beacon. In an embodiment, wearable computer 3300 may include an image acquiring module 3320, which may be part of image capturing module 3310, to acquire one or more images captured by an image capture device, e.g., the image of Jules Caesar, Beth Caesar, and Auggie Caesar.

In an embodiment, wearable computer 3300 may include an entity identification module 3330, which may perform one or more recognition algorithms on the image in order to identify persons in the image. Entity identification module may use known facial recognition algorithms, for example, or may ask the user for input, or may search the internet for similar images that have been identified, for example.

Referring again to FIG. 1-R, in an embodiment, wearable computer 3300 may include preexisting relationship data retrieval module 3340, which may retrieve names of known persons, e.g., from a device contact list, e.g., device contact list 3350. In the example shown in FIG. 1, Jules Caesar is in the contact list of the device 3300. It is noted that the device contact list 3350 may be stored on a different device, e.g., the user's cellular telephone.

Referring now to FIG. 1-Q, in an embodiment, wearable computer 3300 may include data indicating an identified entity from the image data has a preexisting relationship obtaining module 3360, which, in an embodiment, may obtain data indicating that one of the entities recorded in the image data (e.g., Jules Caesar) is in the user's contact list.

Referring again to FIG. 1-Q, in an embodiment, wearable computer 3300 may include entities with preexisting relationship marking to prevent obfuscation module 3370. In an embodiment, entities with preexisting relationship marking to prevent obfuscation module 3370 may attach a marker to the image, e.g., a real marker on the image or a metadata attachment to the image, or another type of marker, that prevents obfuscation of that person, regardless of DCM beacon status, because they are in the user's contact list.

Referring again to FIG. 1-Q, in an embodiment, wearable computer 3300 may include unknown entities with DCM beacon obscuring module 3380, which may obfuscate any of the entities in the image data that have a DCM beacon and are not in the contact list. For example, in the example shown in FIG. 1, Beth Caesar's image is obscured, e.g., blurred, blacked out, covered with advertisements, or the like, because she has a DCM beacon associated with her image, and because she is not in the user's contact list. Jules Caesar, on the other hand, is not obscured because a known entity marker was attached to his image at module 3370, because Jules Caesar is in the contact list of an associated device of the user. Auggie Caesar is not obscured regardless of contact list status, because there is no DCM beacon associated with Auggie Caesar.

Referring again to FIG. 1-Q, after the image is obscured, obscured image 3390 of wearable computer 3300 may release the image to the rest of the device for processing, or to another device, the Internet, or cloud storage, for further operations on the image data.

Active DCM Beacon 6000 (FIGS. 1-P and 1-K).

Referring now to FIG. 1-P, in an embodiment, a user 2107 may be associated with an active DCM beacon 2610, which will be discussed in more detail herein. The word “Active” in this context merely means that the DCM beacon has some form of circuitry or emitter.

Referring now to FIG. 1-K, in an embodiment, the system may include an active DCM beacon 6000, which may show an active DCM beacon, e.g., active DCM beacon 2610, in more detail. In an embodiment, beacon 6000 may include DCM beacon broadcasting module 6010. In an embodiment, DCM beacon broadcasting module 6010 may broadcast a privacy beacon associated with at least one user, e.g., user 2107, from at or near the location of user 2107. The beacon may be detected by an image capturing device when the user is captured in an image.

Referring again to FIG. 1-K, in an embodiment, the beacon 6000 may include an indication of DCM beacon detection module 6020, which may detect, be informed of, or otherwise acquire an indication that the active DCM beacon has been captured by an image capturing device. In an embodiment, indication of DCM beacon detection module 6020 may include one or more of DCM beacon scanning module 6022, which may scan nearby devices to see if they have detected the beacon, and DCM beacon communications handshake module 6024, which may establish communication with one or more nearby devices to determine if they have captured the beacon.

Referring again to FIG. 1-K, in an embodiment, beacon 6000 may include term data broadcasting module 6030, which may broadcast, or which may order to be broadcasted, term data, which may include the terms of service. In an embodiment, term data broadcasting module 6030 may include one or more of a substantive term data broadcasting module 6032, which may broadcast the actual terms of service, and pointer to term data broadcasting module 6034, which may broadcast a pointer to the terms of service data that a capturing device may use to retrieve the terms of service from a particular location.

DCM Beacon Test Duplicating Sever 4800 (FIGS. 1-C and 1-D)

Referring now to FIG. 1-C, in an embodiment, the system may include a DCM beacon test duplicating server 4800. In an embodiment, the DCM beacon test duplicating server 4800 may take the image data, and perform the test for capturing the beacon again, as a redundancy, as a verification, or as a protection for wearable computer server 4000. In an embodiment, DCM beacon test duplicating server 4800 may be a part of wearable computer server 4000. In another embodiment, DCM beacon test duplicating server 4800 may be separate from wearable computer server 4000, and may be controlled by a different entity, e.g., a watchdog entity, or an independent auditing agency.

Referring again to FIG. 1-C, in an embodiment, DCM beacon test duplicating server 4800 may include encrypted data reception for secondary DCM beacon detection module 4810, which may acquire the encrypted image data containing the user, e.g., user 2105, e.g., Jules Caesar, and the associated DCM beacon, e.g., DCM beacon 2110.

Referring again to FIG. 1-C, in an embodiment, DCM beacon test duplicating server 4800 may include a device-specific key retrieving module 4820, which may retrieve the device-specific key, e.g., from wearable computer device 3100, or from wearable computer server 4000. In an embodiment, DCM beacon test duplicating server 4800 may include image data decryption with device-specific key module 4830, which may apply the device-specific key obtained by device-specific key retrieving module 4820, and apply it to the encrypted image data, to generate decrypted image data.

Referring again to FIG. 1-C, in an embodiment, the unencrypted image data may be sent to DCM beacon detecting module 4840 of DCM beacon test duplicating server 4800. If the raw image data was optical in its original form, then it may be reconverted to optical (e.g., light) data. In an embodiment, DCM beacon detecting module 4840 may perform a detection for the DCM beacon, as previously described. In an embodiment, DCM beacon detecting module 4840 may include one or more of an optics-based DCM beacon detecting module 4842 and a digital image processing-based DCM beacon detecting module 4844.

Referring now to FIG. 1-D, after the test for detecting the DCM beacon 2220 (which may be the same as the DCM beacon 2210, but is detected at a different place, so a different number has been assigned), DCM beacon detection at duplicating sever result obtaining module 4850 may obtain the result of the detection performed at DCM beacon test duplicating server 4800. Similarly, DCM beacon detection at device result obtaining module 4860 may obtain the result from the DCM beacon detection performed at wearable computer device 3100. The results from module 4850 and 4860 may be stored at DCM beacon test result storage and logging module 4870 of DCM beacon test duplicating server 4800.

Referring again to FIG. 1-D, the test results from DCM beacon test duplicating server 4800 and from wearable computer 3100 may be stored at DCM beacon test result storage and logging module 4870, and such results may be kept for a predetermined length of time. In an embodiment, the results may be transmitted to a requesting party using DCM beacon test result transmitting module 4880.

Referring again to the system, in an embodiment, a computationally-implemented method may include acquiring an image, said image including at least one representation of a feature of at least one entity, detecting a presence of a privacy beacon associated with the at least one entity from the acquired image, without performance of a further process on the acquired image, encrypting the image using a unique device code prior to performance of one or more image processes other than privacy beacon detection, said unique device code unique to an image capture device and not transmitted from the image capture device, and facilitating transmission of the encrypted image and privacy beacon data associated with the privacy beacon to a location configured to perform processing on one or more of the encrypted image and the privacy beacon data.

Referring again to the system, in an embodiment, a computationally-implemented method may include acquiring a block of encrypted data corresponding to one or more images that have previously been encrypted through use of a unique device code associated with an image capture device configured to capture the one or more images, wherein at least one of the one or more images includes at least one representation of a feature of at least one entity, acquiring a privacy metadata, said privacy metadata corresponding to a detection of a privacy beacon in the one or more images captured by the image capture device, said privacy beacon associated with the at least one entity, and determining, at least partly based on the obtained privacy metadata, and partly based on a value calculation based on the representation of the feature of the at least one entity for which the privacy beacon is associated, whether to allow processing, which may include distribution, decryption, etc., of the encrypted data block.

Referring again to the system, in an embodiment, a computationally-implemented method may include acquiring a block of encrypted data corresponding to one or more images that have previously been encrypted through use of a unique device code associated with an image capture device configured to capture the one or more images, wherein at least one of the one or more images includes at least one representation of a feature of at least one entity, acquiring a privacy metadata indicating detection of a privacy beacon in the one or more images captured by the image capture device, said privacy beacon associated with the at least one entity, retrieving term data from a remote location, said term data corresponding to a term of service associated with a potential release of the block of encrypted data corresponding to the one or more images that have previously been encrypted through use of the unique device code associated with the image capture device configured to capture the one or more images, calculating an expected valuation corresponding to potential revenue associated with the release of at least a portion of the block of encrypted data corresponding to the one or more images that have previously been encrypted through use of the unique device code associated with the image capture device configured to capture the one or more images, and determining whether to perform decryption of at least a portion of the block of encrypted data at least partially based on the calculation of the expected valuation corresponding to the potential revenue associated with the release of the at least the portion of the block of encrypted data, and at least partially based on the retrieved term data corresponding to the term of service.

Referring again to the system, in an embodiment, a computationally-implemented method may include acquiring a block of encrypted data corresponding to one or more images that have previously been encrypted through use of a unique device code associated with an image capture device configured to capture the one or more images, wherein at least one of the one or more images includes at least one representation of a feature of at least one entity, acquiring a privacy metadata indicating a lack of detection of a privacy beacon in the one or more images captured by the image capture device, decrypting the block of encrypted data corresponding to the one or more images that have previously been encrypted through use of a unique device code associated with the image capture device, and encrypting the block of decrypted data through use of a unique entity code that is related to an entity associated with the image capture device configured to capture the one or more images. Referring again to the system, in an embodiment, a computationally-implemented method may include acquiring a block of encrypted data from a remote location, said block of encrypted data corresponding to one or more images captured by an image capture device, said block of encrypted data previously encrypted through use of a unique entity code that is related to an entity associated with the image capture device, receiving an indication that the one or more images captured by the image capture device were approved for decryption through a verification related to privacy metadata associated with the one or more images, obtaining the unique entity code related to the entity associated with the image capture device, and releasing the one or more images through decryption of the block of encrypted data acquired from the remote location using the obtained unique entity code related to the entity associated with the image capture device.

Referring again to the system, in an embodiment, a computationally-implemented method may include acquiring a block of encrypted data corresponding to one or more images that have previously been encrypted through use of a unique device code associated with an image capture device configured to capture the one or more images, wherein at least one of the one or more images includes at least one representation of a feature of at least one entity, retrieving term data from a remote location, said term data corresponding to a term of service associated with a potential release of the one or more images that have previously been encrypted through use of the unique device code associated with the image capture device configured to capture the one or more images, calculating whether an estimated advertising revenue from one or more advertisement images placed in the one or more images of the block of encrypted data will be greater than an estimated potential liability for distribution of the one or more images of the block of encrypted data, said estimated potential liability at least partly based on the retrieved term data, modifying the one or more images of the block of encrypted data by replacing one or more areas associated with one or more entities at least partially depicted in the one or more images with the one or more advertisement images, and calculating a modified estimated advertising revenue from the modified one or more images of the block of encrypted data.

Referring again to the system, in an embodiment, a computationally-implemented method may include monitoring a deployment of a privacy beacon associated with a user, said privacy beacon configured to alert a wearable computer of one or more terms of service associated with said user in response to recordation of image data that includes said privacy beacon by said wearable computer, and said privacy beacon configured to instruct said wearable computer to execute one or more processes to impede transmission of the one or more images that include the user associated with said privacy beacon, and storing a record of the deployment of the privacy beacon associated with the user, said record configured to be retrieved upon request to confirm whether the privacy beacon associated with the user was active at a particular time.

Referring again to the system, in an embodiment, a computationally-implemented method may include receiving data regarding one or more features of one or more entities that are designated for protection by one or more terms of service, associating the one or more terms of service with a privacy beacon configured to be captured in an image when the one or more features of the one or more entities are captured in the image, and providing the terms of service to one or more media service providers associated with a device that captured an image that includes the privacy beacon, in response to receipt of an indication that an image that includes the privacy beacon has been captured.

Referring again to the system, in an embodiment, a computationally-implemented method may include acquiring one or more images that have previously been captured by an image capture device, wherein at least one of the one or more images includes at least one representation of a feature of one or more entities, identifying a first entity for which at least one representation of a first entity feature is present in the one or more images, and a second entity for which at least one representation of a second entity feature is present in the one or more images, obtaining data indicating that the first entity has a preexisting relationship with an entity associated with the image capture device, e.g., in a contact list, preventing an obfuscation of the representation of the first entity for which the preexisting relationship with the entity associated with the image capture device has been indicated, and obfuscating the representation of the second entity for which at least one representation of the second entity feature is present in the one or more images.

Referring again to the system, in an embodiment, a computationally-implemented method may include broadcasting a privacy beacon associated with at least one entity from a location of the at least one entity, said privacy beacon configured to be detected by an image capturing device upon capture of an image of the at least one entity, acquiring an indication that the privacy beacon associated with the at least one entity has been captured by the image capturing device, and broadcasting term data including one or more conditions and/or consequences of distribution of one or more images that depict at least a portion of the at least one entity.

Referring again to the system, in an embodiment, a computationally-implemented method may include acquiring a block of encrypted data corresponding to one or more images that have previously been encrypted through use of a unique device code associated with an image capture device configured to capture the one or more images, wherein at least one of the one or more images includes at least one representation of a feature of at least one entity, decrypting the block of encrypted data corresponding to the one or more images that have previously been encrypted through use of the unique device code associated with the image capture device configured to capture the one or more images, performing an operation to detect a presence of a privacy beacon associated with the at least one entity from the one or more images, wherein the privacy beacon previously had been detected by the image capture device, and storing outcome data corresponding an outcome of the operation to detect the presence of the privacy beacon associated with the at least one entity of the one or more images, wherein said outcome data includes an indication of whether a result of the performed operation to detect the presence of the privacy beacon associated with the at least one entity from the one or more images matches the previous detection of the privacy beacon by the image capture device.

Referring now to FIG. 2, e.g., FIG. 2A, FIG. 2A illustrates an example environment 200 in which the methods, systems, circuitry, articles of manufacture, and computer program products and architecture, in accordance with various embodiments, may be implemented by one or more server devices 230. As shown in FIG. 2A, one or more computing devices 220 may capture images. For example, computing device 220 may capture an image of an entity 105 associated with a privacy beacon, e.g., a DCM (“Don't Capture Me”) beacon 110. In this and some other examples, the captured entity is named “Jules Caesar.”

Referring again to FIG. 2A, computing device 220 may capture the image data as image data 22, which may be optical data, e.g., light data, digital data, e.g., a digital signal, or data in another form. In a process that will be discussed in more detail herein according to various embodiments, image data 22 may be encrypted using a device-specific code, shown here as encrypted image data 24. Encrypted image data 24 may be transmitted to a server device 230, which may be an example of wearable computer server 3000 shown in FIG. 1. In an embodiment, computing device 220 may generate beacon metadata 114 from the detected DCM beacon 110. In an embodiment, beacon metadata 114 may be binary beacon metadata that indicates whether a beacon has been detected, e.g., yes or no. In an embodiment, beacon metadata 114 may include a data string that identifies the beacon, the entity, the type of beacon, data about the beacon, or a combination of the foregoing. In an embodiment, such a beacon metadata 114 may be used by server device 230 to obtain additional information about the entity, e.g., terms of service data, which will be described in more detail herein. In an embodiment, beacon metadata 114 may include terms of service data associated with the entity, e.g., Jules Caesar. The types of beacon metadata 114 are not limited to those listed in this paragraph, and the foregoing types of beacon metadata 114 will be described in more detail further herein with respect to FIGS. 8-12, and with respect to the specific examples listed herein.

In an embodiment, server device 230 may include an encrypted image data block acquisition module 231 that receives encrypted image data 24 from the computing device 220. In an embodiment, server device 230 may include a beacon metadata handling module 233 that receives beacon metadata 114. In an embodiment, beacon metadata handling module 233 may receive the beacon metadata 114 and determine what, if any, actions should be taken to obtain more information regarding the entity 105 and/or the DCM beacon 110. This process will be discussed in more detail further herein with respect to the other figures. In an embodiment, server device 230 may include beacon-related terms of service acquisition module 235 which may retrieve terms of service associated with the entity for which the DCM beacon 110 was detected. In an embodiment, however, beacon-related terms of service acquisition module 235 may be unnecessary, for example, if the beacon metadata 114 contains the terms of service associated with the entity 105, then beacon-related terms of service acquisition module 235 may be omitted or passed through. In another embodiment, beacon-related terms of service acquisition module 235 may contact an external entity (not shown) to obtain terms of service data). In an embodiment, server device 230 may include valuation assessment module 236, which may perform a valuation and/or a risk analysis, which may be partly based on the terms of service data for the beacon and partly based on the contents of the captured image. In an embodiment, such analysis may include obtaining term data, e.g., a terms of service associated with the user 105, e.g., Jules Caesar. In an embodiment, valuation assessment module 236 may determine a potential value of the captured image data 22, e.g., through advertisements, e.g., context-sensitive advertisements, or other advertisements, that may be shown and viewers drawn to the advertisements through use of the image data 22. In an embodiment, the image data may be decrypted and may be transmitted back to computing device 220, where, in an embodiment, it may then be accessed by other modules of the device, e.g., image processing module 205, and/or a user of the computing device 220.

Referring again to FIG. 2A, in some embodiments, one or more of the encrypted image data 24 and the DCM beacon metadata are transmitted over one or more communication network(s) 240. In various embodiments, the communication network 240 may include one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 240 may be wired, wireless, or a combination of wired and wireless networks. It is noted that “communication network” as it is used in this application refers to one or more communication networks, which may or may not interact with each other.

Referring again to FIG. 2A, It is noted that, in an embodiment, one or more of encrypted image data block acquisition module 231, beacon metadata handling module 233, beacon-related terms of service acquisition module 235, and valuation assessment module 236 may be part of processor 222 shown in FIG. 2B, or may be combined, separated, distributed, and/or omitted in other combinations not specifically enumerated here.

Computing device 220 may be any electronic device, portable or not, that may be operated by or associated with one or more users. Computing device 220 is shown as interacting with a user 115. As set forth above, user 115 may be a person, or a group of people, or another entity that mimics the operations of a user. In an embodiment, user 115 may be a computer or a computer-controlled device. Computing device 220 may be, but is not limited to, a wearable computer. Computing device 220 may be any device that is equipped with an image capturing component, including, but not limited to, a cellular phone, a network phone, a smartphone, a tablet, a music player, a walkie-talkie, a radio, an augmented reality device (e.g., augmented reality glasses and/or headphones), wearable electronics, e.g., watches, belts, earphones, or “smart” clothing, earphones, headphones, audio/visual equipment, media player, television, projection screen, flat screen, monitor, clock, appliance (e.g., microwave, convection oven, stove, refrigerator, freezer), a navigation system (e.g., a Global Positioning System (“GPS”) system), a medical alert device, a remote control, a peripheral, an electronic safe, an electronic lock, an electronic security system, a video camera, a personal video recorder, a personal audio recorder, and the like.

Referring now to FIG. 2B, FIG. 2B shows a detailed description of a server device 230 operating in environment 200, in an embodiment. It is noted that the components shown in FIG. 2B represent merely one embodiment of server device 230, and any or all components other than processor 222 may be omitted, substituted, or modified, in various embodiments.

Referring again to FIG. 2B, server device 230 may include a server device memory 245. In an embodiment, device memory 245 may include memory, random access memory (“RAM”), read only memory (“ROM”), flash memory, hard drives, disk-based media, disc-based media, magnetic storage, optical storage, volatile memory, nonvolatile memory, and any combination thereof. In an embodiment, device memory 245 may be separated from the device, e.g., available on a different device on a network, or over the air. For example, in a networked system, there may be many server devices 230 whose device memory 245 is located at a central server that may be a few feet away or located across an ocean. In an embodiment, server device 230 may include a device memory 245. In an embodiment, memory 245 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In an embodiment, memory 245 may be located at a single network site. In an embodiment, memory 245 may be located at multiple network sites, including sites that are distant from each other.

Referring again to FIG. 2B, in an embodiment, server device 230 may include beacon-related terms of service handling module 235, as previously described with respect to FIG. 2A. In an embodiment, for example, beacon-related terms of service handling module 235 may include a beacon metadata analyzing module 235A that may analyze the beacon metadata 114, e.g., may determine a location where terms of service may be retrieved, and/or a code for retrieving the terms of service. In an embodiment, beacon-related terms of service handling module 235 may include terms of service server communication module 235B that may communicate with a server that provides the terms of service associated with the detected DCM beacon 110, which is associated by the user 105, e.g., Jules Caesar. For example, in an embodiment, terms of service server communication module 235B may communicate with an external resource through communication network 240.

Referring again to FIG. 2B, in an embodiment, server device 230 may include valuation assessment module 236, as previously described with respect to FIG. 2A. In an embodiment, valuation assessment module 236 may include a risk modifier application module 236A which, in an embodiment, may apply one or more modifiers when determining a potential damages (e.g., risk) of using the encrypted image. In an embodiment, valuation assessment module 236 may include an entity identity verification module 236B which may analyze and/or verify the DCM beacon metadata and/or other data to confirm an identity of the entity in the picture (e.g., to prevent a false positive when multiple people are contained in an image). In an embodiment, valuation assessment module 236 may include an entity valuation data obtaining module 236C, which may be configured to obtain valuation data from an outside source, e.g., entity valuation data obtaining module 236C may contact a social networking site, e.g., Facebook, to determine how much the image may be worth.

Referring again to FIG. 2B, FIG. 2B shows a more detailed description of server device 230. In an embodiment, server device 230 may include a processor 222. Processor 222 may include one or more microprocessors, Central Processing Units (“CPU”), a Graphics Processing Units (“GPU”), Physics Processing Units, Digital Signal Processors, Network Processors, Floating Point Processors, and the like. In an embodiment, processor 222 may be a server. In an embodiment, processor 222 may be a distributed-core processor. Although processor 222 is as a single processor that is part of a single server device 230, processor 222 may be multiple processors distributed over one or many server devices 230, which may or may not be configured to operate together.

Processor 222 is illustrated as being configured to execute computer readable instructions in order to execute one or more operations described above, and as illustrated in FIGS. 16, 17A-7D, 18A-18F, and 19A-19J. In an embodiment, processor 222 is designed to be configured to operate as processing module 250, which may include one or more of encrypted image that includes at least one representation of a feature of an entity and that has been encrypted through use of a unique device code associated with an image capture device configured to perform image capture obtaining module 252, beacon metadata related to a presence, in the encrypted image that is captured by the image capture device, of a privacy beacon that is associated with the at least one entity acquiring module 254, and determination with regard to allowance of manipulation of the encrypted image that is at least partly based on the acquired beacon data and at least partly based on a calculation that involves the encrypted image performing module 256.

FIGS. 3-7 refer to an “image capture device,” which is defined as any device that is equipped with the ability to capture images, and not necessarily a wearable computer or a device designed specifically to capture images.

Referring now to FIG. 3, FIG. 3 shows an exemplary embodiment of a computing device 220 as image capture device 300. In an embodiment, image capture device 300 may include an image capture component, e.g., a lens 306. Image capture component 306 may capture an image including the user 105 and the DCM beacon 110, and capture that image as raw (optical or digital) data 120. In an embodiment, image capture device 300 may include beacon detection module 310 that is configured to detect DCM beacon 110, either optically, digitally, or other, depending on the embodiment. After detection of the beacon, the image data may be sent to an image data encryption module 320 to encrypt the image. In an embodiment, if the beacon is not detected, the image data is released past barrier 340 and the other image capture device modules 350 may operate on the image data 120. In an embodiment, the encrypted data, and data associated with the DCM beacon 110 (although not necessarily the beacon itself) may be transmitted to encrypted data and beacon transmitting module 330, which may transmit the encrypted data and beacon data to an external source, e.g., server 3000 as described in FIG. 1. It is noted that beacon detection module 310, image data encryption module 320, and encrypted data and beacon transmitting module 330 may be separated from other image capture device modules 350 by barrier 340.

In an embodiment, barrier 340 may be a physical barrier, e.g., beacon detection module 310, lens 306, image data encryption module 320, and encrypted data and beacon transmitting module 330 may be hard-wired to each other and electrically excluded from other image capture device modules 350. In another embodiment, barrier 340 may be implemented as a programmed barrier, e.g., the image data 120 is not transmitted to modules other than beacon detection module 310, lens 306, image data encryption module 320, and encrypted data and beacon transmitting module 330. In another embodiment, barrier 340 may be implemented as a data access barrier, e.g., the captured image data 120 may be protected, e.g., with an access or clearance level, so that only beacon detection 310, lens 306, image data encryption module 320, and encrypted data and beacon transmitting module 330 may read or operate on the image data 120. In another embodiment, barrier 340 may not be a complete barrier, e.g., barrier 350 may allow “read” access to the image data, but not “copy” or “write” access. In another embodiment, barrier 340 may be a barrier to transmission, e.g., the image may be viewed locally at the device, but may be barred from being saved to a removable memory, or uploaded to a cloud storage or social networking site/social media site.

Referring now to FIG. 4, FIG. 4 shows an embodiment of a computing device 220 as image capture device 400. In an embodiment, image capture device 400 may include an image capture component, e.g., a lens and sensor 406. Image capture component 406 may capture an image including the user 105 and the DCM beacon 110, and capture that image as raw (optical or digital) data 120. In an embodiment, image capture device 400 may include image path splitting module 405 that may receive the raw data as a signal, e.g., optical or digital, and split the signal into two branches. As shown in FIG. 4, one branch, e.g., the north branch, sends the raw signal to image data encryption module 420, which may encrypt the image. In an embodiment, the other branch, e.g., the south branch, may send the signal to a beacon detection module 410, which may detect the DCM beacon 110. In an embodiment, if the DCM beacon 110 is detected, then the unencrypted image data that arrived at beacon detection module 410 is destroyed. In an embodiment, if the DCM beacon 110 is not detected, then the encrypted image data from image data encryption module 420 is destroyed, and the unencrypted image data at beacon detection module 410 is allowed to pass to other image capture device modules 460. In an embodiment, the beacon detection result and the encrypted image data are transmitted to the encrypted data and beacon transmitting module 430. In an embodiment, barrier 450 may separate image path splitting module 405, beacon detection module 410, image data encryption module 420, and encrypted data and beacon transmitting module 430 from other image capture device modules 460.

In an embodiment, barrier 450 may be a physical barrier, e.g., beacon detection module 410, lens 406, image data encryption module 420, and encrypted data and beacon transmitting module 430 may be hard-wired to each other and electrically excluded from other image capture device modules 460. In another embodiment, barrier 450 may be implemented as a programmed barrier, e.g., the image data 120 is not transmitted to modules other than image path splitting module 405, beacon detection 410, lens 406, image data encryption module 420, and encrypted data and beacon transmitting module 430. In another embodiment, barrier 450 may be implemented as a data access barrier, e.g., the captured image data may be protected, e.g., with an access or clearance level, so that only beacon detection module 410, lens 406, image data encryption module 420, and encrypted data and beacon transmitting module 430 may read or operate on the image data 120. In another embodiment, barrier 450 may not be a complete barrier, e.g., barrier 450 may allow “read” access to the image data, but not “copy” or “write” access. In another embodiment, barrier 450 may be a barrier to transmission, e.g., the image may be viewed locally at the device, but may be barred from being saved to a removable memory, or uploaded to a cloud storage or social networking site/social media site.

Referring now to FIG. 5, FIG. 5 shows an embodiment of a computing device 220 implemented as image capture device 500. In an embodiment, image capture device 500 may include an image capture component 506 that captures optical data 120A. In an embodiment, optical data 120A may be sent to optical splitting module 505, which may split the optical signal, e.g., the light, into two paths. Referring to FIG. 5, the “south” path may transmit the light to an optical filter 510, which may filter the light for a specific characteristic, e.g., a wavelength or an object, according to known optical filtration techniques. In an embodiment, the filtered optical signal may then be transmitted to a filtered optical signal beacon detection module 520, which may detect the beacon 110 in the optical data 120A.

Referring again to FIG. 5, the “north” path from optical splitting module 505 may transmit the optical image data to an optical-to-digital converter 530, e.g., a CMOS or CCD sensor. In an embodiment, the digital signal then may be transmitted to image data encryption module 540, and the encrypted data transmitted to encrypted data and beacon transmitting module 580, along with the beacon detection result, for transmission to an external source, e.g., server 3000 as shown in FIG. 1. In an embodiment, barrier 550 may prevent access to the unencrypted image data by other image capture device modules 560. In an embodiment, barrier 550 may function similarly to barrier 340 and 450, and the descriptions of those barriers and their possible implementations also may apply to barrier 550. In an embodiment, image data encryption module 540, encrypted data beacon and transmitting module 580, and optical-to-digital converter 530 may be controlled by beacon detection control module 570, which may be part of the processor of image capture device 500, or may be a separate processor. In an embodiment, beacon detection control module 570 may form part or all of processor 222 of computing device 220 of FIG. 2B.

Referring now to FIG. 6, FIG. 6 shows an exemplary implementation of a computing device 220 implemented as image capture device 600, according to an embodiment. Image capture device 600 may include an optical image collector 606 that may capture an image including the user 105 and the DCM beacon 110, and capture that image as optical data 120A. Optical data 120A may then be sent to optical splitting module 605, which may split the optical signal, e.g., the light, into two paths. Referring to FIG. 6, the “south” path may transmit the light to an optical transformation module 610, which may apply a transformation, e.g., a Fourier transformation to the optical image data. The transformed optical data from module 610, as well as a reference image from optical beacon reference signal providing module 625 may be transmitted to optical beacon detection module 620. Optical beacon detection module 620 may optically detect the beacon using Fourier transformation and an optical correlator. The basic operation of performing optical image object detection is described in the publically-available (at the University of Michigan Online Library) paper “Report of Project MICHIGAN, SIGNAL DETECTION BY COMPLEX SPATIAL FILTERING,” by A. B. Vander Lugt, printed in July 1963 at the Radar Laboratory at the Institute of Science and Technology, the University of Michigan, which is hereby incorporated by reference in its entirety. Applicant's representative is including a copy of this paper with the filing of this application, for the convenience of the Examiner.

Referring again to FIG. 6, the “north” path from optical splitting module 605 may transmit the optical image data to an optical-to-digital converter 640, e.g., a CMOS or CCD sensor. In an embodiment, the digital signal then may be transmitted to image data encryption module 660, and the encrypted data transmitted to encrypted data and beacon transmitting module 680, along with the beacon detection result, for transmission to an external source, e.g., server 3000 as shown in FIG. 1. In an embodiment, barrier 650 may prevent access to the unencrypted image data by other image capture device modules 690. In an embodiment, barrier 650 may function similarly to barrier 340 and 450, and the descriptions of those barriers and their possible implementations also may apply to barrier 650. In an embodiment, image data encryption module 660, encrypted data and beacon transmitting module 680, and optical-to-digital converter 640 may be controlled by beacon detection control module 670, which may be part of the processor of image capture device 600, or may be a separate processor. In an embodiment, beacon detection control module 670 may form part or all of processor 222 of computing device 220 of FIG. 2B.

Referring now to FIG. 7, FIG. 7 shows an exemplary embodiment of an implementation of computing device 220 as image capture device 700. In an embodiment, image capture device 700 may include an optical image collector 710, e.g., a lens, which may collect the optical data 120A. Optical data 120A may be emitted to an optical beacon detection module 720, which may detect the DCM beacon 110 using one of the above-described optical detection methods. After detection of the beacon using optical techniques, the optical signal may be captured by an optical-to-digital conversion module 730, and converted to digital image data, which is transferred to image data encryption module 740 for encryption. In an embodiment, modules 710, 720, 730, and 740, are hard-wired to each other, and separated from encrypted data and beacon transmitting module 760 and other image capture device modules 770 by barrier 750 (which, in this embodiment, is shown for exemplary purposes only, because the physical construction of modules 710, 720, 730, and 740 removes the need for an actual barrier 750, whether implemented as hardware, programming, security, or access. In this embodiment, the image data is encrypted prior to interaction with the “main” portions of image capture device 700, and after the beacon data has been optically detected.

FIGS. 8-12 show one or more embodiments of a server device 230, according to one or more embodiments. Unless otherwise stated or contradictory to FIGS. 8-12, the server devices 830, 930, 1030, 1130, and 1230 may include the elements of server device 230, as previously described. Similarly, unless otherwise stated or contradictory to FIGS. 812, the computing devices 820, 920, 1020, 1120, and 1220 may include the elements of computing device 230, as previously described.

Referring now to FIG. 8, FIG. 8 shows an exemplary implementation of server device 230 as server device 830 operating in exemplary environment 800. In an embodiment, computing device 820 further includes a location and time log and transmission module 822A. In an embodiment, location and time log and transmission module 822A may record a location, e.g., through global positioning sensors, triangulation using radio signals, or other methods, of the computing device 820, and a time that the image is captured, at the time the image is captured. This data of location and time of the image capture, e.g., location and time of detection data 162, may be transmitted to server device 830, as shown in FIG. 8.

Referring again to FIG. 8, server device 830 may include a beacon metadata acquisition module 833. Beacon metadata acquisition module 833 may include location and time of beacon detection data acquisition module 833A. Location and time of beacon detection data acquisition module 833A may receive the location and time of detection data 162. In an embodiment in which the beacon metadata 150 is binary beacon metadata 150A, additional data regarding the image may be obtained. For example, server device 830 may transmit the location and time of detection data 162 to a remote location, e.g., to beacon support server 890. Beacon support server 890 may be associated with DCM beacon 110, and may be configured to log each time DCM beacon 110 is detected, e.g., in an embodiment in which DCM beacon 110 is an active beacon that can determine when it is detected. In an embodiment, beacon support server 890 may use the location and time of detection data 162 to determine which DCM beacon is detected, and transmit the beacon identification information back to server device 830, e.g., to beacon identification data acquisition module 833B. In an embodiment, this beacon identification information may be used by server device 830. In an embodiment, the beacon identification information may be used to identify the entity in the image, without decrypting the image, for example.

Referring now to FIG. 9, FIG. 9 shows an exemplary implementation of server device 230 as server device 930 operating in exemplary environment 900. In an embodiment, the computing device 920 may generate beacon metadata 150, which may be binary beacon metadata 150A, and transmit the binary beacon metadata 150A to server device 930. In an embodiment, server device 930 receives the binary beacon metadata, which may describe whether a beacon was detected in the encrypted image data block 160, but which does not provide additional data regarding the beacon. In an embodiment, server device 930 may include encrypted image analysis and data extraction module 932, which may perform analysis on the encrypted image, if possible, for example, the encrypted image data block may have metadata that is not encrypted or that may be read through the encryption. In an embodiment, for example, the image may be encrypted in such a manner that certain characteristics of the image may be obtained without decrypting the image. In an embodiment, server device 930 may use encrypted image analysis and data extraction module 932 to determine more information about the image, e.g., which may be used to perform valuation of the image and/or to retrieve term data regarding a terms of service associated with the DCM beacon 110 and the entity Jules Caesar 105.

Referring now to FIG. 10, FIG. 10 shows an exemplary implementation of server device 230 as server device 1030 operating in exemplary environment 1000. In an embodiment, computing device 1020 may transmit the beacon metadata 150, which may be binary beacon metadata 150A, to server device 1030. In an embodiment, server device 1030 may require more data regarding the image, in order to retrieve term data, or perform a valuation of the image data. Accordingly, in an embodiment, server device 1030 may include encrypted image analysis and data extraction module 1032, which may operate similarly to encrypted image analysis and data extraction module 932, and also, in an embodiment, encrypted image analysis and data extraction module 1032 may transmit the encrypted image data block to a “sandbox,” e.g., image decryption sandbox 1092. Image decryption sandbox 1092 may place the image in a virtual or physical “sandbox” where other processes may be unable to access the data. Image decryption sandbox 1092 may be part of server device 1030, or may be a separate entity. In an embodiment, image decryption sandbox 1092 may decrypt the encrypted image. Encrypted image decryption and beacon identification module 1092A may perform analysis on the decrypted image, including identifying the beacon, or identifying the entity, or a combination thereof. The identification data then may be given to beacon identification data reception module 1034. In an embodiment, the decrypted image data is then trapped in the sandbox and/or destroyed.

Referring now to FIG. 11, FIG. 11 shows an exemplary implementation of server device 230 as server device 1130 operating in exemplary environment 1100. In an embodiment, computing device 1120 may transmit beacon metadata 150, e.g., beacon identifier metadata 150B, to server device 1130. In an embodiment, beacon identifier metadata 150B may identify the beacon, e.g., the DCM beacon 110. The identification may be a unique identification, e.g. “this beacon is associated with user #13606116, Jules Caesar,” or, in an embodiment, the identification may be a class of beacon, e.g., “this is a beacon with a $100,000 dollar liquidated damages clause associated with using a likeness of the entity associated with the beacon,” or “this is a beacon of a television celebrity,” or “this is a beacon provided by Image Protect Corporation.”

Referring again to FIG. 11, server device 1130 receives the beacon identifier metadata 150B, and, in an embodiment, may transmit the identifier to an external location, e.g., a terms of service transmission server 1193. Terms of service transmission server 1193 may store terms of service associated with various beacons in its terms of service repository 1193B. In an embodiment, each unique beacon may be associated with its own unique terms of service. In another embodiment, there may be common terms of service for various users. In another embodiment, there may be common terms of service for various classes of users. In an embodiment, the terms of service may vary depending on how much the entity, e.g., Jules Caesar, is paying to use the beacon service.

In an embodiment, terms of service transmission server 1193 may include beacon identifier lookup table 1193A. Beacon identifier lookup table 1193A may receive the beacon identifier metadata 150B, and use the beacon identifier metadata 150B to obtain the terms of service associated with that beacon, e.g., terms of service data 151. In an embodiment, terms of service data 151 then may be transmitted to server device 1130.

Referring now to FIG. 12, FIG. 12 shows an exemplary implementation of server device 230 as server device 1230 operating in exemplary environment 1200. In an embodiment, computing device 1220 may detect the DCM beacon 110, and may obtain the terms of service from the detected beacon (e.g., the terms of service may be read from the beacon, e.g., in compressed binary). In an embodiment, the computing device 1220 may use the detected beacon data to obtain the terms of service data from another location, e.g., a terms of service data server (not pictured).

Referring again to FIG. 12, in an embodiment, computing device 1220 may transmit beacon metadata 150, e.g., beacon identifier and terms of service metadata 150C, to server device 1230. Beacon metadata acquisition module 1232 may receive the beacon identifier and terms of service metadata 150C, and detect that the terms of service are present in the beacon metadata. In an embodiment, beacon metadata terms of service reading module 1234 may read the terms of service from the beacon metadata 150.

The foregoing examples are merely provided as examples of how beacon data may operate, and how identifying data and/or term of service data may be obtained by the various server devices, and should not be interpreted as limiting the scope of the invention, which is defined solely by the claims. Any and all components of FIGS. 8-12 may be combined with each other, modified, or eliminated.

Referring now to FIG. 13, FIG. 13 illustrates an exemplary implementation of the encrypted image that includes at least one representation of a feature of an entity and that has been encrypted through use of a unique device code associated with an image capture device configured to perform image capture obtaining module 252. As illustrated in FIG. 3, the encrypted image that includes at least one representation of a feature of an entity and that has been encrypted through use of a unique device code associated with an image capture device configured to perform image capture obtaining module may include one or more sub-logic modules in various alternative implementations and embodiments. For example, as shown in FIG. 13, e.g., FIG. 13A, in an embodiment, module 252 may include encrypted image that includes at least one representation of a feature of an entity and that has been encrypted through use of a unique device code associated with an image capture device configured to perform image capture receiving module 1302. In an embodiment, module 1302 may include one or more of cryptographically encoded image that includes at least one representation of a feature of an entity and that has been encrypted through use of a unique device code associated with an image capture device configured to perform image capture receiving module 1304, encoded through use of a device-based encryption key image that includes at least one representation of a feature of an entity and that has been encrypted through use of a unique device code associated with an image capture device configured to perform image capture receiving module 1306, and encrypted image that includes at least one representation of a feature of a person and that has been encrypted through use of a unique device code associated with an image capture device configured to perform image capture receiving module 1310. In an embodiment, module 1306 may include encoded through use of a device-based encryption key multiple images of which at least one of the multiple images includes at least one representation of a feature of an entity and that has been encrypted through use of a unique device code associated with an image capture device configured to perform image capture receiving module 1308. In an embodiment, module 1310 may include encrypted image that includes at least one representation of a face of a publically-known person and that has been encrypted through use of a unique device code associated with an image capture device configured to perform image capture receiving module 1312.

Referring again to FIG. 13, e.g., FIG. 13B, in an embodiment, module 252 may include one or more of encrypted video that includes an image that contains at least one representation of a feature of an entity and that has been encrypted through use of a unique device code associated with an image capture device configured to perform image capture obtaining module 1314, encrypted compressed image that includes at least one representation of a feature of an entity and that has been encrypted through use of a unique device code associated with an image capture device configured to perform image capture obtaining module 1316, and encrypted image that includes at least one representation of a feature of an entity and that has been encrypted through use of a unique device code associated with an image capture device configured to perform image capture obtaining from the image capture device module 1318. In an embodiment, module 1318 may include encrypted image that includes at least one representation of a feature of a nonidentified entity and that has been encrypted through use of a unique device code associated with an image capture device configured to perform image capture obtaining from the image capture device module 1320.

Referring again to FIG. 13, e.g., FIG. 13C, in an embodiment, module 252 may include encrypted image that includes unencrypted metadata and at least one representation of a feature of an entity and that has been encrypted through use of a unique device code associated with an image capture device configured to perform image capture obtaining module 1322. In an embodiment, module 1322 may include one or more of encrypted image that includes unencrypted entity name metadata and at least one representation of a feature of an entity and that has been encrypted through use of a unique device code associated with an image capture device configured to perform image capture obtaining module 1324, encrypted image that includes unencrypted image capture device identifier metadata and at least one representation of a feature of an entity and that has been encrypted through use of a unique device code associated with an image capture device configured to perform image capture obtaining module 1326, and encrypted image that includes unencrypted image property metadata and at least one representation of a feature of an entity and that has been encrypted through use of a unique device code associated with an image capture device configured to perform image capture obtaining module 1328. In an embodiment, module 1328 may include encrypted image that includes unencrypted image particular characteristic metadata and at least one representation of a feature of an entity and that has been encrypted through use of a unique device code associated with an image capture device configured to perform image capture obtaining module 1330.

Referring now to FIG. 14, FIG. 14 illustrates an exemplary implementation of beacon metadata related to a presence, in the encrypted image that is captured by the image capture device, of a privacy beacon that is associated with the at least one entity acquiring module 254. As illustrated in FIG. 14, the beacon metadata related to a presence, in the encrypted image that is captured by the image capture device, of a privacy beacon that is associated with the at least one entity acquiring module 254 may include one or more sub-logic modules in various alternative implementations and embodiments. For example, as shown in FIG. 14 (e.g., FIG. 14A), in an embodiment, module 254 may include beacon metadata related to a presence, in the encrypted image that is captured by a component under control of the image capture device, of a privacy beacon that is associated with the at least one entity acquiring module 1402. In an embodiment, module 1402 may include beacon metadata that includes an identification number of the privacy beacon detected in the encrypted image that is captured by a component under control of the image capture device acquiring module 1404. In an embodiment, module 1404 may include beacon metadata that includes a unique identification number of the privacy beacon detected in the encrypted image that is captured by a component under control of the image capture device acquiring module 1406. In an embodiment, module 1406 may include one or more of beacon metadata that includes a unique identification number of the privacy beacon embedded in the entity and that emits light detected in the encrypted image that is captured by a component under control of the image capture device acquiring module 1408 and beacon metadata that includes a unique identification number of the privacy beacon that emits nonvisible light and that has been detected in the encrypted image that is captured by a component under control of the image capture device acquiring module 1410.

Referring again to FIG. 14, e.g., FIG. 14B, in an embodiment, module 254 may include one or more of beacon metadata related to a presence, in the encrypted image that is captured by the image capture device, of a privacy beacon that is associated with the at least one entity receiving module 1412, beacon metadata related to a presence, in the encrypted image that is captured by the image capture device, of a privacy beacon that is carried on or by the at least one entity acquiring module 1414, and beacon metadata related to a presence, in the encrypted image that is captured by the image capture device, of a privacy beacon that is associated with a device under control of the at least one entity acquiring module 1416. In an embodiment, module 1416 may include one or more of beacon metadata related to a presence, in the encrypted image that is captured by the image capture device, of a privacy beacon that is associated with a tablet device under control of the at least one entity acquiring module 1418 and beacon metadata related to a presence, in the encrypted image that is captured by the image capture device, of a privacy beacon for which an appearance is controlled by with the device under control of the at least one entity acquiring module 1420.

Referring again to FIG. 14, e.g., FIG. 14C, in an embodiment, module 254 may include one or more of beacon metadata related to a presence, in the encrypted image that is captured by the image capture device, of a privacy beacon that is associated with the at least one entity and that is configured to emit an identification signal acquiring module 1422, beacon metadata related to a presence, in the encrypted image that is captured by the image capture device, of a privacy beacon that is associated with the at least one entity and that is configured to be detectable by one or more devices acquiring module 1424, beacon metadata related to a presence, in the encrypted image that is captured by the image capture device, of a privacy beacon that is placed by the entity and that is associated with the at least one entity acquiring module 1426, beacon metadata related to a presence, in the encrypted image that is captured by the image capture device, of a privacy beacon that is configured to be detectable through use of an optical component and that is associated with the at least one entity acquiring module 1428, and beacon metadata related to a presence, in the encrypted image that is captured by the image capture device, of a passive privacy beacon that is associated with the at least one entity acquiring module 1430.

Referring again to FIG. 14, e.g., FIG. 14D, in an embodiment, module 254 may include one or more of beacon metadata related to a presence, in the encrypted image that is captured by the image capture device, of a privacy beacon that is detected through analysis of image data and that is associated with the at least one entity acquiring module 1432, beacon metadata in binary format that is related to a presence, in the encrypted image that is captured by the image capture device, of a privacy beacon that is associated with the at least one entity acquiring module 1434, and alphanumeric string beacon metadata related to a presence, in the encrypted image that is captured by the image capture device, of a privacy beacon that is associated with the at least one entity acquiring module 1436. In an embodiment, module 1436 may include one or more of alphanumeric identification string beacon metadata related to a presence, in the encrypted image that is captured by the image capture device, of a privacy beacon that is associated with the at least one entity acquiring module 1438, alphanumeric string beacon metadata that is configured to be used for a retrieval of entity identity data and that is related to a presence, in the encrypted image that is captured by the image capture device, of a privacy beacon that is associated with the at least one entity acquiring module 1440, and alphanumeric string beacon metadata that is configured to be used for a retrieval of entity associated data and that is related to a presence, in the encrypted image that is captured by the image capture device, of a privacy beacon that is associated with the at least one entity acquiring module 1442. In an embodiment, module 1442 may include alphanumeric string beacon metadata that is configured to be used for a retrieval of an entity associated service term data and that is related to a presence, in the encrypted image that is captured by the image capture device, of a privacy beacon that is associated with the at least one entity acquiring module 1444.

Referring again to FIG. 14, e.g., FIG. 14E, in an embodiment, module 254 may include privacy beacon that includes data regarding the entity and that is associated with the at least one entity within the obtained image detecting module that avoids further image process operation on obtained image data prior to encryption of the obtained image data 1446. In an embodiment, module 1446 may include privacy beacon that includes service term data associated with the entity and that is associated with the at least one entity within the obtained image detecting module that avoids further image process operation on obtained image data prior to encryption of the obtained image data 1448.

Referring now to FIG. 15, FIG. 15 illustrates an exemplary implementation of determination with regard to allowance of manipulation of the encrypted image that is at least partly based on the acquired beacon data and at least partly based on a calculation that involves the encrypted image performing module 256. As illustrated in FIG. 15, the determination with regard to allowance of manipulation of the encrypted image that is at least partly based on the acquired beacon data and at least partly based on a calculation that involves the encrypted image performing module 256 may include one or more sub-logic modules in various alternative implementations and embodiments. For example, as shown in FIG. 15, e.g., FIG. 15A, in an embodiment, module 256 may include one or more of determination with regard to allowance of decryption of the encrypted image that is at least partly based on the acquired beacon data and at least partly based on a calculation that involves the encrypted image performing module 1502, determination with regard to allowance of transmission of the encrypted image that is at least partly based on the acquired beacon data and at least partly based on a calculation that involves the encrypted image performing module 1504, determination with regard to allowance of distribution of the encrypted image that is at least partly based on the acquired beacon data and at least partly based on a calculation that involves the encrypted image performing module 1506, and determination with regard to allowance of manipulation of the encrypted image that is at least partly based on the acquired beacon data and at least partly based on a calculation that related to a feature of the encrypted image performing module 1508.

Referring again to FIG. 15, e.g., FIG. 15B, in an embodiment, module 256 may include determination with regard to allowance of manipulation of the encrypted image that is at least partly based on the acquired beacon data and at least partly based on a valuation calculation that involves the encrypted image performing module 1510. In an embodiment, module 1510 may include determination with regard to allowance of manipulation of the encrypted image that is at least partly based on the acquired beacon data and at least partly based on a valuation of the representation of the feature of the at least one entity in the encrypted image performing module 1512. In an embodiment, module 1512 may include one or more of determination with regard to allowance of manipulation of the encrypted image that is at least partly based on the acquired beacon data and at least partly based on a valuation of an amount of internet traffic that may be driven by the representation of the feature of the at least one entity in the encrypted image performing module 1514, determination with regard to allowance of manipulation of the encrypted image that is at least partly based on the acquired beacon data and at least partly based on a valuation of a sale of an unencrypted version of the encrypted image that contains the representation of the feature of the at least one entity performing module 1516, and determination with regard to allowance of manipulation of the encrypted image that is at least partly based on the acquired beacon data and at least partly based on a valuation of the representation of the feature of the at least one entity in the encrypted image performing without image decryption module 1520. In an embodiment, module 1516 may include determination with regard to allowance of manipulation of the encrypted image that is at least partly based on the acquired beacon data and at least partly based on a valuation of a sale to a reseller of the unencrypted version of the encrypted image that contains the representation of the feature of the at least one entity performing module 1518.

Referring again to FIG. 15, e.g., FIG. 15C, in an embodiment, module 256 may include one or more of estimated amount of potential damage that may be incurred through release of unencrypted version of the encrypted image determining at least partly based on the acquired privacy metadata module 1522, estimated amount of potential revenue that may be obtained through the release of the unencrypted version of the encrypted image calculating module 1524, and determination regarding allowance of manipulation of the encrypted image at least partly based on the calculated estimated amount of potential revenue and the determined estimated amount of potential damage performing module 1526. In an embodiment, module 1522 may include estimated amount of potential monetary damage that may be incurred through release of unencrypted version of the encrypted image determining at least partly based on the acquired privacy metadata module 1528. In an embodiment, module 1528 may include estimated amount of potential monetary damage that may be recovered by the entity through release of unencrypted version of the encrypted image determining at least partly based on the acquired privacy metadata module 1530. In an embodiment, module 1530 may include estimated amount of potential monetary damage that may be recovered by the entity through release of unencrypted version of the encrypted image determining at least partly based on a term of service associated with the entity module 1532. In an embodiment, module 1532 may include estimated amount of potential monetary damage that may be recovered by the entity through release of unencrypted version of the encrypted image determining at least partly based on a term of service associated with the entity and obtained through use of the privacy metadata module 1534.

Referring again to FIG. 15, e.g., FIG. 15D, in an embodiment, module 256 may include modules 1522, 1524, and 1526, as previously described. In an embodiment, module 1524 may include one or more of estimated amount of potential revenue that may be obtained at least partly through selection of one or more advertisements on a web site that features the unencrypted version of the encrypted image calculating module 1536, estimated amount of potential nonmonetary revenue that may be obtained through increased notoriety of a web site that features the unencrypted version of the encrypted image calculating module 1538, estimated amount of improved search engine position revenue that may be obtained through release of unencrypted version of the encrypted image calculating module 1540, estimated amount of revenue that may be obtained through subscription fee to a website that features the unencrypted version of the encrypted image calculating module 1542, estimated amount of social media status that may be obtained for an entity that publishes the unencrypted version of the encrypted image to a social networking site calculating module 1544, and estimated amount of revenue that may be obtained through increased traffic to a web site that allows download of the unencrypted version of the encrypted image module 1546.

Referring again to FIG. 15, e.g., FIG. 15E, in an embodiment, module 256 may include one or more of amount of potential damage that may be incurred through release of unencrypted version of the encrypted image evaluating at least partly based on the acquired privacy metadata module 1548, estimated amount of potential revenue that may be obtained through the release of the unencrypted version of the encrypted image calculating module 1550, and determination regarding allowance of manipulation of the encrypted image at least partly based on the calculated estimated amount of potential revenue and the evaluated amount of potential damage performing module 1552. In an embodiment, module 1548 may include one or more of amount of potential damage that may be incurred through release of unencrypted version of the encrypted image evaluating at least partly based on the acquired binary privacy metadata module 1554, presence of privacy beacon in the encrypted image confirming from privacy metadata module 1556, and identification data of the entity represented in the encrypted image acquiring module 1558. In an embodiment, module 1558 may include one or more of identification data of the entity for which the privacy beacon is associated obtaining from a detected privacy beacon database module 1560 and identification of the entity for which the privacy beacon is associated acquisition through performance of analysis on the encrypted image acquiring module 1564. In an embodiment, module 1560 may include identification data of the entity for which the privacy beacon that was detected by the image capture device is associated obtaining from the detected privacy beacon database module 1562.

Referring again to FIG. 15, e.g., FIG. 15F, in an embodiment, module 256 may include one or more of modules 1548, 1550, 1552, 1556, and 1558, as previously described. In an embodiment, module 1558 may include one or more of identification data of the entity for which the privacy beacon is associated obtaining from a decrypted image that is decrypted in a protected environment module 1566 and identification data of the entity for which the privacy beacon is associated obtaining from an external source module 1572. In an embodiment, module 1566 may include one or more of identification data of the entity for which the privacy beacon is associated extracting from the decrypted image that is decrypted in the protected environment module 1568 and decrypted image destruction upon identification data extraction facilitating module 1570.

Referring again to FIG. 15, e.g., FIG. 15G, in an embodiment, module 256 may include one or more of modules 1548, 1550, 1552, 1556, and 1558, as previously described. In an embodiment, module 1558 may include identification data of the entity for which the privacy beacon is associated obtaining through analysis of data regarding the image capture device at a time of capturing the encrypted image module 1574. In an embodiment, module 1574 may include identification data of the entity for which the privacy beacon is associated obtaining through analysis of a position and orientation of the image capture device at a time of capturing the encrypted image module 1576.

Referring again to FIG. 15, e.g., FIG. 15H, in an embodiment, module 256 may include one or more of amount of potential damage that may be incurred through release of unencrypted version of the encrypted image evaluating at least partly based on the acquired privacy metadata that identifies the privacy beacon module 1578, estimated amount of potential revenue that may be obtained through the release of the unencrypted version of the encrypted image calculating module 1580, and determination regarding allowance of manipulation of the encrypted image at least partly based on the calculated estimated amount of potential revenue and the evaluated amount of potential damage performing module 1582. In an embodiment, module 1578 may include amount of potential damage that may be incurred through release of unencrypted version of the encrypted image evaluating at least partly based on an acquired character string that identifies the privacy beacon module 1584. In an embodiment, module 1584 may include one or more of amount of potential damage that may be incurred through release of unencrypted version of the encrypted image evaluating at least partly based on an acquired character string that identifies a class of privacy beacon module 1586, amount of potential damage that may be incurred through release of unencrypted version of the encrypted image evaluating at least partly based on an acquired character string that uniquely identifies the privacy beacon module 1588, and amount of potential damage that may be incurred through release of unencrypted version of the encrypted image evaluating at least partly based on term of service data obtained through use of the acquired character string that identifies the privacy beacon module 1590.

Referring again to FIG. 15, e.g., FIG. 15I, in an embodiment, module 256 may include one or more of term of service data that includes data regarding potential damages incurred through release of the encrypted image and that is related to the acquired privacy metadata acquiring module 1592, determination regarding allowance of manipulation of the encrypted image at least partly based on the term of service data and at least partly based on an estimated amount of potential revenue from release of the encrypted image performing module 1594, allowance of manipulation of the encrypted when potential damages incurred through release of the encrypted image are less than potential revenues accrued from the release of the encrypted image granting module 1596, and allowance of manipulation of the encrypted when a ratio of potential damages incurred through release of the encrypted image to potential revenues accrued from the release of the encrypted image is less than a particular value granting module 1598.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 16 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIGS. 17-19 as well as the other operations to be described herein may be performed by at least one of a machine, an article of manufacture, or a composition of matter.

It is noted that, the term “associated” does not require physical proximity. A device could be associated with a user if the user purchased that device, or stores information on that device, or has ever logged in and identified herself to that device. In addition, a device may be associated with a user if the user holds the device, carries the device, operates the device, or is assigned the device.

It is noted that “indicator” and “indication” may, in various embodiments, refer to many different things, including any of electronic signals (e.g., pulses between two components), human-understandable signals (e.g., information being displayed on a screen, or a lighting of a light, or a playing of a sound), and non-machine related signals (e.g., two people talking, a change in ambient temperature, the occurrence of an event, whether large scale (e.g., earthquake) or small-scale (e.g., the time becomes 4:09 p.m. and 32 seconds)), alone or in any combination.

Referring now to FIG. 16, FIG. 16 shows operation 1600, e.g., an example operation of a server device 230 operating in an environment 200. In an embodiment, operation 1600 may include operation 1602 depicting acquiring a block of encrypted data that corresponds to at least one image that has been encrypted through use of a unique device code associated with an image capture device configured to capture the at least one image, wherein the at least one image includes at least one representation of a feature of at least one entity. For example, FIG. 2, e.g., FIG. 2B, shows encrypted image that includes at least one representation of a feature of an entity and that has been encrypted through use of a unique device code associated with an image capture device configured to perform image capture obtaining module 252 acquiring (e.g., obtaining, receiving, calculating, selecting from a list or other data structure, receiving, retrieving, or receiving information regarding, performing calculations to find out, retrieving data that indicates, receiving notification, receiving information that leads to an inference, whether by human or automated process, or being party to any action or transaction that results in informing, inferring, or deducting, including but not limited to circumstances without absolute certainty, including more-likely-than-not and/or other thresholds) a block (e.g., any number of bits or bytes that is greater than one, that has some sort of connection, whether logical or physical, regardless of whether packaged, stored, processed, or read together) of encrypted data that corresponds to (e.g., that includes, or is a pointer to, or is instructions for retrieving) at least one image (e.g., a description of a graphic picture that is a visual representation of something, regardless of whether that something is coherent, nonsensical, abstract, or otherwise) that has been encrypted (e.g., one or more operations have been performed with the intention of preventing, delaying, or hindering unauthorized access) through use of a unique device code (e.g., a code that is unique, and is associated with a device (e.g., stored on the device, or tied to the device, or has some logical relationship with the device) that is associated with an image capture device (e.g., any device with the capability of capturing, storing, or manipulating images) configured to capture (e.g., obtain, e.g., receive, retrieve, or take, e.g., convert light data into image data) the at least one image (e.g., the description of a graphic picture that is a visual representation of something, regardless of whether that something is coherent, nonsensical, abstract, or otherwise) wherein the at least one image includes at least one representation of a feature of at least one entity

Referring again to FIG. 16, operation 1600 may include operation 1604 depicting obtaining a privacy metadata that corresponds to a detection of a privacy beacon in the at least one image, said at least one image captured by the image capture device, said privacy beacon associated with the at least one entity. For example, FIG. 2, e.g., FIG. 2B, shows beacon metadata related to a presence, in the encrypted image that is captured by the image capture device, of a privacy beacon that is associated with the at least one entity acquiring module 254 obtaining (e.g., acquiring, receiving, calculating, selecting from a list or other data structure, receiving, retrieving, or receiving information regarding, performing calculations to find out, retrieving data that indicates, receiving notification, receiving information that leads to an inference, whether by human or automated process, or being party to any action or transaction that results in informing, inferring, or deducting, including but not limited to circumstances without absolute certainty, including more-likely-than-not and/or other thresholds) a privacy metadata (e.g., data that is about the image, and more specifically, data that is about a presence or absence of a privacy beacon in the image, e.g., whether binary yes-or-no data or more specific data about the specific privacy beacon, or details about the entity for which the privacy beacon is associated) that corresponds to (e.g., has some relationship with, e.g., provides some data regarding, e.g., an identity of, or whether the beacon is present, or what entity the beacon is associated with, for example) a detection (e.g., data regarding the beacon, e.g., whether the beacon is present, and/or if so, what entity is associated with the beacon) of a privacy beacon (e.g., a marker detectable by some sensor or other action, which may be passive, active, visible or invisible, may operate on the electromagnetic spectrum or in another field, a partial list of which is included below) in the at least one image (e.g., the description of a graphic picture that is a visual representation of something, regardless of whether that something is coherent, nonsensical, abstract, or otherwise), said privacy beacon (e.g., a marker detectable by some sensor or other action, which may be passive, active, visible or invisible, may operate on the electromagnetic spectrum or in another field, a partial list of which is included below) associated (e.g., has a relationship with, e.g., controlled by, directed by, is linked to information about, appears in a similar area as, operates with common purpose, etc.) with the at least one entity (e.g., a thing, e.g., a person, a rock, a deer, anything that has separate and distinct existence and objective or conceptual reality).

Referring again to FIG. 16, operation 1600 may include operation 1606 depicting determining, at least partly based on the obtained privacy metadata, and at least partly based on a calculation related to the block of encrypted data that corresponds to the at least one image, whether to allow one or more processes related to the encrypted data block. For example, FIG. 2, e.g., FIG. 2B, shows determination with regard to allowance of manipulation of the encrypted image that is at least partly based on the acquired beacon data and at least partly based on a calculation that involves the encrypted image performing module 256 determining (e.g., carrying out one or more logical steps, through any known process by machine, which may be assisted by human intellect in part, to facilitate a decision, including gathering data to help with the decision, winnowing or paring data to assist in the decision, assigning a weight to one or more factors, and the like), at least partly based on the obtained privacy metadata (e.g., data that is about the image, and more specifically, data that is about a presence or absence of a privacy beacon in the image, e.g., whether binary yes-or-no data or more specific data about the specific privacy beacon, or details about the entity for which the privacy beacon is associated), and partly based on a calculation (e.g., a result of one or more operations of any kind, whether assisted by a human or human input or fully automated) related to the block (e.g., any number of bits or bytes that is greater than one, that has some sort of connection, whether logical or physical, regardless of whether packaged, stored, processed, or read together) of encrypted data (e.g., the encrypted image data, and possibly other data) that corresponds to (e.g., that includes, or is a pointer to, or is instructions for retrieving) at least one image (e.g., a description of a graphic picture that is a visual representation of something, regardless of whether that something is coherent, nonsensical, abstract, or otherwise), whether to allow (e.g., carry out one or more processes that facilitate the furtherance of, whether directly or indirectly (e.g., changing an access level of data, or of processes that operate on the data) one or more processes (e.g., any operations, including, but not limited to decryption, copying, modification, distribution, upload, download, transmission, deletion, sharing, posting to a social network, printing, selling, offering for sale, providing details about, publishing, leveraging for sale, or any combination thereof) related to (e.g., in this context, any process that involves, directly or indirectly, as an input, output, factor, reference, placeholder, example, or any other use) the encrypted data block (e.g., any number of bits or bytes that is greater than one, that has some sort of connection, whether logical or physical, regardless of whether packaged, stored, processed, or read together, that may include the encrypted image)

An example terms of service is listed below with the numbered paragraphs 1-5. Many other variations of terms of service are known and used in click-through agreements that are common at the time of filing, and the herein example is intended to be exemplary only and not limiting in any way.

1. By capturing an image of any part of the user Jules Caesar (hereinafter “Image”), or providing any automation, design, resource, assistance, or other facilitation in the capturing of the Image, you agree that you have captured these Terms of Service and that you acknowledge and agree to them. If you cannot agree to these Terms of Service, you should immediately delete the captured Image. Failure to do so will constitute acceptance of these Terms of Service.

2. The User Jules Caesar owns all of the rights associated with the Image and any representation of any part of Jules Caesar thereof;

3. By capturing the Image, you agree to provide the User Jules Caesar just compensation for any commercialization of the User's personality rights that may be captured in the Image.

4. By capturing the Image, you agree to take all reasonable actions to track the Image and to provide an accounting of all commercialization attempts related to the Image, whether successful or not.

5. By capturing the Image, you accept a Liquidated Damages agreement in which unauthorized use of the Image will result in mandatory damages of at least, but not limited to, $1,000,000.

A privacy beacon may include, but is not limited to, one or more of a marker that reflects light in a visible spectrum, a marker that reflects light in a nonvisible spectrum, a marker that emits light in a visible spectrum, a marker that emits light in a nonvisible spectrum, a marker that emits a radio wave, a marker that, when a particular type of electromagnetic wave hits it, emits a particular electromagnetic wave, an RFID tag, a marker that uses near-field communication, a marker that is in the form of a bar code, a marker that is in the form of a bar code and painted on a user's head and that reflects light in a nonvisible spectrum, a marker that uses high frequency low penetration radio waves (e.g., 60 GHz radio waves), a marker that emits a particular thermal signature, a marker that is worn underneath clothing and is detectable by an x-ray-type detector, a marker that creates a magnetic field, a marker that emits a sonic wave, a marker that emits a sonic wave at a frequency that cannot be heard by humans, a marker that is tattooed to a person's bicep and is detectable through clothing, a marker that is a part of a user's cellular telephone device, a marker that is broadcast by a part of a user's cellular telephone device, a marker that is broadcast by a keychain carried by a person, a marker mounted on a drone that maintains a particular proximity to the person. a marker mounted in eyeglasses, a marker mounted in a hat. a marker mounted in an article of clothing, the shape of the person's face is registered as the beacon, a feature of a person registered as the beacon, a marker displayed on a screen, a marker in the form of an LED, a marker embedded on a page, or a book, a string of text or data that serves as a marker, a marker embedded or embossed onto a device, and the like.

FIGS. 17A-17E depict various implementations of operation 1602, depicting acquiring a block of encrypted data that corresponds to at least one image that has been encrypted through use of a unique device code associated with an image capture device configured to capture the at least one image, wherein the at least one image includes at least one representation of a feature of at least one entity according to embodiments. Referring now to FIG. 17A, operation 1602 may include operation 1702 depicting receiving a block of encrypted data that corresponds to the at least one image that has been encrypted through use of the unique device code associated with the image capture device configured to capture the at least one image, wherein the at least one image includes at least one representation of the feature of at least one entity. For example, FIG. 13, e.g., FIG. 13A shows encrypted image that includes at least one representation of a feature of an entity and that has been encrypted through use of a unique device code associated with an image capture device configured to perform image capture receiving module 1302 receiving a block (e.g., any number of bits or bytes that is greater than one, that has some sort of connection, whether logical or physical, regardless of whether packaged, stored, processed, or read together) of encrypted data (e.g., data that has been modified to prevent unauthorized access through use of private-key encryption) that has been encrypted through use of a unique device code (e.g., a code that is unique to the device that captured the image, e.g., the Google Glass device) associated with the image capture device (e.g., the Google Glass device) configured to capture the at least one image (e.g., an image of a celebrity at a restaurant), wherein the at least one image includes at least one representation (e.g., pixels) of the feature (e.g., the face) of at least one entity (e.g., the celebrity).

Referring again to FIG. 17A, operation 1702 may include operation 1704 depicting receiving a block of data that has been encoded to deter unauthorized access, wherein said block of data corresponds at least one image that has been encoded to deter unauthorized access through use of the unique device code associated with the image capture device configured to capture the at least one image, wherein the at least one image includes the at least one representation of the feature of the at least one entity. For example, FIG. 13, e.g., FIG. 13A, shows cryptographically encoded image that includes at least one representation of a feature of an entity and that has been encrypted through use of a unique device code associated with an image capture device configured to perform image capture receiving module 1304 receiving a block of data (e.g., an encrypted image file) that has been encoded to deter unauthorized access through use of the unique device code (e.g., a 16 character string) associated with the image capture device (e.g., an EyeTap optical head-mounted computer) configured to capture the at least one image (e.g., a picture of friends at a bar), wherein the at least one image includes the at least one representation (e.g., pixels) of the feature (e.g., head shot) of the at least one entity (e.g., a person in the image).

Referring again to FIG. 17A, operation 1702 may include operation 1706 depicting receiving the block of encrypted data that corresponds to the at least one image that has been encrypted through use of the unique device code as an encryption key, said unique device code associated with the image capture device configured to capture the at least one image, wherein the at least one image includes at least one representation of the feature of the at least one entity. For example, FIG. 13, e.g., FIG. 13A, shows encoded through use of a device-based encryption key image that includes at least one representation of a feature of an entity and that has been encrypted through use of a unique device code associated with an image capture device configured to perform image capture receiving module 1306 receiving the block of encrypted data that corresponds to the at least one image (e.g., a picture of two people on a boat) that has been encrypted through use of the unique device code (e.g., a device's MAC address) as an encryption key (e.g., a key, or a seed for a key), said unique device code associated with the image capture device (e.g., Apple's wearable computer, e.g., “iGlasses”) (it is noted that this product does not exist at the time of filing, but is an imaginary example for illustrative purposes only) configured to capture the at least one image (e.g., the picture of two people on a boat), wherein the at least one image includes at least one representation (e.g., a pixel representation) of the feature (e.g., a full-body image) of the at least one entity (e.g., one of the people on the boat).

Referring again to FIG. 17A, operation 1706 may include operation 1708 depicting receiving the block of encrypted data that corresponds to two or more images including the at least one image, wherein said two or more images have been encrypted by the image capture device through use of the unique device code as the encryption key, and wherein the at least one image of the two or more images includes at least one representation of a feature of at least one entity. For example, FIG. 13, e.g., FIG. 13A, shows encoded through use of a device-based encryption key multiple images of which at least one of the multiple images includes at least one representation of a feature of an entity and that has been encrypted through use of a unique device code associated with an image capture device configured to perform image capture receiving module 1308 receiving the block of encrypted data that corresponds to two or more images (e.g., a picture of two people at a restaurant, taken at 8:05:00 p.m., and a picture of the two people at the restaurant, at 8:05:05 p.m.) including the at least one image (e.g., the picture of the two people at the restaurant at 8:05:05 p.m., which shows a famous celebrity wearing a particular name brand of watch), wherein said two or more images have been encrypted by the image capture device (e.g., a Microsoft-branded wearable computer with optical headset, e.g., a “KinectVision” (it is noted that this product does not exist at the time of filing, but is an imaginary example used to illustrate a non-limiting implementation of one or more embodiments)) through use of the unique device code (e.g., a user ID associated with the device and also with other services, e.g., a Microsoft-themed login, e.g., for Microsoft mail or Microsoft-branded gaming, e.g., an Xbox Live account) as the encryption key (e.g., as the key itself or as a seed for generating the key), and wherein the at least one image (e.g., the picture of the two people at the restaurant at 8:05:05 p.m., which shows a famous celebrity wearing a particular name brand of watch) of the two or more images (e.g., a picture of two people at a restaurant, taken at 8:05:00 p.m., and a picture of the two people at the restaurant, at 8:05:05 p.m.) includes at least one representation (e.g., digital image data) of a feature (e.g., the watch that a person is wearing) of at least one entity (e.g., the famous celebrity).

Referring now to FIG. 17B, operation 1702 may include operation 1710 depicting receiving a block of encrypted data that corresponds to the at least one image that has been encrypted through use of the unique device code associated with the image capture device configured to capture the at least one image, wherein the at least one image includes at least one representation of a feature of a person. For example, FIG. 13, e.g., FIG. 13A, shows encrypted image that includes at least one representation of a feature of a person and that has been encrypted through use of a unique device code associated with an image capture device configured to perform image capture receiving module 1310 receiving a block of encrypted data (e.g., data transmitted in packet format) that corresponds to the at least one image (e.g., an image of a group of friends at a baseball game) that has been encrypted through use of the unique device code (e.g., a 1024 bit numeric string) associated with (e.g., assigned to) the image capture device (e.g., Nokia/Vuzix's “SMARTglasses”) configured to capture the at least one image (e.g., the image of the group of friends at a baseball game), wherein the at least one image includes at least one representation of a feature (e.g., a face) of a person (e.g., one of the people of the group of friends).

Referring again to FIG. 17B, operation 1710 may include operation 1712 depicting receiving a block of encrypted data that corresponds to the at least one image that has been encrypted through use of the unique device code associated with the image capture device configured to capture the at least one image, wherein the at least one image includes at least one representation of a face of a publically-known person. For example, FIG. 13, e.g., FIG. 13A, shows encrypted image that includes at least one representation of a face of a publically-known person and that has been encrypted through use of a unique device code associated with an image capture device configured to perform image capture receiving module 1312 receiving a block of encrypted data (e.g., data to which a data protection scheme has been applied) that corresponds to the at least one image (e.g., a surreptitious picture of two people, including one movie star, sitting on a park bench) that has been encrypted through use of the unique device code (e.g., a 1024 bit character string) associated with the image capture device (e.g., a DigiLens DL40 optical head-mounted computer) configured to capture the at least one image (e.g., the surreptitious picture of two people, including one movie star, sitting on a park bench), wherein the at least one image includes at least one representation of a face of a publically known person (e.g., the movie star sitting on the park bench).

Referring now to FIG. 17C, operation 1602 may include operation 1714 depicting acquiring a block of encrypted data corresponding to a series of images that represent a video that has been encrypted through use of the unique device code associated with the image capture device configured to capture the series of images, wherein at least one of the series of images includes at least one representation of the feature of at least one entity. For example, FIG. 13, e.g., FIG. 13B, shows encrypted video that includes an image that contains at least one representation of a feature of an entity and that has been encrypted through use of a unique device code associated with an image capture device configured to perform image capture obtaining module 1314 acquiring a block of encrypted data corresponding to a series of images that represent a video (e.g., a sex tape filmed with an infrared camera) that has been encrypted through use of the unique device code (e.g., a device name and model number that is used as a seed for an encryption key generator) associated with the image capture device (e.g., a Samsung wearable computer, e.g., the rumored (as of the time of the filing of this application) “Samsung Spectacles”) configured to capture the series of images, wherein at least one of the series of images includes at least one representation (e.g., pixel representation) of a feature (e.g., genitalia) of at least one entity (e.g., one of the participants in the sex tape).

Referring again to FIG. 17C, operation 1602 may include operation 1716 depicting acquiring a block of encrypted data that corresponds to at least one compressed image that has been encrypted through use of the unique device code associated with the image capture device configured to capture the image, wherein the image includes at least one representation of the feature of the at least one entity. For example, FIG. 13, e.g., FIG. 13B, shows encrypted compressed image that includes at least one representation of a feature of an entity and that has been encrypted through use of a unique device code associated with an image capture device configured to perform image capture obtaining module 1316 acquiring a block of encrypted data that corresponds to at least one compressed (e.g., an image that has had processing performed on it in an attempt to decrease the size (e.g., the amount of memory required to store the image) of the image, whether successful or not) image that has been encrypted through use of the unique device code (e.g., a name of the device given by a user of the device, with a number appended to the end of the name of the device), wherein the image (e.g., a picture of a person walking down a crowded street), wherein the image includes at least one representation of the feature of the at least one entity (e.g., the facial profile of the person walking down the crowded street).

Referring again to FIG. 17C, operation 1602 may include operation 1718 depicting receiving, from the image capture device, a block of encrypted data that corresponds to at least one image that has been encrypted through use of the unique device code associated with the image capture device configured to capture the at least one image, wherein the at least one image includes the at least one representation of the feature of the at least one entity. For example, FIG. 13, e.g., FIG. 13B, shows encrypted image that includes at least one representation of a feature of an entity and that has been encrypted through use of a unique device code associated with an image capture device configured to perform image capture obtaining from the image capture device module 1318 receiving, from the image capture device (e.g., a Google Glass optical headset wearable computer), a block of encrypted data that corresponds to at least one image (e.g., an image of a person sitting in an airport terminal reading a book) that has been encrypted through use of the unique device code (e.g., a code that is unique to the Google Glass optical headset that performed the image capture) associated with the image capture device (e.g., the Google Glass optical headset) configured to capture the at least one image (e.g., the image of the person sitting in the airport terminal reading the book), wherein the at least one image includes the at least one representation of the feature (e.g., the book that the person was reading) of the at least one entity (e.g., the person).

Referring again to FIG. 17C, operation 1718 may include operation 1720 depicting receiving, from the image capture device, the block of encrypted data that corresponds to the at least one image that has been encrypted through use of the unique device code associated with the image capture device configured to capture the at least one image, wherein the at least one image includes at least one representation of a feature of at least one unrecognized entity that was not recognized by the image capture device. For example, FIG. 13, e.g., FIG. 13B, shows encrypted image that includes at least one representation of a feature of a nonidentified entity and that has been encrypted through use of a unique device code associated with an image capture device configured to perform image capture obtaining from the image capture device module 1320 receiving, from the image capture device (e.g., an Apple-branded head mounted computer that connects to a user's phone device), the block of encrypted data that corresponds to the at least one image that has been encrypted through use of the unique device code (e.g., the user's identification at the Apple Store, appended with a two-digit number indicating the number of the device that the user owns, for example, if the user, e.g., “JohnnyPaul2013 owns two other Apple-branded devices, then his unique device code may be “JohnnyPaul2013-03”) associated with an image capture device (e.g., the Apple-branded head mounted computer that connects to a user's phone device) configured to capture the at least one image (e.g., a person waiting for a subway train at the Judiciary Square metro stop in Washington, D.C.), wherein the at least one image includes at least one representation of a feature (e.g., a head) of at least one unrecognized (e.g., the user's face has facial recognition techniques applied to it by the image capture device, and after identification, the person identified is not in the user's contact list) entity that was not recognized (e.g., not able to be identified, or, in an embodiment, able to be identified but not found as having a relationship with the owner of the image capture device) by the image capture device (e.g., the Apple-branded head mounted computer that connects to a user's phone device).

Referring now to FIG. 17D, operation 1602 may include operation 1722 depicting acquiring a block of encrypted data that corresponds to an image that has been encrypted through use of the unique device code associated with the image capture device configured to capture the at least one image, wherein the block of encrypted data includes unencrypted metadata. For example, FIG. 13, e.g., FIG. 13C, shows encrypted image that includes unencrypted metadata and at least one representation of a feature of an entity and that has been encrypted through use of a unique device code associated with an image capture device configured to perform image capture obtaining module 1322 acquiring a block of encrypted data that corresponds to an image that has been encrypted through use of the unique device code (e.g., a sixteen digit code) associated with the image capture device (e.g., an imaginary Microsoft product, e.g., “Kinect Vision”) configured to capture the at least one image (e.g., a picture of three people on a subway train), wherein the block of encrypted data includes unencrypted metadata (e.g., metadata including the privacy metadata, which may include an identification number of the beacon).

Referring again to FIG. 17D, operation 1722 may include operation 1724 depicting acquiring the block of encrypted data that corresponds to the image that has been encrypted through use of a unique device code associated with the image capture device configured to capture the at least one image, wherein the block of encrypted data includes unencrypted metadata that identifies the at least one entity. For example, FIG. 13, e.g., FIG. 13C, shows encrypted image that includes unencrypted entity name metadata and at least one representation of a feature of an entity and that has been encrypted through use of a unique device code associated with an image capture device configured to perform image capture obtaining module 1324 acquiring the block of encrypted data that corresponds to the image (e.g., an image of five friends at a karaoke bar) that has been encrypted through use of a unique device code (e.g., a password for logging into the device, that is set by the user and determined to be unique to that device, that is used as a seed for the encryption key) associated with the image capture device (e.g., a Digilens DL40 optical head-mounted wearable computer) configured to capture the at least one image (e.g., the image of five friends at a karaoke bar), wherein the block of encrypted data includes unencrypted metadata (e.g., data that is appended to the encrypted image, or that is left alone by the encryption algorithm) that identifies the at least one entity (e.g., one of the persons among the five friends at the karaoke bar).

Referring again to FIG. 17D, operation 1722 may include operation 1726 depicting acquiring the block of encrypted data that corresponds to the image that has been encrypted through use of the unique device code associated with the image capture device configured to capture the at least one image, wherein the block of encrypted data includes unencrypted metadata that identifies the image capture device. For example, FIG. 13, e.g., FIG. 13C, shows encrypted image that includes unencrypted image capture device identifier metadata and at least one representation of a feature of an entity and that has been encrypted through use of a unique device code associated with an image capture device configured to perform image capture obtaining module 1326 acquiring the block of encrypted data that corresponds to the image (e.g., a covert image of a businessman working on documents in an airport lounge) that has been encrypted through use of the unique device code (e.g., a code set to the device at manufacture-time that is a unique encryption key) associated with the image capture device (e.g., a Samsung optical head-mounted wearable computer) configured to capture the at least one image (e.g., the covert image of a businessman working on documents in an airport lounge), wherein the block of encrypted data includes unencrypted metadata (e.g., data that is added to the encrypted image after encryption, or that is prevented from being included) that identifies the image capture device (e.g., provides a unique identifier of the Samsung optical head-mounted wearable computer).

Referring again to FIG. 17D, operation 1722 may include operation 1728 depicting acquiring the block of encrypted data that corresponds to the at least one image that has been encrypted through use of the unique device code associated with the image capture device configured to capture the at least one image, wherein the block of encrypted data includes unencrypted metadata regarding one or more properties of the encrypted image. For example, FIG. 13, e.g., FIG. 13C, shows encrypted image that includes unencrypted image property metadata and at least one representation of a feature of an entity and that has been encrypted through use of a unique device code associated with an image capture device configured to perform image capture obtaining module 1328 acquiring the block of encrypted data that corresponds to the image (e.g., an image of a person drinking a coffee and writing a novel at a coffee shop) that has been encrypted through use of the unique device code (e.g., a unique number associated with the device that is used to generate the encryption key, e.g., a MAC address of the device) associated with the image capture device (e.g., a Telescouter head-mounted wearable computer) configured to capture the at least one image (e.g., the image of the person drinking a coffee and writing a novel at a coffee shop), wherein the block of encrypted data includes unencrypted metadata (e.g., data that was excluded from encryption) regarding one or more properties of the encrypted image (e.g., a list of the names and/or identifying character strings (e.g., social security numbers, or aliases on an online service) of people identified in the image using facial recognition, for example).

Referring again to FIG. 17D, operation 1728 may include operation 1730 depicting acquiring the block of encrypted data that corresponds to the image that has been encrypted through use of the unique device code associated with the image capture device configured to capture the at least one image, wherein the block of encrypted data includes unencrypted metadata regarding one or more of a location, a timestamp, a size, a resolution, a compression, an exposure time, a capturing device orientation, an aperture value, and a color space of the encrypted image. For example, FIG. 13, e.g., FIG. 13C, shows encrypted image that includes unencrypted image particular characteristic metadata and at least one representation of a feature of an entity and that has been encrypted through use of a unique device code associated with an image capture device configured to perform image capture obtaining module 1330 acquiring the block of encrypted data that corresponds to the image (e.g., a surreptitious image of two people at a Broadway play) that has been encrypted through use of the unique device code (e.g., a code corresponding to the device) associated with the image capture device (e.g., a Fujitsu Laser EyeWear head-mounted wearable computer) configured to capture the at least one image (e.g., the surreptitious image of two people at a Broadway play), wherein the block of encrypted data includes unencrypted metadata regarding one or more of a location, a timestamp, a size, a resolution, a compression, an exposure time, a capturing device orientation, an aperture value, and a color space of the encrypted image.

FIGS. 18A-18C depict various implementations of operation 1604, depicting obtaining a privacy metadata that corresponds to a detection of a privacy beacon in the at least one image, said at least one image captured by the image capture device, said privacy beacon associated with the at least one entity, according to embodiments. Referring now to FIG. 18A, operation 1604 may include operation 1802 depicting obtaining a privacy metadata that indicates whether the privacy beacon was detected in the at least one image captured by the image capture device, said privacy beacon associated with the at least one entity. For example, FIG. 14, e.g., FIG. 14A, shows beacon metadata related to a presence, in the encrypted image that is captured by a component under control of the image capture device, of a privacy beacon that is associated with the at least one entity acquiring module 1402 obtaining a privacy metadata (e.g., data about the detection of the privacy beacon) that indicates whether the privacy beacon (e.g., one or more of a marker that reflects light in a visible spectrum, a marker that reflects light in a nonvisible spectrum, a marker that emits light in a visible spectrum, a marker that emits light in a nonvisible spectrum, a marker that emits a radio wave, a marker that, when a particular type of electromagnetic wave hits it, emits a particular electromagnetic wave, an RFID tag, a marker that uses near-field communication, a marker that is in the form of a bar code, a marker that is in the form of a bar code and painted on a user's head and that reflects light in a nonvisible spectrum, a marker that uses high frequency low penetration radio waves (e.g., 60 GHz radio waves), a marker that emits a particular thermal signature, a marker that is worn underneath clothing and is detectable by an x-ray-type detector, a marker that creates a magnetic field, a marker that emits a sonic wave, a marker that emits a sonic wave at a frequency that cannot be heard by humans, a marker that is tattooed to a person's bicep and is detectable through clothing, a marker that is a part of a user's cellular telephone device, a marker that is broadcast by a part of a user's cellular telephone device, a marker that is broadcast by a keychain carried by a person, a marker mounted on a drone that maintains a particular proximity to the person, a marker mounted in eyeglasses, and a marker mounted in a hat, a marker mounted in an article of clothing, the shape of the person's face is registered as the beacon) was detected in the at least one image (e.g., an image of two people eating at a restaurant) captured by the image capture device (e.g., an Oculon Optoelectronics head-mounted wearable computer), said privacy beacon associated with the at least one entity (e.g., one of the people eating at the restaurant).

Referring again to FIG. 18A, operation 1802 may include operation 1804 depicting obtaining the privacy metadata, wherein said privacy metadata includes an identification number of the privacy beacon that was detected in the at least one image captured by the image capture device, and wherein said privacy beacon is associated with the at least one entity. For example, FIG. 14, e.g., FIG. 14A, shows beacon metadata that includes an identification number of the privacy beacon detected in the encrypted image that is captured by a component under control of the image capture device acquiring module 1404 obtaining the privacy metadata (e.g., data regarding the privacy beacon), wherein said privacy metadata includes an identification number (e.g., a nonunique identification number indicating a “class” of person that is associated with the privacy beacon, e.g., “actor,” “movie star,” “C.E.O.,” or indicating a class of potential damages associated with that person's image (e.g., “<100,000 damages;” “100,000-500,000 damages;” “>500,000 damages”) of the privacy beacon (e.g., a marker that reflects light in a visible spectrum) that was detected in the at least one image (e.g., an image of a person running a red light on a bicycle) captured by the image capture device (e.g., a vehicle-mounted video camera), and wherein said privacy beacon (e.g., the marker that reflects light in a visible spectrum) is associated with the at least one entity (e.g., the person on the bicycle).

Referring again to FIG. 18A, operation 1804 may include operation 1806 depicting obtaining the privacy metadata that includes a unique identification number of the privacy beacon that was obtained from the detection of the privacy beacon in the at least one image captured by the image capture device, wherein said privacy beacon is associated with the at least one entity. For example, FIG. 14, e.g., FIG. 14A, shows beacon metadata that includes a unique identification number of the privacy beacon detected in the encrypted image that is captured by a component under control of the image capture device acquiring module 1406 obtaining the privacy metadata that includes a unique identification number of the privacy beacon (e.g., a marker that emits light in a nonvisible spectrum) that was obtained from the detection of the privacy beacon (e.g., the marker that emits light in a nonvisible spectrum) in the at least one image (e.g., an image of a person sitting on a park bench) captured by the image capture device (e.g., a camera mounted in an automated teller machine), said privacy beacon (e.g., the marker that emits light in an nonvisible spectrum) associated with the at least one entity (e.g., the person sitting on the park bench).

Referring again to FIG. 18A, operation 1806 may include operation 1808 depicting obtaining the privacy metadata that includes the identification number that was read from a privacy beacon that is embedded in the entity and that emits light in a nonvisible spectrum that was obtained from an optical detection of the privacy beacon in the at least one image captured by the image capture device, said privacy beacon associated with the at least one entity. For example, FIG. 14, e.g., FIG. 14A, shows beacon metadata that includes a unique identification number of the privacy beacon embedded in the entity and that emits light detected in the encrypted image that is captured by a component under control of the image capture device acquiring module 1408 obtaining the privacy metadata that includes the identification number that was read from a privacy beacon that is embedded in the entity (e.g., in the skin, or in an article of clothing or a device carried by the entity) and that emits light in a nonvisible spectrum that was obtained from an optical detection of the privacy beacon in the at least one image (e.g., an image of people at a baseball game) captured by the image capture device (e.g., a satellite that takes a super-high resolution picture of everyone at the game), said privacy beacon associated with the at least one entity (e.g., a person at the baseball game that has a privacy beacon).

Referring again to FIG. 18A, operation 1806 may include operation 1810 depicting obtaining the privacy metadata that includes the identification number that was obtained based on a wavelength of light emitted from a privacy beacon that is mounted to a drone and that emits light in a nonvisible spectrum that was obtained from an optical detection of the privacy beacon in the at least one image captured by the image capture device, said privacy beacon associated with the at least one entity. For example, FIG. 14, e.g., FIG. 14A, shows beacon metadata that includes a unique identification number of the privacy beacon that emits nonvisible light and that has been detected in the encrypted image that is captured by a component under control of the image capture device acquiring module 1410 obtaining the privacy metadata that includes the identification number that was obtained based on a wavelength of light emitted from a privacy beacon that is mounted to a drone and that emits light in a nonvisible spectrum that was obtained from an optical detection of the privacy beacon in the at least one image (e.g., a candid image taken in public) captured by the image capture device (e.g., a Google Glass optical head-mounted wearable computer), said privacy beacon associated with the at least one entity (e.g., the person whose image is taken in public).

Referring now to FIG. 18B, operation 1604 may include operation 1812 depicting receiving the privacy metadata that corresponds to the detection of the privacy beacon in the image captured by the image capture device, said privacy beacon associated with the at least one entity. For example, FIG. 14, e.g., FIG. 14B, shows beacon metadata related to a presence, in the encrypted image that is captured by the image capture device, of a privacy beacon that is associated with the at least one entity receiving module 1412 receiving the privacy metadata (e.g., data that includes a terms of service associated with the privacy beacon that was downloaded by the device at the time the beacon was detected) that corresponds to the detection of the privacy beacon (e.g., a marker that is worn underneath clothing and is detectable by an x-ray-type detector) in the image (e.g., an image of a person eating at a restaurant) captured by the image capture device (e.g., the Apple-branded wearable computer), said privacy beacon associated with at least one entity (e.g., the person eating at the restaurant).

Referring again to FIG. 18B, operation 1604 may include operation 1814 depicting obtaining the privacy metadata that corresponds to the detection of the privacy beacon in the at least one image captured by the image capture device, wherein the privacy beacon is carried by the entity or on the entity. For example, FIG. 14, e.g., FIG. 14B, shows beacon metadata related to a presence, in the encrypted image that is captured by the image capture device, of a privacy beacon that is carried on or by the at least one entity acquiring module 1414 obtaining the privacy metadata that corresponds to the detection of the privacy beacon (e.g., a marker that is a part of a user's cellular telephone device) in the at least one image (e.g., a picture of a man sitting at a bar) captured by the image capture device (e.g., an EyeTap head-mounted wearable computer), wherein the privacy beacon is carried by the entity or on the entity (e.g., the privacy beacon is part of the cellular telephone device carried by the user).

Referring again to FIG. 18B, operation 1604 may include operation 1816 depicting obtaining the privacy metadata that corresponds to the detection of the privacy beacon in the at least one image captured by the image capture device, wherein the privacy beacon is part of a device that operates under control of the entity. For example, FIG. 14, e.g., FIG. 14B, shows beacon metadata related to a presence, in the encrypted image that is captured by the image capture device, of a privacy beacon that is associated with a device under control of the at least one entity acquiring module 1416 obtaining the privacy metadata that corresponds to the detection of the privacy beacon (e.g., a marker that is broadcast by a keychain carried by a person) in the at least one image (e.g., a team picture of an intramural basketball game) captured by the image capture device (e.g., a Microsoft-branded optical headgear with wearable computer, e.g., a “Kinect Vision” (not a real product), wherein the privacy beacon is part of a device (e.g., a tablet device carried by the user) that operates under control of the entity (e.g., the person controls the operation of the tablet device).

Referring again to FIG. 18B, operation 1816 may include operation 1818 depicting obtaining the privacy metadata that corresponds to the detection of the privacy beacon in the at least one image captured by the image capture device, wherein the privacy beacon is part of a smartphone device that is owned by the entity. For example, FIG. 14, e.g., FIG. 14B, shows beacon metadata related to a presence, in the encrypted image that is captured by the image capture device, of a privacy beacon that is associated with a tablet device under control of the at least one entity acquiring module 1418 obtaining the privacy metadata that corresponds to the detection of the privacy beacon (e.g., a marker that uses near-field communication) in the at least one image (e.g., a surreptitious picture of a high school football team practicing) captured by the image capture device (e.g., a Google Glass wearable computer that is worn by a person in the stands of the area where the team is practicing), wherein the privacy beacon (e.g., the marker that uses near-field communication) is part of (e.g., the smartphone device facilitates the presentation of) a smartphone device (e.g., a smartphone device running Google's operating system, e.g., Android) that is owned by the entity (e.g., a coach of the high school football team that is in the picture).

Referring again to FIG. 18B, operation 1816 may include operation 1820 depicting obtaining the privacy metadata that corresponds to the detection of the privacy beacon in the at least one image captured by the image capture device, wherein appearance of the privacy beacon is controlled by the device that operates under control of the entity. For example, FIG. 14, e.g., FIG. 14B, shows beacon metadata related to a presence, in the encrypted image that is captured by the image capture device, of a privacy beacon for which an appearance is controlled by the device under control of the at least one entity acquiring module 1420 obtaining the privacy metadata that corresponds to the detection of the privacy beacon (e.g., a marker that emits a radio wave) in the at least one image (e.g., a discreet picture of a couple holding hands at a winery) captured by the image capture device (e.g., a LifeLog device), wherein appearance of the privacy beacon is controlled by the device (e.g., a smart watch worn by the entity) that operates under control of the entity (e.g., the person holding hands at the winery).

Referring now to FIG. 18C, operation 1604 may include operation 1822 depicting obtaining the privacy metadata that corresponds to the detection of the privacy beacon in the at least one image captured by the image capture device, said privacy beacon configured to emit a signal usable to identify the entity. For example, FIG. 14, e.g., FIG. 14C, shows beacon metadata related to a presence, in the encrypted image that is captured by the image capture device, of a privacy beacon that is associated with the at least one entity and that is configured to emit an identification signal acquiring module 1422 obtaining the privacy metadata that corresponds to the detection of the privacy beacon (e.g., a marker that emits light in a visible spectrum) in the at least one image (e.g., a discreet picture of a person at the movie theater) captured by the image capture device (e.g., a wearable computer mounted on the head of another person sitting in the movie theater), said privacy beacon (e.g., the marker that emits light in a visible spectrum) configured to emit a signal (e.g., a particular wavelength of light, or a particular pattern in the emission of light) usable to identify the entity (e.g., either specifically (e.g., person Bob Jones) or generally (e.g., “a person with a $100,000 potential damages clause for improper use of the person's image).

Referring again to FIG. 18C, operation 1604 may include operation 1824 depicting obtaining the privacy metadata that corresponds to the detection of the privacy beacon in the at least one image captured by the image capture device, said privacy beacon configured to be detectable by the image capture device. For example, FIG. 14, e.g., FIG. 14C, shows beacon metadata related to a presence, in the encrypted image that is captured by the image capture device, of a privacy beacon that is associated with the at least one entity and that is configured to be detectable by one or more devices acquiring module 1424 obtaining the privacy metadata that corresponds to the detection of the privacy beacon (e.g., a marker that reflects light in a visible spectrum) in the at least one image (e.g., a picture of two high-schoolers going to a prom) captured by the image capture device (e.g., a DSLR camera), said privacy beacon configured to be detectable by the image capture device (e.g., the privacy beacon is such that the image capture device is capable of detecting the privacy beacon, e.g., through its image sensor).

Referring again to FIG. 18C, operation 1604 may include operation 1826 depicting obtaining the privacy metadata that corresponds to the detection of the privacy beacon in the at least one image captured by the image capture device, wherein the privacy beacon is placed by the entity. For example, FIG. 14, e.g., FIG. 14C, shows beacon metadata related to a presence, in the encrypted image that is captured by the image capture device, of a privacy beacon that is placed by the entity and that is associated with the at least one entity acquiring module 1426 obtaining the privacy metadata that corresponds to the detection of the privacy beacon (e.g., a marker that is in the form of a bar code) in the at least one image (e.g., a candid picture of two students in the classroom) captured by the image capture device (e.g., a student monitoring system set up in the classroom), wherein the privacy beacon (e.g., the marker that is in the form of a bar code and attached to the clothing) is placed (e.g., attached to clothing) by the entity (e.g., the student).

Referring again to FIG. 18C, operation 1604 may include operation 1828 depicting obtaining the privacy metadata that corresponds to the detection of an optically-detectable privacy beacon in the at least one image captured by the image capture device, said privacy beacon associated with the at least one entity. For example, FIG. 14, e.g., FIG. 14C, shows beacon metadata related to a presence, in the encrypted image that is captured by the image capture device, of a privacy beacon that is configured to be detectable through use of an optical component and that is associated with the at least one entity acquiring module 1428 obtaining the privacy metadata that corresponds to the detection of an optically (e.g., detectable by an optical sensor, regardless of whether the signal is visible to the human eye) detectable privacy beacon (e.g., a marker that emits light in a visible spectrum) in the at least one image (e.g., an image of a telemarketing office worker in her cubicle) captured by the image capture device (e.g., the webcamera of her computer that is owned by the company and turned on to monitor her work), said privacy beacon (e.g., the marker that emits light in a visible spectrum) associated with the at least one entity (e.g., the telemarketing worker).

Referring again to FIG. 18C, operation 1604 may include operation 1830 depicting obtaining the privacy metadata that corresponds to the detection of a passive privacy beacon in the at least one image captured by the image capture device, said privacy beacon associated with the at least one entity. For example, FIG. 14, e.g., FIG. 14C, shows beacon metadata related to a presence, in the encrypted image that is captured by the image capture device, of a passive privacy beacon that is associated with the at least one entity acquiring module 1430 obtaining the privacy metadata (e.g., a marker that reflects light in an invisible spectrum) that corresponds to the detection of a passive privacy beacon (e.g., a privacy beacon that is not required to take affirmative action, e.g., a light reflecting beacon) in the at least one image (e.g., an image of two friends at a football game) captured by the image capture device (e.g., the camera of a tablet device), said privacy beacon associated with the at least one entity (e.g., the person at the football game).

Referring now to FIG. 18D, operation 1604 may include operation 1832 depicting obtaining a privacy metadata that corresponds to a result of analysis of the at least one image to detect the privacy beacon, said privacy beacon associated with the at least one entity. For example, FIG. 14, e.g., FIG. 14D shows beacon metadata related to a presence, in the encrypted image that is captured by the image capture device, of a privacy beacon that is detected through analysis of image data and that is associated with the at least one entity acquiring module 1432 obtaining a privacy metadata that corresponds to a result of analysis (e.g., image processing, e.g., pattern recognition, whether performed digitally or optically) of the at least one image (e.g., a picture of a guy eating a hamburger) to detect the privacy beacon (e.g., a marker that is in the form of a bar code and painted on a user's head and that reflects light in a visible spectrum), said privacy beacon associated with the at least one entity (e.g., the guy eating the hamburger).

Referring again to FIG. 18D, operation 1604 may include operation 1834 depicting obtaining a binary privacy metadata that corresponds to whether the privacy beacon was detected in the at least one image captured by the image capture device, said privacy beacon associated with the at least one entity. For example, FIG. 14, e.g., FIG. 14D, shows beacon metadata in binary format that is related to a presence, in the encrypted image that is captured by the image capture device, of a privacy beacon that is associated with the at least one entity acquiring module 1434 obtaining a binary (e.g., 0 or 1, e.g., “YES” or “NO”) privacy metadata that corresponds to (e.g., a yes or no answer) to whether the privacy beacon was detected in the at least one image (e.g., a picture taken of friends at a bar doing shots) captured by the image capture device (e.g., a Google-branded wearable computer, e.g., Google Glass), said privacy beacon associated with the at least one entity (e.g., one of the people at the bar).

Referring again to FIG. 18D, operation 1604 may include operation 1836 depicting obtaining a privacy metadata that includes an alphanumeric string, wherein the privacy metadata corresponds to the detection of the privacy beacon in the at least one image captured by the image capture device, said privacy beacon associated with the at least one entity. For example, FIG. 14, e.g., FIG. 14D, shows alphanumeric string beacon metadata related to a presence, in the encrypted image that is captured by the image capture device, of a privacy beacon that is associated with the at least one entity acquiring module 1436 obtaining a privacy metadata that includes an alphanumeric string (e.g., “user2345606”), wherein the privacy metadata corresponds to the detection of the privacy beacon (e.g., a marker that is tattooed to a person's bicep and is detectable through clothing) in the at least one image (e.g., an image of a person drag racing his car) captured by the image capture device (e.g., a wearable computer with an image sensor worn by a person), said privacy beacon associated with the at least one entity (e.g., the person drag racing his car).

Referring again to FIG. 18D, operation 1836 may include operation 1838 depicting obtaining the privacy metadata that includes an alphanumeric string that identifies the entity, said privacy metadata corresponding to the detection of the privacy beacon in the at least one image captured by the image capture device, said privacy beacon associated with the at least one entity. For example, FIG. 14, e.g., FIG. 14D, shows alphanumeric identification string beacon metadata related to a presence, in the encrypted image that is captured by the image capture device, of a privacy beacon that is associated with the at least one entity acquiring module 1438 obtaining the privacy metadata that includes an alphanumeric string (e.g., “Jules_Caesar_{—}12”) that identifies the entity (e.g., the person named Jules Caesar), said privacy metadata corresponding to the detection of the privacy beacon (e.g., a marker that is broadcast by a keychain carried by a person) in the at least one image (e.g., Jules Caesar riding a roller coaster) captured by the image capture device (e.g., a head-mounted wearable computer), said privacy beacon (e.g., the marker that is broadcast by a keychain carried by a person) associated with the at least one entity (e.g., Jules Caesar).

Referring again to FIG. 18D, operation 1836 may include operation 1840 depicting obtaining the privacy metadata that includes an alphanumeric string configured to be used to retrieve an identity of the entity, said privacy metadata corresponding to the detection of the privacy beacon in the at least one image captured by the image capture device, said privacy beacon associated with the at least one entity. For example, FIG. 14, e.g., FIG. 14D, shows alphanumeric string beacon metadata that is configured to be used for a retrieval of entity identity data and that is related to a presence, in the encrypted image that is captured by the image capture device, of a privacy beacon that is associated with the at least one entity acquiring module 1440 obtaining the privacy metadata that includes an alphanumeric string (e.g., lookup code “A12Gh35ee”) configured to be used to retrieve (e.g., from a database) an identity (e.g., a name, and/or information about) of the entity (e.g., the pet owned by the person whose picture was taken, e.g., Jules Caesar), said privacy metadata corresponding to the detection (e.g., the detection of the privacy beacon yields the alphanumeric string, either directly or with the aid of computation) of the privacy beacon (e.g., a marker that is in the form of a bar code) in the at least one image (e.g., a picture of Jules Caesar standing in a park, walking his dog) captured by the image capture device (e.g., a Laser EyeWear device that is a wearable computer), said privacy beacon (e.g., the marker that is in the form of a bar code) associated with the at least one entity (e.g., the dog, e.g., the dog may be famous, and may be the entity, e.g., the entity does not have to be human or even living).

Referring now to FIG. 18E, operation 1836 may include operation 1842 depicting obtaining a privacy metadata that includes an alphanumeric string configured to be used to retrieve data associated with the entity, wherein the privacy metadata corresponds to the detection of the privacy beacon in the at least one image captured by the image capture device, said privacy beacon associated with the at least one entity. For example, FIG. 14, e.g., FIG. 14D, shows alphanumeric string beacon metadata that is configured to be used for a retrieval of entity associated data and that is related to a presence, in the encrypted image that is captured by the image capture device, of a privacy beacon that is associated with the at least one entity acquiring module 1442 obtaining the privacy metadata that includes an alphanumeric string configured to be used to retrieve data associated (e.g., a terms of service associated with) the entity (e.g., a person gambling in a Las Vegas casino), wherein the privacy metadata corresponds to the detection of the privacy beacon (e.g., a marker that, when a particular type of electromagnetic wave hits it, emits a particular electromagnetic wave) in the at least one image (e.g., an image of the person playing blackjack at the Bellagio casino) captured by the image capture device (e.g., a wearable computer, e.g., Google Glass, worn by a blackjack dealer), said privacy beacon associated with the at least one entity (e.g., the person playing blackjack).

Referring again to FIG. 18E, operation 1842 may include operation 1844 depicting obtaining a privacy metadata that includes an alphanumeric string configured to be used to retrieve at least one service term associated with use of the at least one image that contain the at least one representation of the feature of the entity, said privacy metadata corresponding to the detection of the privacy beacon in the at least one image captured by the image capture device, said privacy beacon associated with the at least one entity. For example, FIG. 14, e.g., FIG. 14D, shows alphanumeric string beacon metadata that is configured to be used for a retrieval of an entity associated service term data and that is related to a presence, in the encrypted image that is captured by the image capture device, of a privacy beacon that is associated with the at least one entity acquiring module 1444 obtaining a privacy metadata that includes an alphanumeric string configured to be used to retrieve at least one service term (e.g., “unauthorized use of this person's image will result in liquidated damages of $2,000,000”) associated with use (e.g., distribution, manipulation, sale, circulation, and the like) of the at least one image (e.g., a picture of a drunk celebrity) that contain at least one representation of the feature (e.g., the face) of the entity (e.g., the drunk celebrity), said privacy metadata corresponding to the detection of the privacy beacon (e.g., a marker that creates a magnetic field) in the at least one image (e.g., the picture of the drunk celebrity) captured by the image capture device (e.g., a set of eyeglasses for which a camera has been wired into the frame), said privacy beacon (e.g., the marker that creates a magnetic field) associated with the at least one entity (e.g., the celebrity).

Referring now to FIG. 18F, operation 1604 may include operation 1846 depicting obtaining a privacy metadata that includes data regarding the entity, said privacy metadata corresponding to the detection of the privacy beacon in the at least one image captured by the image capture device, said privacy beacon associated with the at least one entity. For example, FIG. 14, e.g., FIG. 14E, shows privacy beacon that includes data regarding the entity and that is associated with the at least one entity within the obtained image detecting module that avoids further image process operation on obtained image data prior to encryption of the obtained image data 1446 obtaining a privacy metadata that includes data regarding the entity (e.g., identity data, type data, terms of service data, and the like), said privacy metadata corresponding to the detection of the privacy beacon (e.g., a marker that uses near-field communication) in the at least one image (e.g., an image of five people smoking cigars on a balcony) captured by the image capture device (e.g., a wearable computer, e.g., “Samsung Spectacles”), said privacy beacon (e.g., the marker that uses near-field communication) associated with the at least one entity (e.g., one of the people smoking the cigar).

Referring again to FIG. 18F, operation 1846 may include operation 1848 depicting obtaining a privacy metadata that includes data regarding at least one service term associated with use of the at least one image that contains the at least one representation of the feature of the entity, said privacy metadata corresponding to the detection of the privacy beacon in the at least one image captured by the image capture device, said privacy beacon associated with the at least one entity. For example, FIG. 14, e.g., FIG. 14E, shows privacy beacon that includes service term data associated with the entity and that is associated with the at least one entity within the obtained image detecting module that avoids further image process operation on obtained image data prior to encryption of the obtained image data 1448 obtaining a privacy metadata that includes data regarding at least one service term (e.g., “sale of a picture containing the face and/or likeness of Jules Caesar without Jules Caesar's explicit permission will result in a 50,000 dollar fine”) associated with use (e.g., sale, distribution, decryption, modification, etc.) of the at least one image (e.g., a picture of Jules Caesar decapitating an enemy in public) that contains the at least one representation of the feature of the entity (e.g., the face of Jules Caesar), said privacy metadata corresponding to the detection of the privacy beacon (e.g., a marker embedded in a necklace) in the at least one image (e.g., the picture of Jules Caesar decapitating an enemy in public) captured by the image capture device (e.g., the wearable computer), said privacy beacon associated with the at least one entity (e.g., Jules Caesar).

FIGS. 19A-19J depict various implementations of operation 1606 depicting determining, at least partly based on the obtained privacy metadata, and at least partly based on a calculation related to the block of encrypted data that corresponds to the at least one image, whether to allow one or more processes related to the encrypted data block, according to embodiments. Referring now to FIG. 19A, operation 1606 may include operation 1902 depicting determining, at least partly based on the obtained privacy metadata, and partly based on a calculation related to the representation of the feature of the at least one entity for which the privacy beacon is associated, whether to allow decryption of the encrypted data block. For example, FIG. 15, e.g., FIG. 15A, shows determination with regard to allowance of decryption of the encrypted image that is at least partly based on the acquired beacon data and at least partly based on a calculation that involves the encrypted image performing module 1502 determining, at least partly based on the obtained privacy metadata (e.g., data identifying the privacy beacon as a beacon associated with a user that is a movie star), and partly based on a calculation (e.g., that the image will be worth $5,000) related to the representation of the feature (e.g., the face) of the at least one entity (e.g., the movie star) for which the privacy beacon (e.g., a marker that uses near-field communication) is associated, whether to allow (e.g., whether to transmit to a location capable of decryption) decryption of the encrypted data block (e.g., the encrypted data containing the image of the movie star).

Referring again to FIG. 19A, operation 1606 may include operation 1904 depicting determining, at least partly based on the obtained privacy metadata, and partly based on the calculation related to the block of encrypted data that corresponds to the at least one image, whether to allow transmission of the at least one image to the image capture device. For example, FIG. 15, e.g., FIG. 15A, shows determination with regard to allowance of transmission of the encrypted image that is at least partly based on the acquired beacon data and at least partly based on a calculation that involves the encrypted image performing module 1504 determining, at least partly based on the obtained privacy metadata (e.g., data indicating that the beacon was detected, and also based on image analysis, an identity of the entity associated with the privacy beacon was made, identified as Jules Caesar, and terms of service for use of Jules Caesar's picture were obtained) and partly based on the calculation (e.g., the picture of Jules Caesar is worth $15,000) related to the block of encrypted data (e.g., analysis on the block of encrypted data identified the entity as Jules Caesar) that corresponds to the at least one image (e.g., an image containing the face of Jules Caesar), whether to allow transmission of the at least one image (e.g., the image of Jules Caesar) to the image capture device (e.g., a Google Glass wearable computer that originally captured and encrypted the image of Jules Caesar).

Referring again to FIG. 19A, operation 1606 may include operation 1906 depicting determining, at least partly based on the obtained privacy metadata, and partly based on a calculation related to the block of encrypted data that corresponds to the at least one image, whether to allow distribution of the at least one image to a network. For example, FIG. 15, e.g., FIG. 15A, shows determination with regard to allowance of distribution of the encrypted image that is at least partly based on the acquired beacon data and at least partly based on a calculation that involves the encrypted image performing module 1506 determining, at least partly based on the obtained privacy metadata (e.g., based on term data that was readable from the privacy beacon and included in the privacy metadata, and that indicates that unauthorized sale of the image of the person will result in $500,000 damages) and partly based on a calculation related to the block of encrypted data (e.g., the block of data including the image of the person) that corresponds to the at least one image (e.g., an image of the person urinating in public), whether to allow distribution of the at least one image (e.g., the image of the person urinating in public) to a network (e.g., a picture sharing network, e.g., Google's Picasa).

Referring again to FIG. 19A, operation 1606 may include operation 1908 depicting determining, at least partly based on the obtained privacy metadata, and partly based on a calculation related to the block of encrypted data that corresponds to the at least one image, whether to allow manipulation of the at least one image. For example, FIG. 15, e.g., FIG. 15A, shows determination with regard to allowance of manipulation of the encrypted image that is at least partly based on the acquired beacon data and at least partly based on a calculation that related to a feature of the encrypted image performing module 1508 determining, at least partly based on the obtained privacy metadata (e.g., the privacy metadata included a beacon identification number, which was transmitted to a server to obtain a terms of service that indicated that unauthorized posting of surreptitious pictures of a user would result in a $25,000 per incident fine), and partly based on a calculation related to the block of encrypted data (e.g., based on the quality of the picture and the persons involved, posting the picture to a social networking site would generate an additional $12,000 in ad revenue) that corresponds to the at least one image (e.g., a modern “Rat Pack” picture of four male celebrities), whether to allow manipulation (e.g., adding “the sands” casino in the background of the picture) of the at least one image.

Referring now to FIG. 19B, operation 1606 may include operation 1910 depicting determining, at least partly based on the obtained privacy metadata, and partly based on a value calculation related to the block of encrypted data that corresponds to the at least one image, whether to allow one or more processes related to the encrypted data block. For example, FIG. 15, e.g., FIG. 15B, shows determination with regard to allowance of manipulation of the encrypted image that is at least partly based on the acquired beacon data and at least partly based on a valuation calculation that involves the encrypted image performing module 1510 determining, at least partly based on the obtained privacy metadata (e.g., metadata that allows the system to retrieve a terms of service data indicating that release of a covertly-taken picture of the entity will result in a $5 ticket), and partly based on a value calculation related to the block of encrypted data that corresponds to the at least one image (e.g., the value calculation indicates that the picture could be sold for $4,500), whether to allow one or more processes (e.g., e-mailing the picture to people) related to the encrypted data block (e.g. the image).

Referring again to FIG. 19B, operation 1910 may include operation 1912 depicting determining, at least partly based on the obtained privacy metadata, and partly based on a valuation of the image of the representation of the feature of the at least one entity contained in the block of encrypted data, whether to allow one or more processes related to the encrypted data block. For example, FIG. 15, e.g., FIG. 15B, shows determination with regard to allowance of manipulation of the encrypted image that is at least partly based on the acquired beacon data and at least partly based on a valuation of the representation of the feature of the at least one entity in the encrypted image performing module 1512 determining, at least partly based on the obtained privacy metadata (e.g., an identification string that is used to retrieve an identity of the entity in the image, and then the identity is used to retrieve a terms of service from that entity's web site, and the terms of service specify $5,000 dollars of liquidated damages for publication of the image), and partly based on a valuation of an image of the representation of the feature of the at least one entity (e.g., the picture of the celebrity eating a fast food hamburger) contained in the block of encrypted data that corresponds to the at least one image (e.g., the image of the celebrity eating the fast food hamburger), whether to allow one or more processes (e.g., decryption) related to the encrypted data block.

Referring again to FIG. 19B, operation 1912 may include operation 1914 depicting determining, at least partly based on the obtained privacy metadata, and partly based on a valuation of an amount of traffic that may be delivered to a website that featured the image of the representation of the feature of the at least one entity contained in the block of encrypted data, whether to allow one or more processes related to the encrypted data block. For example, FIG. 15, e.g., FIG. 15B, shows determination with regard to allowance of manipulation of the encrypted image that is at least partly based on the acquired beacon data and at least partly based on a valuation of an amount of internet traffic that may be driven by the representation of the feature of the at least one entity in the encrypted image performing module 1514 determining, at least partly based on the obtained privacy metadata (e.g., data that identifies the privacy beacon and allows a retrieval of a terms of service), and partly based on a valuation of an amount of traffic (e.g., website hits) that may be delivered to a website that featured the image of the representation of the feature of the at least one entity in the block of encrypted data, whether to allow one or more processes (e.g., posting to a social networking site) related to the encrypted data block.

Referring again to FIG. 19B, operation 1912 may include operation 1916 depicting determining, at least partly based on the obtained privacy metadata, and partly based on a valuation of a potential sale of an image of the representation of the feature of the at least one entity contained in the block of encrypted data, whether to allow one or more processes related to the encrypted data block. For example, FIG. 15, e.g., FIG. 15B, shows determination with regard to allowance of manipulation of the encrypted image that is at least partly based on the acquired beacon data and at least partly based on a valuation of a sale of an unencrypted version of the encrypted image that contains the representation of the feature of the at least one entity performing module 1516 determining, at least partly based on the obtained privacy metadata (e.g., a terms of service that specifies one million dollars in damages for unauthorized use of the image of a popular CEO), and partly based on a valuation of a potential sale of an image of the representation of the feature of the at least one entity (e.g., a CEO of a company using a rival company's product) contained in the block of encrypted data, whether to allow one or more processes (e.g., copying to a portable drive) related to the encrypted data block.

Referring again to FIG. 19B, operation 1916 may include operation 1918 depicting determining, at least partly based on the obtained privacy metadata, and partly based on a valuation of a potential sale to a reselling entity of the image of the representation of the feature of the at least one entity contained in the block of encrypted data, whether to allow one or more processes related to the encrypted data block. For example, FIG. 15, e.g., FIG. 15B, shows determination with regard to allowance of manipulation of the encrypted image that is at least partly based on the acquired beacon data and at least partly based on a valuation of a sale to a reseller of the unencrypted version of the encrypted image that contains the representation of the feature of the at least one entity performing module 1518 determining, at least partly based on the obtained privacy metadata (e.g., data that indicates an address where term of service data for this particular class of privacy beacon may be retrieved), and partly based on a valuation of a potential sale to a reselling entity of the image of the representation of the feature of the at least one entity (e.g., a picture of five reality show stars in a bar) contained in the block of encrypted data, whether to allow one or more processes (e.g., decryption and transmission back to the image capture device) related to the encrypted data block.

Referring now to FIG. 19C, operation 1912 may include operation 1920 depicting determining whether to allow one or more processes related to the encrypted data block, said determination at least partly based on the obtained privacy metadata, and partly based on a valuation of the image of the representation of the feature of the at least one entity contained in the block of encrypted data, said valuation carried out without decryption of the block of encrypted data. For example, FIG. 15, e.g., FIG. 15B, shows determination with regard to allowance of manipulation of the encrypted image that is at least partly based on the acquired beacon data and at least partly based on a valuation of the representation of the feature of the at least one entity in the encrypted image performing without image decryption module 1520 determining whether to allow one or more processes related to the encrypted data block, said determination at least partly based on the obtained privacy data (e.g., data that includes a terms of service in which the capturer of the image would be liable for any damages incurred through the public posting of the picture of the entity), and partly based on a valuation of the image of the representation of the feature of the at least one entity (e.g., a picture of a prominent politician playing golf) contained in the block of encrypted data, said valuation carried out without decryption of the block of encrypted data.

Referring now to FIG. 19D, operation 1606 may include operation 1922 depicting determining an estimated amount of damage that may be incurred through a release of the at least one image, at least partly based on the obtained privacy metadata. For example, FIG. 15, e.g., FIG. 15C, shows estimated amount of potential damage that may be incurred through release of unencrypted version of the encrypted image determining at least partly based on the acquired privacy metadata module 1522 determining an estimated amount of damage (e.g., $5,000) that may be incurred through a release (e.g., a posting to a social network, e.g., Facebook) of the at least one image (e.g., an image of two people at a bar, one of whom is a local anchorman), at least partly based on the obtained privacy metadata (e.g., metadata that allows retrieval of a terms of service that indicates $5,000 damage will be incurred for posting surreptitious pictures of the anchorman to a social network).

Referring again to FIG. 19D, operation 1606 may include operation 1924 depicting calculating an estimated amount of revenue that may be accrued through the release of the at least one image. For example, FIG. 15, e.g., FIG. 15C, shows estimated amount of potential revenue that may be obtained through the release of the unencrypted version of the encrypted image determining module 1524 calculating an estimated amount of revenue (e.g., through web traffic, sales of subscriptions to a web site, increased goodwill, resale of the image, e.g., $4,000) that may be accrued through release (e.g., a posting to a social network, e.g., Facebook) of the at least one image (e.g., an image of two people at a bar, one of whom is a local anchorman).

Referring again to FIG. 19D, operation 1606 may include operation 1926 depicting determining whether to allow the one or more processes related to the encrypted data block that corresponds to the at least one image at least partly based on one or more of the determined estimated amount of damage and the estimated amount of revenue. For example, FIG. 15, e.g., FIG. 15C, shows determination regarding allowance of manipulation of the encrypted image at least partly based on the calculated estimated amount of potential revenue and the determined estimated amount of potential damage performing module 1526 determining whether to allow the one or more processes (e.g., decryption and posting to a cloud drive) related to the encrypted data block that corresponds to the at least one image (e.g., an image of two people at a bar, one of whom is a local anchorman) at least partly based on one or more of the determined estimated amount of damage (e.g., $5,000) and the estimated amount of revenue (e.g., $4,000).

Referring again to FIG. 19D, operation 1922 may include operation 1928 depicting determining an estimated amount of monetary damage that may be incurred through a release of the at least one image, at least partly based on the obtained privacy metadata. For example, FIG. 15, e.g., FIG. 15C, shows estimated amount of potential monetary damage that may be incurred through release of unencrypted version of the encrypted image determining at least partly based on the acquired privacy metadata module 1528 determining an estimated amount of monetary damage (e.g., $1,000,000) that may be incurred through a release of the at least one image (e.g., a picture from a private sex tape of two celebrities) at least partly based on the obtained privacy metadata (e.g., a beacon identifier that is used to obtain terms of service data which specifies one million dollars in liquidated damages for release of a naked picture of a celebrity).

Referring again to FIG. 19D, operation 1928 may include operation 1930 depicting determining an estimated amount of monetary damages that may be recovered by the entity represented in the at least one image. For example, FIG. 15, e.g., FIG. 15C, shows estimated amount of potential monetary damage that may be recovered by the entity through release of unencrypted version of the encrypted image determining at least partly based on the acquired privacy metadata module 1530 determining an estimated amount of monetary damages that may be recovered by the entity (e.g., a movie star) represented in the at least one image (e.g., the image of the movie star eating French fries).

Referring again to FIG. 19D, operation 1930 may include operation 1932 depicting determining an estimated amount of monetary damages that may be recovered by the entity represented in the at least one image, at least partly based on a term of service associated with the entity represented in the at least one image. For example, FIG. 15, e.g., FIG. 15C, shows estimated amount of potential monetary damage that may be recovered by the entity through release of unencrypted version of the encrypted image determining at least partly based on a term of service associated with the entity module 1532 determining an estimated amount of monetary damages (e.g., five thousand dollars) that may be recovered by the entity (e.g., Jules Caesar) represented in the at least one image (e.g., an image of Jules Caesar and friends at a bar), at least partly based on a term of service (e.g., a term of service that specifies five thousand dollars in damages for release of the image to particular sites).

Referring again to FIG. 19D, operation 1932 may include operation 1934 depicting determining an estimated amount of monetary damages that may be recovered by the entity represented in the at least one image, at least partly based on a term of service associated with the entity represented in the at least one image, wherein said term of service is obtained at least partially through use of the privacy metadata. For example, FIG. 15, e.g., FIG. 15C, shows estimated amount of potential monetary damage that may be recovered by the entity through release of unencrypted version of the encrypted image determining at least partly based on a term of service associated with the entity and obtained through use of the privacy metadata module 1534 determining an estimated amount of monetary damages (e.g., five thousand dollars) that may be recovered by the entity represented in the at least one image (e.g., an image of five guys building a house), at least partly based on a term of service associated with the entity represented in the at least one image, wherein said term of service is obtained at least partially through use of the privacy metadata.

Referring now to FIG. 19E, operation 1924 may include operation 1936 depicting determining an estimated amount of revenue that may be accrued at least partly through increased selection of one or more advertisements that are part of a web site that includes the at least one image. For example, FIG. 15, e.g., FIG. 15D, shows estimated amount of potential revenue that may be obtained at least partly through selection of one or more advertisements on a web site that features the unencrypted version of the encrypted image calculating module 1536 determining an estimated amount of revenue that may be accrued at least partly through increased selection of one or more advertisements that are part of a website that includes the at least one image (e.g., of two celebrities on a date at a popular new restaurant).

Referring again to FIG. 19E, operation 1924 may include operation 1938 depicting determining an estimated amount of nonmonetary goodwill revenue that may be accrued at least partly through increased notoriety of a web site that includes the at least one image. For example, FIG. 15, e.g., FIG. 15D, shows estimated amount of potential nonmonetary revenue that may be obtained through increased notoriety of a web site that features the unencrypted version of the encrypted image calculating module 1538 determining an estimated amount of nonmonetary goodwill revenue (e.g., popularity of a site, placement in search engines, word of mouth, reputation, etc.) that may be accrued at least partly through increased notoriety of a website that includes the at least one image (e.g., an image of a famous baseball player at a trendy new bar).

Referring again to FIG. 19E, operation 1924 may include operation 1940 depicting determining an estimated amount of improved search engine position revenue that may be accrued through release of the at least one image to a web site. For example, FIG. 15, e.g., FIG. 15D, shows estimated amount of improved search engine position revenue that may be obtained through release of unencrypted version of the encrypted image calculating module 1540 determining an estimated amount of improved search engine position revenue that may be accrued through release of the at least one image (e.g., a picture of a famous actor riding a mechanical bull) to a web site.

Referring again to FIG. 19E, operation 1924 may include operation 1942 depicting determining an estimated amount of revenue that may be accrued at least partly through one or more subscription fees to a website that features the at least one image behind a pay wall. For example, FIG. 15, e.g., FIG. 15D, shows estimated amount of revenue that may be obtained through subscription fee to a website that features the unencrypted version of the encrypted image calculating module 1542 determining an estimated amount of revenue that may be accrued at least partly through one or more subscription fees to a website (e.g., a gossip/politics website) that features the at least one image (e.g., an image of a politician giving a speech at an unpopular location) behind a paywall.

Referring again to FIG. 19E, operation 1924 may include operation 1944 depicting determining an estimated amount of social media status revenue that may be accrued by a person that uses the at least one image on a social networking site. For example, FIG. 15, e.g., FIG. 15D, shows estimated amount of social media status that may be obtained for an entity that publishes the unencrypted version of the encrypted image to a social networking site calculating module 1544 determining an estimated amount of social media status revenue (e.g., increase in number of “friends,” e.g., for Facebook, or “followers,” e.g., for Twitter, or “Likes,” e.g., for Tumblr) that may be accrued by a person that uses the at least one image (e.g., an image of Matt & Kim performing in a park) on a social networking site (e.g., one or more of Facebook, MySpace, Twitter, Tumblr, Pinterest, and the like).

Referring again to FIG. 19E, operation 1924 may include operation 1946 depicting determining an estimated amount of revenue that may be accrued at least partly through increased traffic to a web site through the release of the at least one image. For example, FIG. 15, e.g., FIG. 15D, shows estimated amount of revenue that may be obtained through increased traffic to a web site that allows download of the unencrypted version of the encrypted image module 1546 determining an estimated amount of revenue that may be accrued at least partly through increased traffic to a web site through the release of the at least one image (e.g., an image of three people at a baseball game, one of whom is a celebrity from Boston, Mass., wearing the cap of the Washington Nationals baseball team).

Referring now to FIG. 19F, operation 1606 may include operation 1948 depicting performing an evaluation of a potential damages incurred through a release of the at least one image, at least partly based on acquired privacy metadata. For example, FIG. 15, e.g., FIG. 15E, shows amount of potential damage that may be incurred through release of unencrypted version of the encrypted image evaluation at least partly based on the acquired privacy metadata module 1548 performing an evaluation of a potential damages (e.g., determining which clause of the terms of service is likely to apply if the pictures are emailed to a friend and then posted to a social networking site, e.g., Facebook, by the friend, and determining a range of damages from $5,000 to $25,000) incurred through a release (e.g., private emailing of the unencrypted data) of the at least one image (e.g., a candid picture of two people at the airport, one of whom is the former boyfriend of the picture taker), at least partly based on acquired privacy metadata (e.g., metadata indicating that a privacy beacon was detected, and that the privacy beacon is associated with an image security firm that has a standard terms of service for all of its users with that particular privacy beacon).

Referring again to FIG. 19F, operation 1606 may include operation 1950 depicting calculating potential revenue that may be obtained through the release of the at least one image. For example, FIG. 15, e.g., FIG. 15E, shows estimated amount of potential revenue that may be obtained through the release of the unencrypted version of the encrypted image calculating module 1550 calculating potential revenue (e.g., five additional dollars) that may be obtained through the release of the at least one image (e.g., the candid picture of two people at the airport, one of whom is the former boyfriend of the picture taker).

Referring again to FIG. 19F, operation 1606 may include operation 1952 depicting determining whether to allow processing of the encrypted data block that corresponds to the at least one image at least partly based on one or more of the performing the evaluation of the potential damages and the calculating potential revenue. For example, FIG. 15, e.g., FIG. 15E, shows determination regarding allowance of manipulation of the encrypted image at least partly based on the calculated estimated amount of potential revenue and the evaluated amount of potential damage performing module 1552 determining whether to allow processing (e.g., decryption and changing the security level to allow access by other programs) of the encrypted data block that corresponds to the at least one image (e.g., the picture of two people at the airport, one of whom is the former boyfriend of the picture taker) at least partly based on one or more of the performing the evaluation of the potential damages (e.g., determining which clause of the terms of service is likely to apply if the pictures are emailed to a friend and then posted to a social networking site, e.g., Facebook, by the friend, and determining a range of damages from $5,000 to $25,000) and the calculating potential revenue (e.g., five additional dollars).

Referring again to FIG. 19F, operation 1948 may include operation 1954 depicting performing an evaluation of a potential damages incurred through a release of the at least one image, at least partly based on acquired binary privacy metadata. For example, FIG. 15, e.g., FIG. 15E, shows amount of potential damage that may be incurred through release of unencrypted version of the encrypted image evaluating at least partly based on the acquired binary privacy metadata module 1554 performing an evaluation of a potential damages (e.g., 25,000 dollars) incurred through a release of the at least one image (e.g., an image of two people on a boat) at least partly based on acquired binary privacy metadata (e.g., the metadata indicates whether there is a privacy beacon detected or not, and the system is designed to estimate the potential damages at $25,000 anytime a beacon is detected, without regard to the terms of service, regardless of whether they contradict the calculation).

Referring again to FIG. 19F, operation 1948 may include operation 1956 depicting determining that the privacy beacon was detected in the at least one image in the encrypted data block, based on the acquired privacy data. For example, FIG. 15, e.g., FIG. 15E, shows presence of privacy beacon in the encrypted image confirming from privacy metadata module 1556 determining that the privacy beacon (e.g., a marker that reflects light in a visible spectrum) was detected in the at least one image (e.g., an image of two people sitting on a balcony overlooking the water) in the encrypted data block, based on the acquired privacy data (e.g., the acquired privacy data has a character string that is “0000000” when the beacon is not detected, and a seven-digit identifier of the beacon based on the reflected light characteristics when the beacon is detected).

Referring again to FIG. 19F, operation 1948 may include operation 1958 depicting obtaining data that identifies the entity represented in the at least one image in the encrypted data block. For example, FIG. 15, e.g., FIG. 15E, shows identification data of the entity represented in the encrypted image acquiring module 1558 obtaining data that identifies (e.g., a name and identification number, e.g., a social security number) the entity (e.g., a famous football quarterback for the team from Green Bay) represented in the at least one image (e.g., a picture of the famous football quarterback in a nightclub) in the encrypted data block.

Referring again to FIG. 19F, operation 1958 may include operation 1960 depicting requesting data from a privacy beacon database regarding one or more privacy beacons that indicated as detected. For example, FIG. 15, e.g., FIG. 15E, shows identification data of the entity for which the privacy beacon is associated obtaining from a detected privacy beacon database module 1560 requesting data from a privacy beacon database (e.g., a database that uses the privacy beacon number as input and returns data, e.g., a terms of service data, associated with that privacy beacon) regarding one or more privacy beacons that indicated as detected.

Referring again to FIG. 19F, operation 1960 may include operation 1962 depicting requesting data from a privacy beacon database regarding one or more privacy beacons that indicated a detection by the image capture device. For example, FIG. 15, e.g., FIG. 15E, shows identification data of the entity for which the privacy beacon that was detected by the image capture device is associated obtaining from the detected privacy beacon database module 1562 requesting data from a privacy beacon database (e.g., a database in which the privacy beacon identification character string is used as a key, and the record retrieved has a terms of service and an enforcement history) regarding one or more privacy beacons that indicated a detection by the image capture device (e.g., a Google Glass head-mounted image capture device).

Referring again to FIG. 19F, operation 1958 may include operation 1964 depicting performing encrypted data analysis on the encrypted data block to determine an identity of the entity represented in the at least one image in the encrypted data block. For example, FIG. 15, e.g., FIG. 15E, shows identification of the entity for which the privacy beacon is associated acquisition through performance of analysis on the encrypted image acquiring module 1564 performing encrypted data analysis (e.g., the data block has been encrypted so as to allow histogram diagrams and other image analysis to partly determine a value without decrypting part or all of the image) to determine an identity of the entity (e.g., a famous movie star) represented in the at least one image (e.g., a picture of the celebrity walking down the red carpet) in the encrypted data block).

Referring now to FIG. 19G, operation 1958 may include operation 1966 depicting decrypting a copy of the block of encrypted data in a protected environment to identify the entity represented in the at least one image in the encrypted data block. For example, FIG. 15, e.g., FIG. 15F, shows identification data of the entity for which the privacy beacon is associated obtaining from a decrypted image that is decrypted in a protected environment module 1566 decrypting a copy of the block of encrypted data in a protected environment (e.g., a sandbox environment, e.g., that prevents other access to the data once it is decrypted) to identify the entity (e.g., after the block of encrypted data is decrypted, facial recognition and/or other algorithms designed to identify people may be run on the image) represented in the at least one image (e.g., a picture of five people at an opera performance) in the encrypted data block.

Referring again to FIG. 19G, operation 1966 may include operation 1968 depicting decrypting the copy of the block of encrypted data in the protected environment to identify the entity represented in the at least one image in the encrypted data block. For example, FIG. 15, e.g., FIG. 15F, shows identification data of the entity for which the privacy beacon is associated extracting from the decrypted image that is decrypted in the protected environment module 1568 decrypting the copy of the block of encrypted data in the protected environment (e.g., a remote environment, e.g., a dedicated server workstation) to identify the entity (e.g., after the block of encrypted data is decrypted, facial recognition and/or other algorithms designed to identify people may be run on the image) represented in the at least one image (e.g., a famous mixed martial arts boxer training at a new gym) in the encrypted data block.

Referring again to FIG. 19G, operation 1966 may include operation 1970 depicting destroying the decrypted copy of the block of encrypted data upon identification of the entity represented in the at least one image. For example, FIG. 15, e.g., FIG. 15F, shows decrypted image destruction upon identification data extraction facilitating module 1570 destroying (e.g., deleting) the decrypted copy of the block of encrypted data upon identification of the entity (e.g., a former famous basketball player) represented in the at least one image (e.g., a candid shot from a minor league baseball game).

Referring again to FIG. 19G, operation 1958 may include operation 1972 depicting obtaining data that identifies the entity represented in the at least one image in the encrypted data block through a query that is transmitted to the image capture device. For example, FIG. 15, e.g., FIG. 15F, shows identification data of the entity for which the privacy beacon is associated obtaining from an external source module 1572 obtaining data (e.g., contact list data) that identifies the entity represented in the at least one image (e.g., a picture of five guys going fishing) in the encrypted data block through a query (e.g., “can you identify the people in the block of encrypted data sent at 08:30:03”) that is transmitted to the image capture device (e.g., to an Apple-branded head mounted computer that is synced to a person's contacts in their Apple-branded phone).

Referring now to FIG. 19H, operation 1958 may include operation 1974 depicting determining an identity of the entity represented in the at least one image through an analysis of data regarding the image capture device at a time of capture of the at least one image. For example, FIG. 15, e.g., FIG. 15G, shows identification data of the entity for which the privacy beacon is associated obtaining through analysis of data regarding the image capture device at a time of capturing the encrypted image module 1574 determining an identity of the entity represented in the at least one image through an analysis of data regarding the image capture device (e.g., location, position, and orientation) at a time of capture of the at least one image (e.g., a picture of four women getting ready to go out for a night on the town).

Referring again to FIG. 19H, operation 1974 may include operation 1976 depicting determining the identity of the entity represented in the at least one image through an analysis of one or more devices present in a field of view of the image capture device at the time of capture of the at least one image, said field of view of the image capture device determined at least partly based on position data of the image capture device and orientation data of the image capture device. For example, FIG. 15, e.g., FIG. 15G, shows identification data of the entity for which the privacy beacon is associated obtaining through analysis of a position and orientation of the image capture device at a time of capturing the encrypted image module 1576 determining the identity of the entity represented in the at least one image through an analysis of one or more devices present in a field of view of the image capture device at the time of capture of the at least one image, said field of view of the image capture device determined at least partly based on position data of the image capture device and orientation data of the image capture device (e.g., a Google Glass head-mounted wearable computer).

Referring now to FIG. 19I, operation 1606 may include operation 1978 depicting performing an evaluation of a potential damages incurred through a release of the at least one image, at least partly based on acquired privacy metadata that identifies the privacy beacon. For example, FIG. 15, e.g., FIG. 15H, shows amount of potential damage that may be incurred through release of unencrypted version of the encrypted image evaluating at least partly based on the acquired privacy metadata that identifies the privacy beacon module 1578 performing an evaluation of a potential damages incurred through a release of the at least one image (e.g., an image of a game of pickup basketball in which a famous athlete is participating), at least partly based on acquired privacy metadata (e.g., an identification data for the famous athlete) that identifies the privacy beacon (e.g., a marker that reflects light in a visible spectrum, worn on the famous athlete's wrist, and associated with the famous athlete).

Referring again to FIG. 19I, operation 1606 may include operation 1980 depicting calculating potential revenue incurred through the release of the at least one image. For example, FIG. 15, e.g., FIG. 15H, shows estimated amount of potential revenue that may be obtained through the release of the unencrypted version of the encrypted image calculating module 1580 calculating potential revenue (e.g., advertising revenue through unique visitors to a web site, e.g., $700) incurred through the release of the at least one image (e.g., an image of a famous rock star playing pool at a dive bar at 3 am).

Referring again to FIG. 19I, operation 1606 may include operation 1982 depicting determining whether to allow processing of the encrypted data block that corresponds to the at least one image at least partly based on one or more of the performing the evaluation of the potential damages and the calculating potential revenue. For example, FIG. 15, e.g., FIG. 15H, shows determination regarding allowance of manipulation of the encrypted image at least partly based on the calculated estimated amount of potential revenue and the evaluated amount of potential damage performing module 1582 determining whether to allow processing (e.g., decryption and distribution) of the encrypted data block that corresponds to the at least one image (e.g., an image of two women at a rock concert) at least partly based on one or more of the performing the evaluation of the potential damages and the calculating potential revenue.

Referring again to FIG. 19I, operation 1978 may include operation 1984 depicting performing an evaluation of a potential damages incurred through a release of the at least one image, at least partly based on an identification character string that identifies the privacy beacon. For example, FIG. 15, e.g., FIG. 15H, shows amount of potential damage that may be incurred through release of unencrypted version of the encrypted image evaluating at least partly based on the an acquired character string that identifies the privacy beacon module 1584 performing an evaluation of a potential damages (e.g., the terms of service specify that unauthorized sale of the image will result in a 250,000 dollar penalty) incurred through a release (e.g., a sale) of the at least one image (e.g., an image of a famous tennis player with her skirt blown upwards), at least partly based on an identification character string (e.g., “Banana Gornakova-055”) that identifies the privacy beacon (e.g., a marker that is tattooed to a person's bicep).

Referring again to FIG. 19I, operation 1984 may include operation 1986 depicting performing an evaluation of the potential damages incurred through a release of the at least one image, at least partly based on an identification character string that identifies a class of privacy beacon that has been detected. For example, FIG. 15, e.g., FIG. 15H, shows amount of potential damage that may be incurred through release of unencrypted version of the encrypted image evaluating at least partly based on an acquired character string that identifies a class of privacy beacon module 1586 performing an evaluation of the potential damages (e.g., a $50,000 dollar “Facebook posting” penalty specified in the terms of service acquired) incurred through the release of the at least one image (e.g., a picture of three friends playing poker), at least partly based on an identification character string (e.g., “gold access privacy beacon) that identifies a class of privacy beacon (e.g., gold class, with a $50,000 dollar penalty for unauthorized posting) that has been detected.

Referring again to FIG. 19I, operation 1984 may include operation 1988 depicting performing an evaluation of the potential damages incurred through a release of the at least one image, at least partly based on an identification character string that uniquely identifies the privacy beacon that has been detected. For example, FIG. 15, e.g., FIG. 15H, shows amount of potential damage that may be incurred through release of unencrypted version of the encrypted image evaluating at least partly based on an acquired character string that uniquely identifies the privacy beacon module 1588 performing an evaluation of a potential damages (e.g., 75,000 dollars) incurred through a release (e.g., through uploading to a public picture repository) of the at least one image (e.g., a picture of a woman at a bar), at least partly based on an identification character string that uniquely identifies the privacy beacon that has been detected.

Referring again to FIG. 19I, operation 1984 may include operation 1990 depicting acquiring term of service data regarding the entity, said term of service data at least partly based on the identification character string that identifies the privacy beacon. For example, FIG. 15, e.g., FIG. 15H, shows amount of potential damage that may be incurred through release of unencrypted version of the encrypted image evaluating at least partly based on term of service data obtained through use of the acquired character string that identifies the privacy beacon module 1590 acquiring term of service data regarding the entity, said term of service data at least partly based (e.g., is retrieved from a remote database using the string as a key) on the identification character string (e.g., “User_Jules_Caesar_{—}024362”) that identifies the privacy beacon (e.g., a marker that emits light in a nonvisible spectrum).

Referring now to FIG. 19J, operation 1606 may include operation 1992 depicting obtaining term of service data that includes data regarding potential damages incurred through release of an image that contains the representation of the feature of the at least one entity, said term of service data related to the obtained privacy metadata. For example, FIG. 15, e.g., FIG. 15I, shows term of service data that includes data regarding potential damages incurred through release of the encrypted image and that is related to the acquired privacy metadata acquiring module 1592 obtaining term of service data (e.g., data that describes a term of service similar to a “click-through” agreement that is activated when the beacon is detected, and that specifies the conditions under which any image of the entity can be used) that includes data regarding potential damages (e.g., a liquidated damages clause for release of a picture, whether embarrassing or otherwise) that contains the representation (e.g., the pixel data) of the feature (e.g., face, body, private parts, etc.) of the at least one entity (e.g., an up-and-coming movie star), said term of service data related to the obtained privacy metadata (e.g., the privacy metadata is used to retrieve the term of service data, e.g., as shown in FIG. 13, for example).

Referring again to FIG. 19J, operation 1606 may include operation 1994 depicting determining whether to allow one or more processes to be performed on the encrypted data block by comparing the potential damages to a calculation of the potential value of the block of encrypted data that corresponds to the at least one image. For example, FIG. 15, e.g., FIG. 15I, shows determination regarding allowance of manipulation of the encrypted image at least partly based on the term of service data and at least partly based on an estimated amount of potential revenue from release of the encrypted image performing module 1594 determining whether to allow one or more processes (e.g., decryption, transmission, analysis, release into a network) to be performed on the encrypted data block (e.g., a block of data including the encrypted image of an up-and-coming movie star urinating in public) by comparing the potential damages (e.g., the potential liability incurred by the movie star suing for violation of the terms of service) to a calculation of the potential value (e.g., through sale to a gossip website, for example) of the block of encrypted data that corresponds to the at least one image (e.g., the encrypted image of an up-and-coming movie star urinating in public).

Referring again to FIG. 19J, operation 1606 may include operation 1996 depicting granting permission to perform one or more processes on the encrypted data block when the potential damages are less than the calculation of the potential value of the block of encrypted data that corresponds to the at least one image. For example, FIG. 15, e.g., FIG. 15I, shows allowance of manipulation of the encrypted image when potential damages incurred through release of the encrypted image are less than potential revenues accrued from the release of the encrypted image granting module 1596 granting permission (e.g., decrypting the image) to perform one or more processes on the encrypted data block when the potential damages (e.g., the potential recovery from the entity pictured in the image) are less than the calculation of the potential value of the block of encrypted data that corresponds to the at least one image (e.g., an image of a famous female singer vandalizing a brick wall with spray paint).

Referring again to FIG. 19J, operation 1606 may include operation 1998 depicting granting permission to perform one or more processes on the encrypted data block when the ratio of the potential damages to the potential value of the block of encrypted data that corresponds to the at least one image is below a particular value. For example, FIG. 15, e.g., FIG. 15I, shows allowance of manipulation of the encrypted image when a ratio of potential damages incurred through release of the encrypted image to potential revenues accrued from the release of the encrypted image is less than a particular value granting module 1598 granting permission (e.g., changing access levels, providing credentials, providing clearance, notifying one or more applications, and the like) to perform one or more processes on the encrypted data block (e.g., the data containing the encrypted image) when the ratio of the potential damages to the potential value of the block of encrypted data that corresponds to the at least one image (e.g., the image of a basketball player dunking on a guy in a street pickup game) is below a particular value (e.g., below 5:1).

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Throughout this application, the terms “in an embodiment,” ‘in one embodiment,” “in an embodiment,” “in several embodiments,” “in at least one embodiment,” “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A computationally-implemented method, comprising:
acquiring a block of encrypted data that corresponds to at least one image that has been encrypted through use of a unique device code associated with an image capture device configured to capture the at least one image, wherein the at least one image includes at least one representation of a feature of at least one entity;
obtaining a privacy metadata that corresponds to a detection of a privacy beacon in the at least one image, said at least one image captured by the image capture device, said privacy beacon associated with the at least one entity; and
determining, at least partly based on the obtained privacy metadata, and partly based on a calculation related to the block of encrypted data that corresponds to the at least one image, whether to allow one or more processes related to the encrypted data block.

2. (canceled)

3. (canceled)

4. (canceled)

5. (canceled)

6. (canceled)

7. (canceled)

8. (canceled)

9. The computationally-implemented method of claim 1, wherein said acquiring a block of encrypted data that corresponds to at least one image that has been encrypted through use of a unique device code associated with an image capture device configured to capture the at least one image, wherein the at least one image includes at least one representation of a feature of at least one entity comprises:
acquiring a block of encrypted data that corresponds to at least one compressed image that has been encrypted through use of the unique device code associated with the image capture device configured to capture the image, wherein the image includes at least one representation of the feature of the at least one entity.

10. The computationally-implemented method of claim 1, wherein said acquiring a block of encrypted data that corresponds to at least one image that has been encrypted through use of a unique device code associated with an image capture device configured to capture the at least one image, wherein the at least one image includes at least one representation of a feature of at least one entity comprises:
receiving, from the image capture device, a block of encrypted data that corresponds to at least one image that has been encrypted through use of the unique device code associated with the image capture device configured to capture the at least one image, wherein the at least one image includes the at least one representation of the feature of the at least one entity.

11. (canceled)

12. The computationally-implemented method of claim 1, wherein said acquiring a block of encrypted data that corresponds to at least one image that has been encrypted through use of a unique device code associated with an image capture device configured to capture the at least one image, wherein the at least one image includes at least one representation of a feature of at least one entity comprises:
acquiring a block of encrypted data that corresponds to an image that has been encrypted through use of the unique device code associated with the image capture device configured to capture the at least one image, wherein the block of encrypted data includes unencrypted metadata.

13. The computationally-implemented method of claim 12, wherein said acquiring a block of encrypted data that corresponds to an image that has been encrypted through use of the unique device code associated with the image capture device configured to capture the at least one image, wherein the block of encrypted data includes unencrypted metadata comprises:
acquiring the block of encrypted data that corresponds to the image that has been encrypted through use of a unique device code associated with the image capture device configured to capture the at least one image, wherein the block of encrypted data includes unencrypted metadata that identifies the at least one entity.

14. The computationally-implemented method of claim 12, wherein said acquiring a block of encrypted data that corresponds to an image that has been encrypted through use of the unique device code associated with the image capture device configured to capture the at least one image, wherein the block of encrypted data includes unencrypted metadata comprises:
acquiring the block of encrypted data that corresponds to the image that has been encrypted through use of the unique device code associated with the image capture device configured to capture the at least one image, wherein the block of encrypted data includes unencrypted metadata that identifies the image capture device.

15. (canceled)

16. (canceled)

17. The computationally-implemented method of claim 1, wherein said obtaining a privacy metadata that corresponds to a detection of a privacy beacon in the at least one image, said at least one image captured by the image capture device, said privacy beacon associated with the at least one entity comprises:
obtaining a privacy metadata that indicates whether the privacy beacon was detected in the at least one image captured by the image capture device, said privacy beacon associated with the at least one entity.

18. The computationally-implemented method of claim 17, wherein said obtaining a privacy metadata that indicates whether the privacy beacon was detected in the at least one image captured by the image capture device, said privacy beacon associated with the at least one entity comprises:
obtaining the privacy metadata, wherein said privacy metadata includes an identification number of the privacy beacon that was detected in the at least one image captured by the image capture device, and wherein said privacy beacon is associated with the at least one entity.

19. The computationally-implemented method of claim 18, wherein said obtaining the privacy metadata, wherein said privacy metadata includes an identification number of the privacy beacon that was detected in the at least one image captured by the image capture device, and wherein said privacy beacon is associated with the at least one entity comprises:
obtaining the privacy metadata that includes a unique identification number of the privacy beacon that was obtained from the detection of the privacy beacon in the at least one image captured by the image capture device, wherein said privacy beacon is associated with the at least one entity.

20. The computationally-implemented method of claim 19, wherein said obtaining the privacy metadata that includes a unique identification number of the privacy beacon that was obtained from the detection of the privacy beacon in the at least one image captured by the image capture device, wherein said privacy beacon is associated with the at least one entity comprises:
obtaining the privacy metadata that includes the identification number that was read from a privacy beacon that is embedded in the entity and that emits light in a nonvisible spectrum that was obtained from an optical detection of the privacy beacon in the at least one image captured by the image capture device, said privacy beacon associated with the at least one entity.

21. (canceled)

22. (canceled)

23. (canceled)

24. The computationally-implemented method of claim 1, wherein said obtaining a privacy metadata that corresponds to a detection of a privacy beacon in the at least one image, said at least one image captured by the image capture device, said privacy beacon associated with the at least one entity comprises:
obtaining the privacy metadata that corresponds to the detection of the privacy beacon in the at least one image captured by the image capture device, wherein the privacy beacon is part of a device that operates under control of the entity.

25. (canceled)

26. (canceled)

27. The computationally-implemented method of claim 1, wherein said obtaining a privacy metadata that corresponds to a detection of a privacy beacon in the at least one image, said at least one image captured by the image capture device, said privacy beacon associated with the at least one entity comprises:
obtaining the privacy metadata that corresponds to the detection of the privacy beacon in the at least one image captured by the image capture device, said privacy beacon configured to emit a signal usable to identify the entity.

28. (canceled)

29. (canceled)

30. The computationally-implemented method of claim 1, wherein said obtaining a privacy metadata that corresponds to a detection of a privacy beacon in the at least one image, said at least one image captured by the image capture device, said privacy beacon associated with the at least one entity comprises:
obtaining the privacy metadata that corresponds to the detection of an optically-detectable privacy beacon in the at least one image captured by the image capture device, said privacy beacon associated with the at least one entity.

31. The computationally-implemented method of claim 1, wherein said obtaining a privacy metadata that corresponds to a detection of a privacy beacon in the at least one image, said at least one image captured by the image capture device, said privacy beacon associated with the at least one entity comprises:
obtaining the privacy metadata that corresponds to the detection of a passive privacy beacon in the at least one image captured by the image capture device, said privacy beacon associated with the at least one entity.

32. The computationally-implemented method of claim 1, wherein said obtaining a privacy metadata that corresponds to a detection of a privacy beacon in the at least one image, said at least one image captured by the image capture device, said privacy beacon associated with the at least one entity comprises:
obtaining a privacy metadata that corresponds to a result of analysis of the at least one image to detect the privacy beacon, said privacy beacon associated with the at least one entity.

33. (canceled)

34. The computationally-implemented method of claim 1, wherein said obtaining a privacy metadata that corresponds to a detection of a privacy beacon in the at least one image, said at least one image captured by the image capture device, said privacy beacon associated with the at least one entity comprises:
obtaining a privacy metadata that includes an alphanumeric string, wherein the privacy metadata corresponds to the detection of the privacy beacon in the at least one image captured by the image capture device, said privacy beacon associated with the at least one entity.

35. The computationally-implemented method of claim 34, wherein said obtaining a privacy metadata that includes an alphanumeric string, wherein the privacy metadata corresponds to the detection of the privacy beacon in the at least one image captured by the image capture device, said privacy beacon associated with the at least one entity comprises:
obtaining the privacy metadata that includes an alphanumeric string that identifies the entity, said privacy metadata corresponding to the detection of the privacy beacon in the at least one image captured by the image capture device, said privacy beacon associated with the at least one entity.

36. (canceled)

37. (canceled)

38. (canceled)

39. The computationally-implemented method of claim 1, wherein said obtaining a privacy metadata that corresponds to a detection of a privacy beacon in the at least one image, said at least one image captured by the image capture device, said privacy beacon associated with the at least one entity comprises:
obtaining a privacy metadata that includes data regarding the entity, said privacy metadata corresponding to the detection of the privacy beacon in the at least one image captured by the image capture device, said privacy beacon associated with the at least one entity.

40. The computationally-implemented method of claim 39, wherein said obtaining a privacy metadata that includes data regarding the entity, said privacy metadata corresponding to the detection of the privacy beacon in the at least one image captured by the image capture device, said privacy beacon associated with the at least one entity comprises:
obtaining a privacy metadata that includes data regarding at least one service term associated with use of the at least one image that contains the at least one representation of the feature of the entity, said privacy metadata corresponding to the detection of the privacy beacon in the at least one image captured by the image capture device, said privacy beacon associated with the at least one entity.

41. (canceled)

42. (canceled)

43. (canceled)

44. (canceled)

45. The computationally-implemented method of claim 1, wherein said determining, at least partly based on the obtained privacy metadata, and partly based on a calculation related to the block of encrypted data that corresponds to the at least one image whether to allow one or more processes related to the encrypted data block comprises:
determining, at least partly based on the obtained privacy metadata, and partly based on a value calculation related to the block of encrypted data that corresponds to the at least one image, whether to allow one or more processes related to the encrypted data block.

46. The computationally-implemented method of claim 45, wherein said determining, at least partly based on the obtained privacy metadata, and partly based on a value calculation related to the block of encrypted data that corresponds to the at least one image, whether to allow one or more processes related to the encrypted data block comprises:
determining, at least partly based on the obtained privacy metadata, and partly based on a valuation of the image of the representation of the feature of the at least one entity contained in the block of encrypted data, whether to allow one or more processes related to the encrypted data block.

47. The computationally-implemented method of claim 46, wherein said determining, at least partly based on the obtained privacy metadata, and partly based on a valuation of the image of the representation of the feature of the at least one entity contained in the block of encrypted data, whether to allow one or more processes related to the encrypted data block comprises:
determining, at least partly based on the obtained privacy metadata, and partly based on a valuation of an amount of traffic that may be delivered to a website that featured the image of the representation of the feature of the at least one entity contained in the block of encrypted data, whether to allow one or more processes related to the encrypted data block.

48. The computationally-implemented method of claim 46, wherein said determining, at least partly based on the obtained privacy metadata, and partly based on a valuation of the image of the representation of the feature of the at least one entity contained in the block of encrypted data, whether to allow one or more processes related to the encrypted data block comprises:
determining, at least partly based on the obtained privacy metadata, and partly based on a valuation of a potential sale of an image of the representation of the feature of the at least one entity contained in the block of encrypted data, whether to allow one or more processes related to the encrypted data block.

49. (canceled)

50. The computationally-implemented method of claim 46, wherein said determining, at least partly based on the obtained privacy metadata, and partly based on a valuation of the image of the representation of the feature of the at least one entity contained in the block of encrypted data, whether to allow one or more processes related to the encrypted data block comprises:
determining whether to allow one or more processes related to the encrypted data block, said determination at least partly based on the obtained privacy metadata, and partly based on a valuation of the image of the representation of the feature of the at least one entity contained in the block of encrypted data, said valuation carried out without decryption of the block of encrypted data.

51. The computationally-implemented method of claim 1, wherein said determining, at least partly based on the obtained privacy metadata, and partly based on a calculation related to the block of encrypted data that corresponds to the at least one image whether to allow one or more processes related to the encrypted data block comprises:
determining an estimated amount of damage that may be incurred through a release of the at least one image, at least partly based on the obtained privacy metadata;
calculating an estimated amount of revenue that may be accrued through the release of the at least one image; and
determining whether to allow the one or more processes related to the encrypted data block that corresponds to the at least one image at least partly based on one or more of the determined estimated amount of damage and the estimated amount of revenue.

52. The computationally-implemented method of claim 51, wherein said determining an estimated amount of damage that may be incurred through a release of the at least one image, at least partly based on the obtained privacy metadata comprises:
determining an estimated amount of monetary damage that may be incurred through a release of the at least one image, at least partly based on the obtained privacy metadata.

53. The computationally-implemented method of claim 52, wherein said determining an estimated amount of monetary damage that may be incurred through a release of the at least one image, at least partly based on the obtained privacy metadata comprises:
determining an estimated amount of monetary damages that may be recovered by the entity represented in the at least one image.

54. The computationally-implemented method of claim 53, wherein said determining an estimated amount of monetary damages that may be recovered by the entity represented in the at least one image comprises:
determining an estimated amount of monetary damages that may be recovered by the entity represented in the at least one image, at least partly based on a term of service associated with the entity represented in the at least one image.

55. The computationally-implemented method of claim 54, wherein said determining an estimated amount of monetary damages that may be recovered by the entity represented in the at least one image, at least partly based on a term of service associated with the entity represented in the at least one image comprises:
determining an estimated amount of monetary damages that may be recovered by the entity represented in the at least one image, at least partly based on a term of service associated with the entity represented in the at least one image, wherein said term of service is obtained at least partially through use of the privacy metadata.

56. (canceled)

57. (canceled)

58. (canceled)

59. (canceled)

60. The computationally-implemented method of claim 51, wherein said calculating an estimated amount of revenue that may be accrued through the release of the at least one image comprises:
determining an estimated amount of social media status revenue that may be accrued by a person that uses the at least one image on a social networking site.

61. (canceled)

62. The computationally-implemented method of claim 1, wherein said determining, at least partly based on the obtained privacy metadata, and partly based on a calculation related to the block of encrypted data that corresponds to the at least one image whether to allow one or more processes related to the encrypted data block comprises:
performing an evaluation of a potential damages incurred through a release of the at least one image, at least partly based on acquired privacy metadata;
calculating potential revenue that may be obtained through the release of the at least one image; and
determining whether to allow processing of the encrypted data block that corresponds to the at least one image at least partly based on one or more of the performing the evaluation of the potential damages and the calculating potential revenue.

63. (canceled)

64. The computationally-implemented method of claim 62, wherein said performing an evaluation of a potential damages incurred through a release of the at least one image, at least partly based on acquired privacy metadata comprises:
determining that the privacy beacon was detected in the at least one image in the encrypted data block, based on the acquired privacy data; and
obtaining data that identifies the entity represented in the at least one image in the encrypted data block.

65. (canceled)

66. (canceled)

67. (canceled)

68. (canceled)

69. (canceled)

70. (canceled)

71. The computationally-implemented method of claim 64, wherein said obtaining data that identifies the entity represented in the at least one image in the encrypted data block comprises:
determining an identity of the entity represented in the at least one image through an analysis of data regarding the image capture device at a time of capture of the at least one image.

72. The computationally-implemented method of claim 71, wherein said determining an identity of the entity represented in the at least one image through an analysis of data regarding the image capture device at a time of capture of the at least one image comprises:
determining the identity of the entity represented in the at least one image through an analysis of one or more devices present in a field of view of the image capture device at the time of capture of the at least one image, said field of view of the image capture device determined at least partly based on position data of the image capture device and orientation data of the image capture device.

73. The computationally-implemented method of claim 1, wherein said determining, at least partly based on the obtained privacy metadata, and partly based on a calculation related to the block of encrypted data that corresponds to the at least one image whether to allow one or more processes related to the encrypted data block comprises:
performing an evaluation of a potential damages incurred through a release of the at least one image, at least partly based on acquired privacy metadata that identifies the privacy beacon;
calculating potential revenue incurred through the release of the at least one image; and
determining whether to allow processing of the encrypted data block that corresponds to the at least one image at least partly based on one or more of the performing the evaluation of the potential damages and the calculating potential revenue.

74. The computationally-implemented method of claim 73, wherein said performing an evaluation of a potential damages incurred through a release of the at least one image, at least partly based on acquired privacy metadata that identifies the privacy beacon comprises:
performing an evaluation of a potential damages incurred through a release of the at least one image, at least partly based on an identification character string that identifies the privacy beacon.

75. The computationally-implemented method of claim 74, wherein said performing an evaluation of a potential damages incurred through a release of the at least one image, at least partly based on an identification character string that identifies the privacy beacon comprises:
performing an evaluation of the potential damages incurred through a release of the at least one image, at least partly based on an identification character string that identifies a class of privacy beacon that has been detected.

76. (canceled)

77. (canceled)

78. The computationally-implemented method of claim 1, wherein said determining, at least partly based on the obtained privacy metadata, and partly based on a calculation related to the block of encrypted data that corresponds to the at least one image whether to allow one or more processes related to the encrypted data block comprises:
obtaining term of service data that includes data regarding potential damages incurred through release of an image that contains the representation of the feature of the at least one entity, said term of service data related to the obtained privacy metadata; and
determining whether to allow one or more processes to be performed on the encrypted data block by comparing the potential damages to a calculation of the potential value of the block of encrypted data that corresponds to the at least one image.

79. The computationally-implemented method of claim 1, wherein said determining, at least partly based on the obtained privacy metadata, and partly based on a calculation related to the block of encrypted data that corresponds to the at least one image whether to allow one or more processes related to the encrypted data block comprises:
granting permission to perform one or more processes on the encrypted data block when the potential damages are less than the calculation of the potential value of the block of encrypted data that corresponds to the at least one image.

80. (canceled)

81. (canceled)

82. A computationally-implemented system, comprising:
circuitry for acquiring a block of encrypted data that corresponds to at least one image that has been encrypted through use of a unique device code associated with an image capture device configured to capture the at least one image, wherein the at least one image includes at least one representation of a feature of at least one entity;
circuitry for obtaining a privacy metadata that corresponds to a detection of a privacy beacon in the at least one image, said at least one image captured by the image capture device, said privacy beacon associated with the at least one entity; and
circuitry for determining, at least partly based on the obtained privacy metadata, and partly based on a calculation related to the block of encrypted data that corresponds to the at least one image whether to allow one or more processes related to the encrypted data block.

83-162. (canceled)

163. A device defined by a computational language comprising:
one or more interchained physical machines ordered for acquiring a block of encrypted data that corresponds to at least one image that has been encrypted through use of a unique device code associated with an image capture device configured to capture the at least one image, wherein the at least one image includes at least one representation of a feature of at least one entity;
one or more interchained physical machines ordered for obtaining a privacy metadata that corresponds to a detection of a privacy beacon in the at least one image, said at least one image captured by the image capture device, said privacy beacon associated with the at least one entity; and
one or more interchained physical machines ordered for determining, at least partly based on the obtained privacy metadata, and partly based on a calculation related to the block of encrypted data that corresponds to the at least one image whether to allow one or more processes related to the encrypted data block.
